(19) United States
(12) Patent Application Publication
(10) Pub. No.: US 2026/0000218 A1
(43) Pub. Date: Jan. 1, 2026

(54) BED SYSTEM INCLUDING PRESSURE SENSOR

(71) Applicant: Sleep Number Corporation, Minneapolis, MN (US)

(72) Inventors: Gary N. Garcia Molina, DeForest, WI (US); Artur Klibyshev, Minneapolis, MN (US)

(21) Appl. No.: 19/256,445

(22) Filed: Jul. 1, 2025

Related U.S. Application Data
(60) Provisional application No. 63/666,529, filed on Jul. 1, 2024.

(51) Int. Cl. A47C 31/12; A47C 21/00; G05B 13/02

(52) U.S. Cl. CPC A47C 31/123; A47C 21/006; G05B 13/0265

(57) ABSTRACT

A bed includes one or more actuation devices and a pressure sensor configured to generate a pressure signal. The bed system also includes control circuitry comprising one or more memories configured to store a machine learning model and a bed actuation control model; and processing circuitry in communication with the one or more memories. The processing circuitry is configured to receive a first biometric signal indicating a first biometric parameter over a period of time; apply, based on the first biometric signal, the machine learning model to generate a second biometric signal, wherein the second biometric signal indicates a second biometric parameter over the period of time, wherein the pressure signal indicates a user sample of the second biometric parameter corresponding to a user laying on the bed; and train, using the second biometric signal, the bed actuation control model to control the one or more actuation devices.

### CROSS-REFERENCE TO RELATED APPLICATIONS

This application claims priority to U.S. Application Ser. No. 63/666,529, filed on Jul. 1, 2024. The disclosure of the prior application is considered part of the disclosure of this application, and is incorporated in its entirety into this application.

### TECHNICAL FIELD

The present document relates bed systems that accept input sensor signals.

### BACKGROUND

In general, a bed is a piece of furniture used as a location to sleep or relax. Many modern beds include a soft mattress on a bed frame. The mattress may include springs, foam material, and/or an air chamber to support the weight of one or more occupants.

### SUMMARY

A controller can manage aspects of a sleep environment to aid sleep of a user. The controller can perform many actions such as adjusting a firmness of a mattress, causing a noise machine to emit ambient noise or cease emitting ambient noise, and controlling a temperature or an amount of light in the sleep environment. In some embodiments, the controller performs actions based on receiving input data signals. These input data signals can include biometric signals collected from a user laying on a mattress. One example biometric signal is a ballistocardiogram (BCG) signal. The mattress can include pressure sensors that collect a BCG signal from the user laying on the mattress and transmit the BCG signal to the controller. The controller can process the BCG signal to determine one or more biometric parameters of the user. Based on these biometric parameters, the controller can determine whether to perform one or more actions.

A user can have one or more cardiac conditions that affect an ability of the controller to determine biometric parameters based on a collected BCG signal. Atrial fibrillation, for examples, can introduce noise into the BCG signal that makes it more difficult for the controller to determine parameters like heart rate. This means that it may be beneficial for the controller to account for patient conditions in determining whether to perform one or more actions based on collected BCG data. The controller may additionally or alternatively train one or models to determine biometric parameters based on biometric signals collected from users that have certain patient conditions. To account for certain patient conditions and/or train models to determine biometric parameters from biometric signals collected from users that have certain patient conditions, it may be beneficial for the controller to have access to biometric signal samples that are collected from patients known to have these certain patient conditions.

In some aspects, the techniques described herein relate to a bed system including: a bed including: one or more actuation devices; and a pressure sensor configured to generate a pressure signal; and control circuitry including: one or more memories configured to store a machine learning model and a bed actuation control model; and processing circuitry in communication with the one or more memories, wherein the processing circuitry is configured to: receive a primary biometric signal indicating a primary biometric parameter over a period of time; apply, based on the primary biometric signal, the machine learning model to generate a secondary biometric signal, wherein the secondary biometric signal indicates a secondary biometric parameter over the period of time, wherein the pressure signal indicates a user sample of the secondary biometric parameter corresponding to a user laying on the bed; and train, using the secondary biometric signal, the bed actuation control model to control the one or more actuation devices based on the user sample of the secondary biometric parameter.

In some aspects, the techniques described herein relate to a bed system, wherein the one or more memories are configured to store a database, wherein the database is configured to store a plurality of secondary biometric signals each representing a sample of the secondary biometric parameter, wherein the plurality of secondary biometric signals includes the secondary biometric signal, and wherein the processing circuitry is further configured to train the bed actuation control model using the plurality of secondary biometric signals.

In some aspects, the techniques described herein relate to a bed system, wherein the processing circuitry is configured to: apply the machine learning model to generate each secondary biometric signal of the plurality of secondary biometric signals based on a primary biometric signal of a plurality of primary biometric signals, wherein each primary biometric signal of the plurality of primary biometric signals represents a sample of the primary biometric parameter, and wherein the plurality of primary biometric signals includes the primary biometric signal; and save each secondary biometric signal of the plurality of secondary biometric signals to the database.

In some aspects, the techniques described herein relate to a bed system, wherein prior to applying the machine learning model to generate the secondary biometric signal, the processing circuitry is configured to apply a band pass filter to the primary biometric signal to generate a filtered primary biometric signal, and wherein the processing circuitry is configured to apply the machine learning model to the filtered primary biometric signal to generate the secondary biometric signal.

In some aspects, the techniques described herein relate to a bed system, wherein to apply the band pass filter to the primary biometric signal, the processing circuitry is configured to cause the band pass filter to pass one or more frequency components of the primary biometric signal, wherein the one or more frequency components are within a range from a lower-bound frequency to an upper-bound frequency.

In some aspects, the techniques described herein relate to a bed system, wherein the lower-bound frequency is within a first range from 0.0001 Hertz (Hz) to 0.2 Hz, and wherein the upper-bound frequency is within a second range from 30 Hz to 100 Hz.

In some aspects, the techniques described herein relate to a bed system, wherein the lower-bound frequency is 0.001 Hz and the upper-bound frequency is 50 Hz.

In some aspects, the techniques described herein relate to a bed system, wherein prior to applying the machine learning model to generate the secondary biometric signal, the processing circuitry is configured to resample the primary biometric signal at a predetermined sampling frequency.

In some aspects, the techniques described herein relate to a bed system, wherein the predetermined sampling frequency is 100 Hz.

In some aspects, the techniques described herein relate to a bed system, wherein the primary biometric signal includes one of an electrocardiogram (ECG) signal or a photoplethysmogram (PPG) signal, and wherein the secondary biometric signal includes a ballistocardiogram (BCG) signal.

In some aspects, the techniques described herein relate to a bed system, wherein the primary biometric signal includes the ECG signal.

In some aspects, the techniques described herein relate to a bed system, wherein the primary biometric signal includes the PPG signal.

In some aspects, the techniques described herein relate to a bed system, wherein the memory is further configured to store training data including a plurality of training data sets, each training data set of the plurality of training data sets including: a first training biometric signal collected over a window of time, the first training biometric signal indicating the primary biometric parameter of a subject over the window of time; and a second training biometric signal collected over the window of time, the second training biometric signal indicating the second parameter of the subject over the window of time; and wherein the processing circuitry is further configured to train, using the plurality of training data sets, the machine learning model to regenerate the secondary biometric signal indicating the second parameter using the primary biometric signal indicating the primary biometric parameter.

In some aspects, the techniques described herein relate to a bed system, wherein the processing circuitry is configured to train the machine learning model using unsupervised learning.

In some aspects, the techniques described herein relate to a bed system, wherein the processing circuitry is configured to train the machine learning model using supervised learning.

In some aspects, the techniques described herein relate to a bed system, wherein the processing circuitry is configured to train the machine learning model using semi-supervised learning.

In some aspects, the techniques described herein relate to a bed system, wherein the processing circuitry is further configured to: generate, for each data sample of a first plurality of data samples corresponding to the primary biometric signal, an input embedding, and wherein to apply the machine learning model to generate the secondary biometric signal, the processing circuitry is configured to apply the machine learning model generate, for the input embedding corresponding to each data sample of the first plurality of data samples, a data sample of a second plurality of data samples of the secondary biometric signal.

In some aspects, the techniques described herein relate to a bed system, wherein the input embedding includes a set of rows and a set of columns, and wherein to generate the input embedding, the processing circuitry is configured to: populate a first row of the input embedding with a sequence of data samples of the first plurality of data samples, the sequence of data samples the sequence of data samples ending with the data sample corresponding to the input embedding; populate a second row of the input embedding with the sequence of data samples so that the sequence of data samples is delayed by one sample relative to the first row; populate a third row of the input embedding with the sequence of data samples so that the sequence of data samples is delayed by two samples relative to the first row; and populate a fourth row of the input embedding with the sequence of data samples so that the sequence of data samples is delayed by three samples relative to the first row.

In some aspects, the techniques described herein relate to a bed system, wherein the machine learning model includes two convolutional layers, three long short-term memory (LSTM) layers, and one dense layer.

In some aspects, the techniques described herein relate to a method including: generating, by a pressure sensor of a bed, a pressure signal; receiving, by processing circuitry, a primary biometric signal indicating a primary biometric parameter over a period of time, wherein one or more memories are configured to store a machine learning model and a bed actuation control model; and applying, by the processing circuitry based on the primary biometric signal, the machine learning model to generate a secondary biometric signal, wherein the v biometric signal indicates a secondary biometric parameter over the period of time, wherein the pressure signal indicates a user sample of the secondary biometric parameter corresponding to a user laying on the bed; and training, by the processing circuitry using the secondary biometric signal, the bed actuation control model to control one or more actuation devices of the bed based on the user sample of the secondary biometric parameter.

In some aspects, the techniques described herein relate to a method, further including training the bed actuation control model based on a plurality of secondary biometric signals including the second biometric signal.

In some aspects, the techniques described herein relate to a method, further including applying the machine learning model to generate each secondary biometric signal of the plurality of secondary biometric signals based on a primary biometric signal of a plurality of primary biometric signals,

In some aspects, the techniques described herein relate to a method, wherein prior to applying the machine learning model to generate the secondary biometric signal, the method further includes applying a band pass filter to the primary biometric signal to generate a filtered primary biometric signal, and wherein the method further includes applying the machine learning model to the filtered primary biometric signal to generate the secondary biometric signal.

In some aspects, the techniques described herein relate to a method, wherein applying the band pass filter to the primary biometric signal includes causing the band pass filter to pass one or more frequency components of the primary biometric signal, wherein the one or more frequency components are within a range from a lower-bound frequency to an upper-bound frequency.

In some aspects, the techniques described herein relate to a method, wherein prior to applying the machine learning model to generate the secondary biometric signal, the method further includes resampling the primary biometric signal at a predetermined sampling frequency.

In some aspects, the techniques described herein relate to a method, wherein the primary biometric signal includes one of an electrocardiogram (ECG) signal or a photoplethysmogram (PPG) signal, and wherein the secondary biometric signal includes a ballistocardiogram (BCG) signal.

In some aspects, the techniques described herein relate to a method, wherein the primary biometric signal includes the ECG signal.

In some aspects, the techniques described herein relate to a method, wherein the primary biometric signal includes the PPG signal.

In some aspects, the techniques described herein relate to a bed system including: a bed; and control circuitry including: one or more memories configured to store a machine learning model and a bed actuation control model; and processing circuitry in communication with the memory, wherein the processing circuitry is configured to: receive a primary biometric signal indicating a primary biometric parameter over a period of time; generate, based on the primary biometric signal, an input embedding that indicates one or more spatial or temporal aspects of the primary biometric signal; apply, based on the input embedding, the machine learning model to generate a secondary biometric signal, wherein the secondary biometric signal indicates a secondary biometric parameter over the period of time, wherein a pressure signal collected by a pressure sensor of the bed indicates a user sample of the secondary biometric parameter corresponding to a user laying on the bed; and train, using the secondary biometric signal, the bed actuation control model to control one or more actuation devices of the bed based on the user sample of the secondary biometric parameter.

In some aspects, the techniques described herein relate to a bed system including: a bed; and control circuitry including: one or more memories configured to store a machine learning model and a bed actuation control model; and processing circuitry in communication with the one or more memories, wherein the processing circuitry is configured to: receive a primary biometric signal indicating a primary biometric parameter over a period of time; apply, based on an input embedding, the machine learning model to generate a secondary biometric signal by recognizing one or more spatial or temporal relationships between the primary biometric parameter and a secondary biometric parameter, wherein the secondary biometric signal indicates the secondary biometric parameter over the period of time, wherein a pressure signal collected by a pressure sensor of the bed indicates a user sample of the secondary biometric parameter corresponding to a user laying on a mattress; and train, using the secondary biometric signal, the bed actuation control model to control one or more actuation devices of the bed based on the user sample of the secondary biometric parameter.

In some aspects, the techniques described herein relate to a method including: converting a first data set from a first type of sensor to simulate a second data set appearing to be collected from a second type of sensor; collecting, by a sensor of the second type of sensor located on a bed, a sensor signal from a user laying on the bed; and training, using the second data set and the sensor signal collected by the sensor of the second type of sensor, a bed actuation control model to control one or more actuation devices of the bed.

In some aspects, the techniques described herein relate to a bed system including: a bed; and control circuitry configured to: convert a first data set from a first type of sensor to simulate a second data set appearing to be collected from a second type of sensor; collect, by a sensor of the second type of sensor located on the bed, a sensor signal from a user laying on the bed; and train, using the second data set and the sensor signal collected by the sensor of the second type of sensor, a bed actuation control model to control one or more actuation devices of the bed.

In some aspects, the techniques described herein relate to a method including: receiving a primary biometric signal indicating a primary biometric parameter; applying, based on the primary biometric signal, a machine learning model to generate a reconstructed sample of a secondary biometric signal indicating a secondary biometric parameter separate from the primary biometric parameter; and training, using the reconstructed sample of the secondary biometric signal, a bed actuation control model to control one or more actuation devices of a bed based on a genuine sample of the second biometric signal indicating the second biometric parameter, wherein the genuine sample is collected from a user laying on the bed.

In some aspects, the techniques described herein relate to a bed system including: a bed including one or more actuation devices; and one or more memories configured to store a machine learning model and a bed actuation control model; and processing circuitry in communication with the one or more memories, wherein the processing circuitry is configured to: receive a primary biometric signal indicating a primary biometric parameter; apply, based on the primary biometric signal, the machine learning model to generate a reconstructed sample of a secondary biometric signal indicating a secondary biometric parameter separate from the primary biometric parameter; and train, using the reconstructed sample of the secondary biometric signal, a bed actuation control model to control one or more actuation devices of a bed based on a genuine sample of the second biometric signal indicating the second biometric parameter, wherein the genuine sample is collected from a user laying on the bed.

In some aspects, the techniques described herein relate to a bed system including: one or more memories configured to store a machine learning model and a bed actuation control model; and processing circuitry in communication with the one or more memories, wherein the processing circuitry is configured to: receive a primary biometric signal indicating a primary biometric parameter over a period of time; apply, based on the primary biometric signal, the machine learning model to generate a secondary biometric signal, wherein the secondary biometric signal indicates a secondary biometric parameter over the period of time, wherein the signal indicates a user sample of the secondary biometric parameter corresponding to a user laying on a bed; and train, using the secondary biometric signal, the bed actuation control model to control one or more actuation devices of the bed based on the user sample of the secondary biometric parameter.

In some aspects, the techniques described herein relate to a bed system including: one or more memories configured to store a machine learning model and a bed actuation control model; and processing circuitry in communication with the one or more memories, wherein the processing circuitry is configured to: receive a primary biometric signal indicating a primary biometric parameter over a period of time; and apply, based on the primary biometric signal, the machine learning model to generate a secondary biometric signal, wherein the secondary biometric signal indicates a secondary biometric parameter over the period of time, wherein the signal indicates a user sample of the secondary biometric parameter corresponding to a user laying on a bed for training the bed actuation control model to control one or more actuation devices of the bed based on the user sample of the secondary biometric parameter.

In some aspects, the techniques described herein relate to a method including: receiving a primary biometric signal indicating a primary biometric parameter over a period of time; and applying, based on the primary biometric signal, a machine learning model to generate a secondary biometric signal, wherein the secondary biometric signal indicates a secondary biometric parameter over the period of time, the secondary biometric signal for training a bed actuation control model to control one or more actuation devices of a bed based on a user sample of the secondary biometric parameter.

In some aspects, the techniques described herein relate to a bed system including: a bed including: one or more actuation devices; and a sensor configured to generate a signal indicating a biometric parameter of a user laying on the bed; and one or more memories configured to store a machine learning model and a bed actuation control model; and processing circuitry in communication with the one or more memories, wherein the processing circuitry is configured to: receive a first biometric signal; generate an embedding matrix based on the first biometric signal; apply one or more convolutional layers of the machine learning model to the embedding matrix to generate a convolutional layer output; apply one or more long-term short memory (LSTM) layers of the machine learning model to the convolutional layer output to generate an LSTM layer output; apply one or more dense layers of the machine learning model to the LSTM layer output to generate a second biometric signal indicating a reconstructed version of the biometric parameter of the user laying on the bed; and train, using the second biometric signal, a bed actuation control model to control the one or more actuation devices based on the signal indicating the biometric parameter of the user laying on the bed.

In some aspects, the techniques described herein relate to a method including: receiving a first biometric signal; generating an embedding matrix based on the first biometric signal; applying one or more convolutional layers of a machine learning model to the embedding matrix to generate a convolutional layer output; applying one or more long-term short memory (LSTM) layers of the machine learning model to the convolutional layer output to generate an LSTM layer output; applying one or more dense layers of the machine learning model to the LSTM layer output to generate a second biometric signal indicating a reconstructed version of a biometric parameter; and training, using the second biometric signal, a bed actuation control model to control one or more actuation devices of the bed based on a signal indicating the biometric parameter of a user laying on the bed.

In some aspects, the techniques described herein relate to a bed system including: a bed including: one or more actuation devices; and a sensor configured to generate a signal indicating a biometric parameter of a user laying on the bed; and one or more memories configured to store a machine learning model and a bed actuation control model; and processing circuitry in communication with the one or more memories, wherein the processing circuitry is configured to: receive a first biometric signal; apply the machine learning model to the first biometric signal to generate a second biometric signal indicating a reconstructed version of the biometric parameter of the user laying on the bed; and train, using the second biometric signal, the bed actuation control model to control the one or more actuation devices based on the signal indicating the biometric parameter of the user laying on the bed.

Implementations can include any, all, or none of the following features.

Other features, aspects and potential advantages will be apparent from the accompanying description and figures.

### DESCRIPTION OF DRAWINGS bed system.

FIG. 3 shows an example environment including a bed in communication with devices located in and around a home.

FIG. 1 shows an example air bed system.

FIG. 2 is a block diagram of an example of various components of an air

FIGS. 4A and 4B are block diagrams of example data processing systems that can be associated with a bed.

FIGS. 5 and 6 are block diagrams of examples of motherboards that can be used in a data processing system that can be associated with a bed.

FIG. 7 is a block diagram of an example of a daughterboard that can be used in a data processing system that can be associated with a bed.

FIG. 8 is a block diagram of an example of a motherboard with no daughterboard that can be used in a data processing system that can be associated with a bed.

FIG. 9 is a block diagram of an example of a sensory array that can be used in a data processing system that can be associated with a bed.

FIG. 10 is a block diagram of an example of a control array that can be used in a data processing system that can be associated with a bed.

FIG. 11 is a block diagram of an example of a computing device that can be used in a data processing system that can be associated with a bed.

FIGS. 12-16 are block diagrams of example cloud services that can be used in a data processing system that can be associated with a bed.

FIG. 17 is a block diagram of an example of using a data processing system that can be associated with a bed to automate peripherals around the bed.

FIG. 18 is a schematic diagram that shows an example of a computing device and a mobile computing device.

FIG. 19 is a block diagram illustrating a system including an example controller for using a first biometric signal to reconstruct a second biometric signal.

FIG. 20 is a block diagram including a system for using a first biometric signal to reconstruct a second biometric signal that includes a pre-processing model, an embedding unit, and a machine learning model.

FIG. 21 is a conceptual diagram illustrating an example set of data points for generating an embedding matrix.

FIG. 22 is a conceptual diagram illustrating an example machine learning model 2200 including a set of layers.

FIGS. 23A-23D include plot diagrams of recorded electrocardiogram (ECG) signals, recorded photoplethysmogram (PPG) signals, recorded ballistocardiogram (BCG) signals, and reconstructed BCG signals generated based on the recorded ECG signals and recorded PPG signals.

FIG. 24 is a flow diagram illustrating an example operation for using a first kind of biometric data to regenerate a second kind of biometric data.

FIG. 25A-25C include plot diagrams of recorded hear rate and sleep duration signals.

FIG. 26 is a flow diagram illustrating an example operation for generating biometric signals.

FIG. 27 is a flow diagram illustrating an example operation for controlling a mechanical feedback system.

Like reference symbols in the various drawings indicate like elements.

### DETAILED DESCRIPTION

A bed system can convert ballistocardiogram (BCG) data to another biometric signal, and use that converted signal to train a machine learning classifier. In addition or in the alternative, a bed system can operate while accounting for atypical biological phenomena such as atrial fibrillation (AF). A controller can accept biometric data as input to determine one or more actions for controlling a bed system. This biometric data can include, for example, BCG data that indicates movement of a user due to cardiac activity. The bed system may include a mattress having pressure sensors that record BCG data for a user. This BCG data may indicate biometric parameters that are useful for controlling the bed system such as heart rate, heart rate variability, breathing rate, and breathing rate variability. This means that a controller can determine one or more biometric parameters based the BCG data and use these determined parameters to control the bed system to improve the sleep of the user.

### Example Airbed Hardware

FIG. 1 shows an example air bed system 100 that includes a bed 112. The bed 112 includes at least one air chamber 114 surrounded by a resilient border 116 and encapsulated by bed ticking 118. The resilient border 116 can comprise any suitable material, such as foam.

As illustrated in FIG. 1, the bed 112 can be a two chamber design having first and second fluid chambers, such as a first air chamber 114A and a second air chamber 114B. In alternative embodiments, the bed 112 can include chambers for use with fluids other than air that are suitable for the application. In some embodiments, such as single beds or kids' beds, the bed 112 can include a single air chamber 114A or 114B or multiple air chambers 114A and 114B. First and second air chambers 114A and 114B can be in fluid communication with a pump 120. The pump 120 can be in electrical communication with a remote control 122 via control box 124. The control box 124 can include a wired or wireless communications interface for communicating with one or more devices, including the remote control 122. The control box 124 can be configured to operate the pump 120 to cause increases and decreases in the fluid pressure of the first and second air chambers 114A and 114B based upon commands input by a user using the remote control 122. In some implementations, the control box 124 is integrated into a housing of the pump 120.

The remote control 122 can include a display 126, an output selecting mechanism 128, a pressure increase button 129, and a pressure decrease button 130. The output selecting mechanism 128 can allow the user to switch air flow generated by the pump 120 between the first and second air chambers 114A and 114B, thus enabling control of multiple air chambers with a single remote control 122 and a single pump 120. For example, the output selecting mechanism 128 can by a physical control (e.g., switch or button) or an input control displayed on display 126. Alternatively, separate remote control units can be provided for each air chamber and can each include the ability to control multiple air chambers. Pressure increase and decrease buttons 129 and 130 can allow a user to increase or decrease the pressure, respectively, in the air chamber selected with the output selecting mechanism 128. Adjusting the pressure within the selected air chamber can cause a corresponding adjustment to the firmness of the respective air chamber. In some embodiments, the remote control 122 can be omitted or modified as appropriate for an application. For example, in some embodiments the bed 112 can be controlled by a computer, tablet, smart phone, or other device in wired or wireless communication with the bed 112.

FIG. 2 is a block diagram of an example of various components of an air bed system. For example, these components can be used in the example air bed system 100. As shown in FIG. 2, the control box 124 can include a power supply 134, a processor 136, a memory 137, a switching mechanism 138, and an analog to digital (A/D) converter 140. The switching mechanism 138 can be, for example, a relay or a solid state switch. In some implementations, the switching mechanism 138 can be located in the pump 120 rather than the control box 124.

The pump 120 and the remote control 122 are in two-way communication with the control box 124. The pump 120 includes a motor 142, a pump manifold 143, a relief valve 144, a first control valve 145A, a second control valve 145B, and a pressure transducer 146. The pump 120 is fluidly connected with the first air chamber 114A and the second air chamber 114B via a first tube 148A and a second tube 148B, respectively. The first and second control valves 145A and 145B can be controlled by switching mechanism 138 and are operable to regulate the flow of fluid between the pump 120 and first and second air chambers 114A and 114B, respectively.

In some implementations, the pump 120 and the control box 124 can be provided and packaged as a single unit. In some alternative implementations, the pump 120 and the control box 124 can be provided as physically separate units. In some implementations, the control box 124, the pump 120, or both are integrated within or otherwise contained within a bed frame or bed support structure that supports the bed 112. In some implementations, the control box 124, the pump 120, or both are located outside of a bed frame or bed support structure (as shown in the example in FIG. 1).

The example air bed system 100 depicted in FIG. 2 includes the two air chambers 114A and 114B and the single pump 120. However, other implementations can include an air bed system having two or more air chambers and one or more pumps incorporated into the air bed system to control the air chambers. For example, a separate pump can be associated with each air chamber of the air bed system, or a pump can be associated with multiple chambers of the air bed system. Separate pumps can allow each air chamber to be inflated or deflated independently and simultaneously. Furthermore, additional pressure transducers can also be incorporated into the air bed system such that, for example, a separate pressure transducer can be associated with each air chamber.

In use, the processor 136 can, for example, send a decrease pressure command to one of air chambers 114A or 114B, and the switching mechanism 138 can be used to convert the low voltage command signals sent by the processor 136 to higher operating voltages sufficient to operate the relief valve 144 of the pump 120 and open the control valve 145A or 145B. Opening the relief valve 144 can allow air to escape from the air chamber 114A or 114B through the respective air tube 148A or 148B. During deflation, the pressure transducer 146 can send pressure readings to the processor 136 via the A/D converter 140. The A/D converter 140 can receive analog information from pressure transducer 146 and can convert the analog information to digital information useable by the processor 136. The processor 136 can send the digital signal to the remote control 122 to update the display 126 in order to convey the pressure information to the user.

As another example, the processor 136 can send an increase pressure command. The pump motor 142 can be energized in response to the increase pressure command and send air to the designated one of the air chambers 114A or 114B through the air tube 148A or 148B via electronically operating the corresponding valve 145A or 145B. While air is being delivered to the designated air chamber 114A or 114B in order to increase the firmness of the chamber, the pressure transducer 146 can sense pressure within the pump manifold 143. Again, the pressure transducer 146 can send pressure readings to the processor 136 via the A/D converter 140. The processor 136 can use the information received from the A/D converter 140 to determine the difference between the actual pressure in air chamber 114A or 114B and the desired pressure. The processor 136 can send the digital signal to the remote control 122 to update display 126 in order to convey the pressure information to the user.

Generally speaking, during an inflation or deflation process, the pressure sensed within the pump manifold 143 can provide an approximation of the pressure within the respective air chamber that is in fluid communication with the pump manifold 143. An example method of obtaining a pump manifold pressure reading that is substantially equivalent to the actual pressure within an air chamber includes turning off pump 120, allowing the pressure within the air chamber 114A or 114B and the pump manifold 143 to equalize, and then sensing the pressure within the pump manifold 143 with the pressure transducer 146. Thus, providing a sufficient amount of time to allow the pressures within the pump manifold 143 and chamber 114A or 114B to equalize can result in pressure readings that are accurate approximations of the actual pressure within air chamber 114A or 114B. In some implementations, the pressure of the air chambers 114A and/or 114B can be continuously monitored using multiple pressure sensors (not shown).

In some implementations, information collected by the pressure transducer 146 can be analyzed to determine various states of a person lying on the bed 112. For example, the processor 136 can use information collected by the pressure transducer 146 to determine a heart rate or a respiration rate for a person lying in the bed 112. For example, a user can be lying on a side of the bed 112 that includes the chamber 114A. The pressure transducer 146 can monitor fluctuations in pressure of the chamber 114A and this information can be used to determine the user's heart rate and/or respiration rate. As another example, additional processing can be performed using the collected data to determine a sleep state of the person (e.g., awake, light sleep, deep sleep). For example, the processor 136 can determine when a person falls asleep and, while asleep, the various sleep states of the person.

Additional information associated with a user of the air bed system 100 that can be determined using information collected by the pressure transducer 146 includes motion of the user, presence of the user on a surface of the bed 112, weight of the user, heart arrhythmia of the user, and apnea. Taking user presence detection for example, the pressure transducer 146 can be used to detect the user's presence on the bed 112, e.g., via a gross pressure change determination and/or via one or more of a respiration rate signal, heart rate signal, and/or other biometric signals. For example, a simple pressure detection process can identify an increase in pressure as an indication that the user is present on the bed 112. As another example, the processor 136 can determine that the user is present on the bed 112 if the detected pressure increases above a specified threshold (so as to indicate that a person or other object above a certain weight is positioned on the bed 112). As yet another example, the processor 136 can identify an increase in pressure in combination with detected slight, rhythmic fluctuations in pressure as corresponding to the user being present on the bed 112. The presence of rhythmic fluctuations can be identified as being caused by respiration or heart rhythm (or both) of the user. The detection of respiration or a heartbeat can distinguish between the user being present on the bed and another object (e.g., a suitcase) being placed upon the bed.

In some implementations, fluctuations in pressure can be measured at the pump 120. For example, one or more pressure sensors can be located within one or more internal cavities of the pump 120 to detect fluctuations in pressure within the pump 120. The fluctuations in pressure detected at the pump 120 can indicate fluctuations in pressure in one or both of the chambers 114A and 114B. One or more sensors located at the pump 120 can be in fluid communication with the one or both of the chambers 114A and 114B, and the sensors can be operative to determine pressure within the chambers 114A and 114B. The control box 124 can be configured to determine at least one vital sign (e.g., heart rate, respiratory rate) based on the pressure within the chamber 114A or the chamber 114B.

In some implementations, the control box 124 can analyze a pressure signal detected by one or more pressure sensors to determine a heart rate, respiration rate, and/or other vital signs of a user lying or sitting on the chamber 114A or the chamber 114B. More specifically, when a user lies on the bed 112 positioned over the chamber 114A, each of the user's heart beats, breaths, and other movements can create a force on the bed 112 that is transmitted to the chamber 114A. As a result of the force input to the chamber 114A from the user's movement, a wave can propagate through the chamber 114A and into the pump 120. A pressure sensor located at the pump 120 can detect the wave, and thus the pressure signal output by the sensor can indicate a heart rate, respiratory rate, or other information regarding the user.

With regard to sleep state, air bed system 100 can determine a user's sleep state by using various biometric signals such as heart rate, respiration, and/or movement of the user. While the user is sleeping, the processor 136 can receive one or more of the user's biometric signals (e.g., heart rate, respiration, and motion) and determine the user's present sleep state based on the received biometric signals. In some implementations, signals indicating fluctuations in pressure in one or both of the chambers 114A and 114B can be amplified and/or filtered to allow for more precise detection of heart rate and respiratory rate.

The control box 124 can perform a pattern recognition algorithm or other calculation based on the amplified and filtered pressure signal to determine the user's heart rate and respiratory rate. For example, the algorithm or calculation can be based on assumptions that a heart rate portion of the signal has a frequency in the range of 0.5-4.0 Hz and that a respiration rate portion of the signal a has a frequency in the range of less than 1 Hz. The control box 124 can also be configured to determine other characteristics of a user based on the received pressure signal, such as blood pressure, tossing and turning movements, rolling movements, limb movements, weight, the presence or lack of presence of a user, and/or the identity of the user. Techniques for monitoring a user's sleep using heart rate information, respiration rate information, and other user information are disclosed in U.S. Patent Application Publication No. 20100170043 to Steven J. Young et al., titled “APPARATUS FOR MONITORING VITAL SIGNS,” the entire contents of which is incorporated herein by reference.

For example, the pressure transducer 146 can be used to monitor the air pressure in the chambers 114A and 114B of the bed 112. If the user on the bed 112 is not moving, the air pressure changes in the air chamber 114A or 114B can be relatively minimal and can be attributable to respiration and/or heartbeat. When the user on the bed 112 is moving, however, the air pressure in the mattress can fluctuate by a much larger amount. Thus, the pressure signals generated by the pressure transducer 146 and received by the processor 136 can be filtered and indicated as corresponding to motion, heartbeat, or respiration. For example, pressure transducer 146 may be configured to generate a BCG signal indicating movements of a user laying on bed 112 that are caused by cardiac activity. This BCG signal may indicate parameters such as heart rate.

In some implementations, rather than performing the data analysis in the control box 124 with the processor 136, a digital signal processor (DSP) can be provided to analyze the data collected by the pressure transducer 146. Alternatively, the data collected by the pressure transducer 146 could be sent to a cloud-based computing system for remote analysis.

In some implementations, the example air bed system 100 further includes a temperature controller configured to increase, decrease, or maintain the temperature of a bed, for example for the comfort of the user. For example, a pad can be placed on top of or be part of the bed 112 or can be placed on top of or be part of one or both of the chambers 114A and 114B. Air can be pushed through the pad and vented to cool off a user of the bed. Conversely, the pad can include a heating element that can be used to keep the user warm. In some implementations, the temperature controller can receive temperature readings from the pad. In some implementations, separate pads are used for the different sides of the bed 112 (e.g., corresponding to the locations of the chambers 114A and 114B) to provide for differing temperature control for the different sides of the bed.

In some implementations, the user of the air bed system 100 can use an input device, such as the remote control 122, to input a desired temperature for the surface of the bed 112 (or for a portion of the surface of the bed 112). The desired temperature can be encapsulated in a command data structure that includes the desired temperature as well as identifies the temperature controller as the desired component to be controlled. The command data structure can then be transmitted via Bluetooth or another suitable communication protocol to the processor 136. In various examples, the command data structure is encrypted before being transmitted. The temperature controller can then configure its elements to increase or decrease the temperature of the pad depending on the temperature input into remote control 122 by the user.

In some implementations, data can be transmitted from a component back to the processor 136 or to one or more display devices, such as the display 126. For example, the current temperature as determined by a sensor element of temperature controller, the pressure of the bed, the current position of the foundation or other information can be transmitted to control box 124. The control box 124 can then transmit the received information to remote control 122 where it can be displayed to the user (e.g., on the display 126).

In some implementations, the example air bed system 100 further includes an adjustable foundation and an articulation controller configured to adjust the position of a bed (e.g., the bed 112) by adjusting the adjustable foundation that supports the bed. For example, the articulation controller can adjust the bed 112 from a flat position to a position in which a head portion of a mattress of the bed is inclined upward (e.g., to facilitate a user sitting up in bed and/or watching television). In some implementations, the bed 112 includes multiple separately articulable sections. For example, portions of the bed corresponding to the locations of the chambers 114A and 114B can be articulated independently from each other, to allow one person positioned on the bed 112 surface to rest in a first position (e.g., a flat position) while a second person rests in a second position (e.g., a reclining position with the head raised at an angle from the waist). In some implementations, separate positions can be set for two different beds (e.g., two twin beds placed next to each other). The foundation of the bed 112 can include more than one zone that can be independently adjusted. The articulation controller can also be configured to provide different levels of massage to one or more users on the bed 112.

### Example of a Bed in a Bedroom Environment

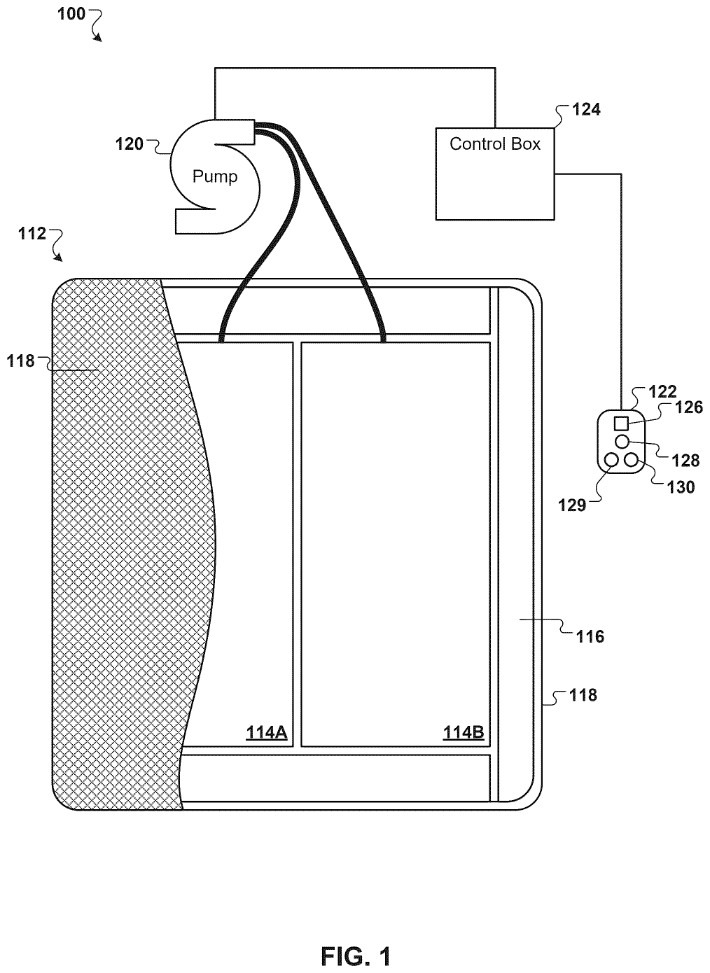

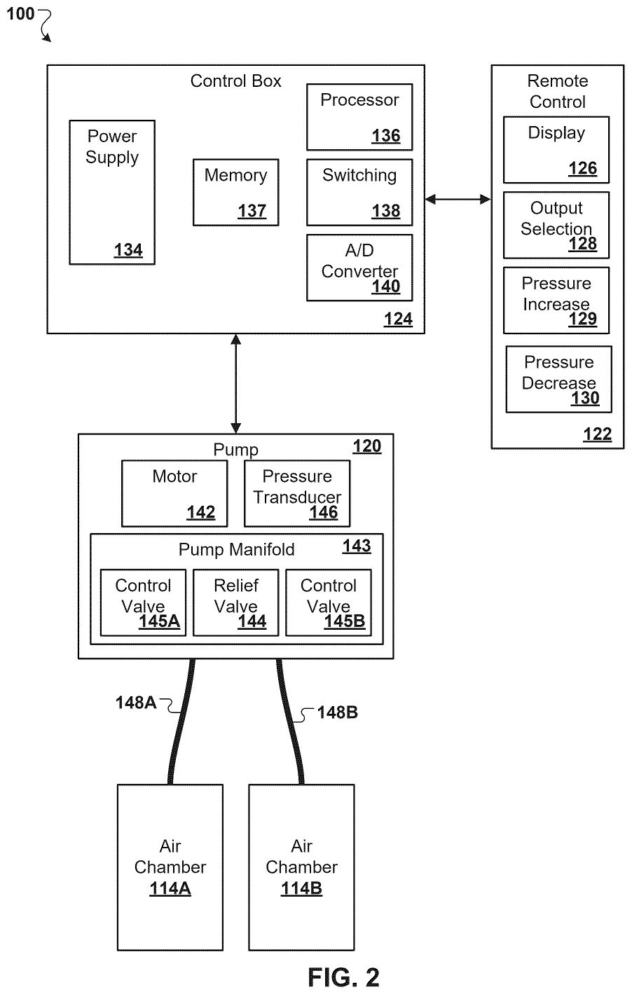

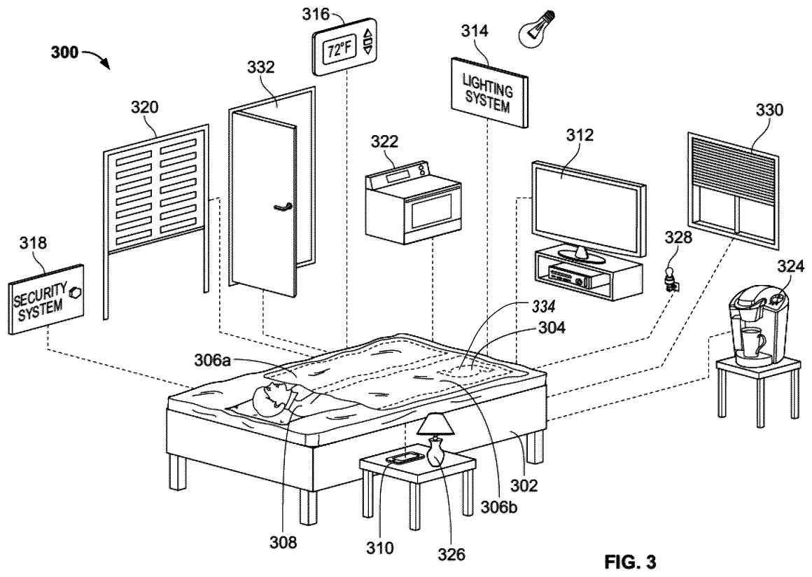

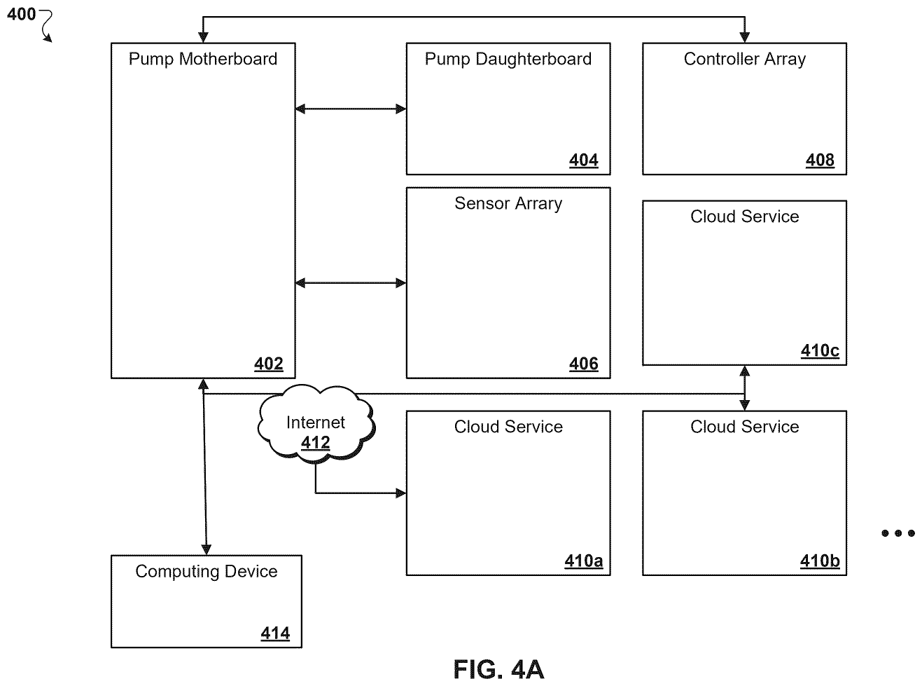

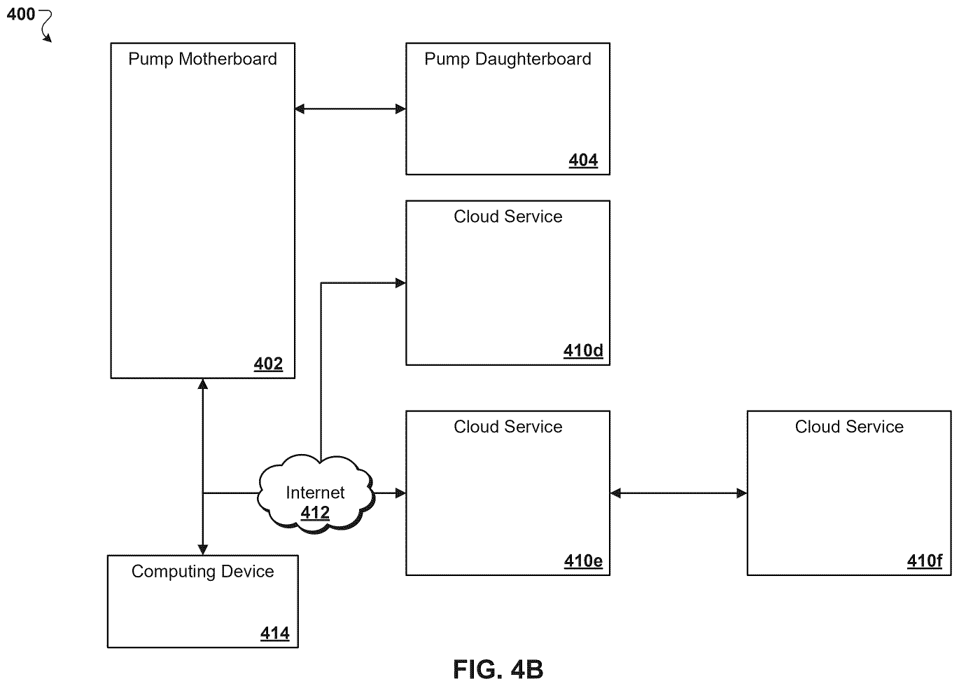

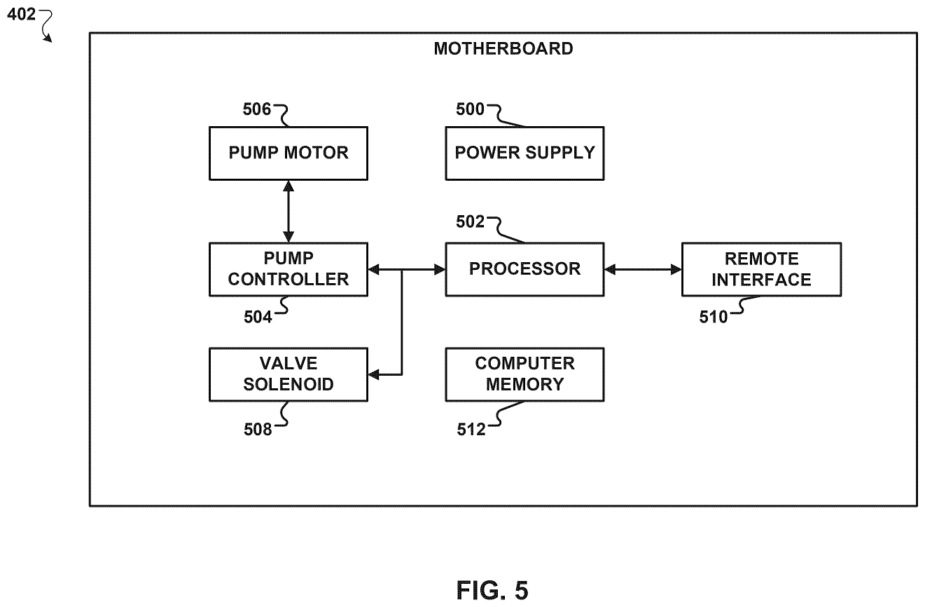

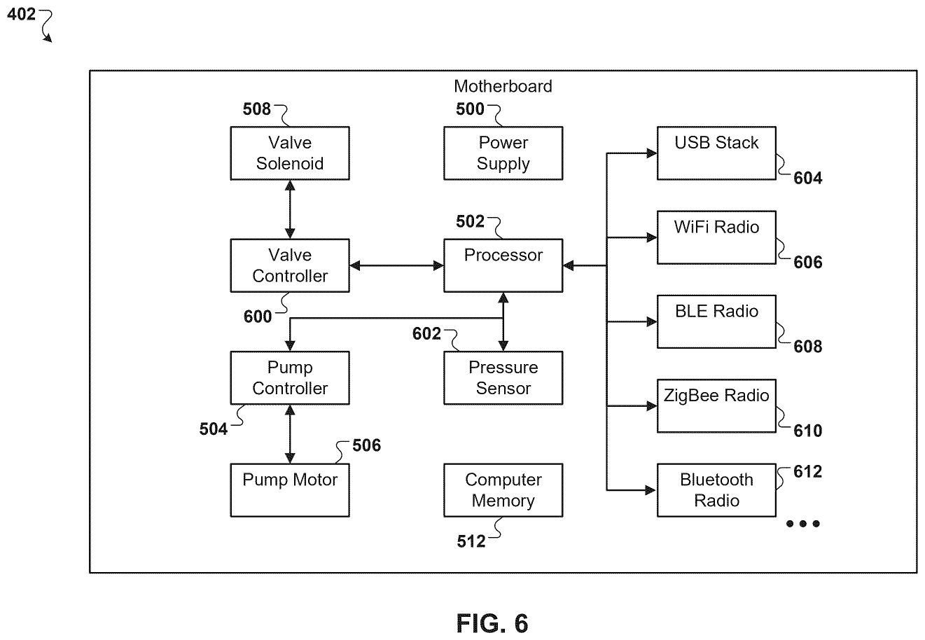

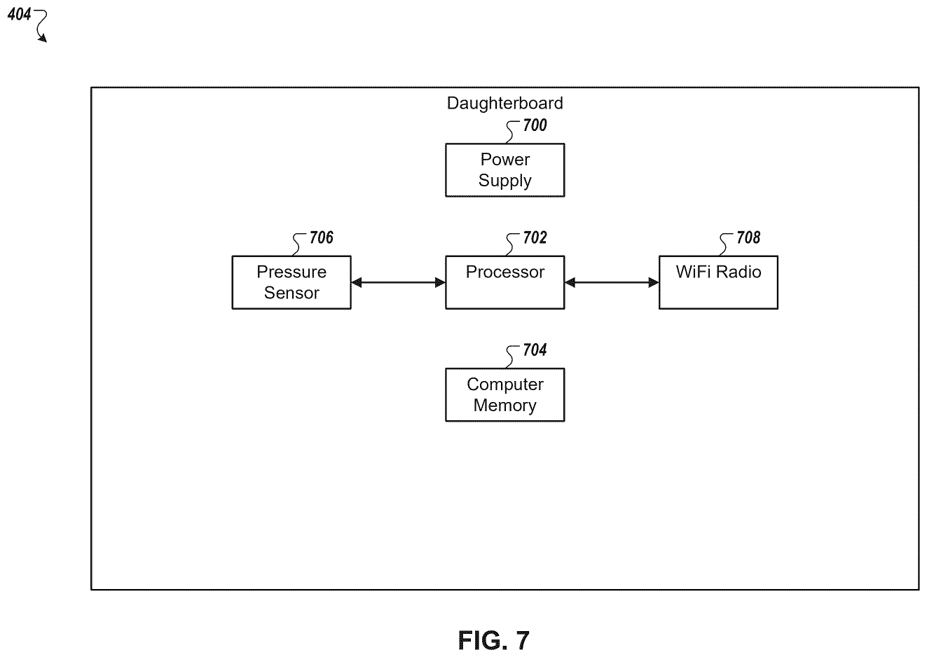

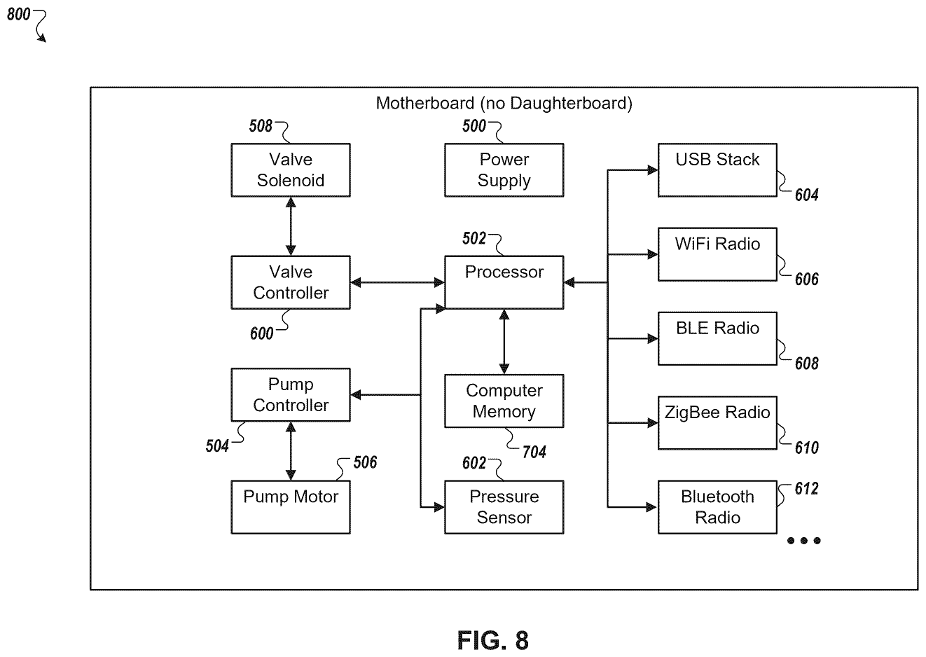

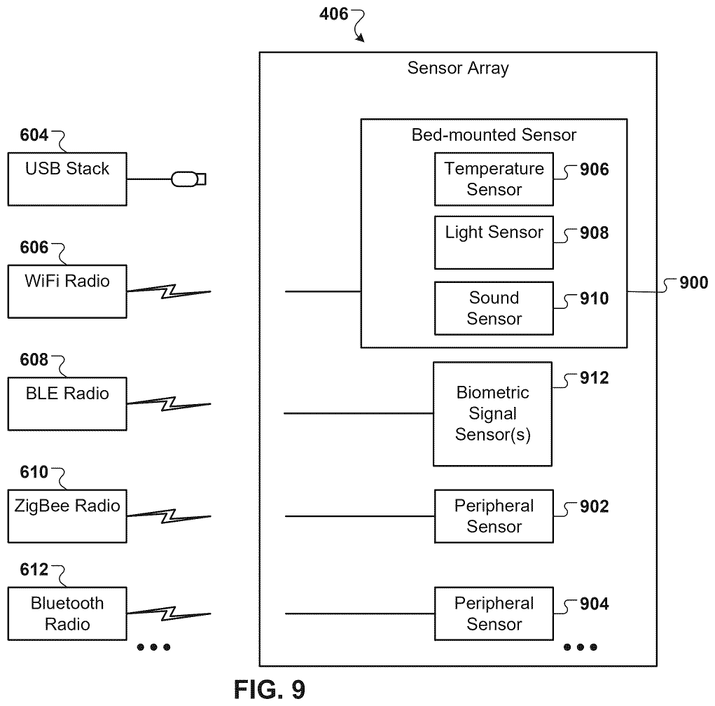

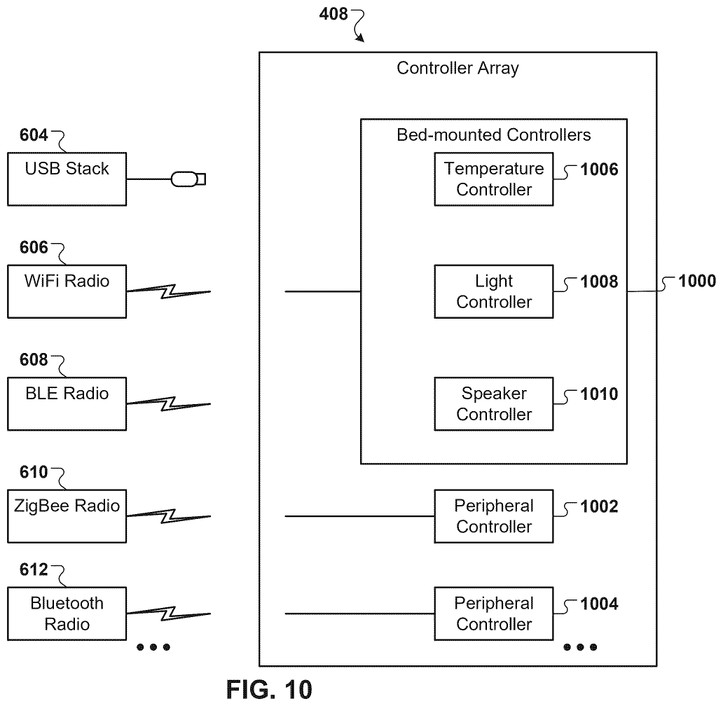

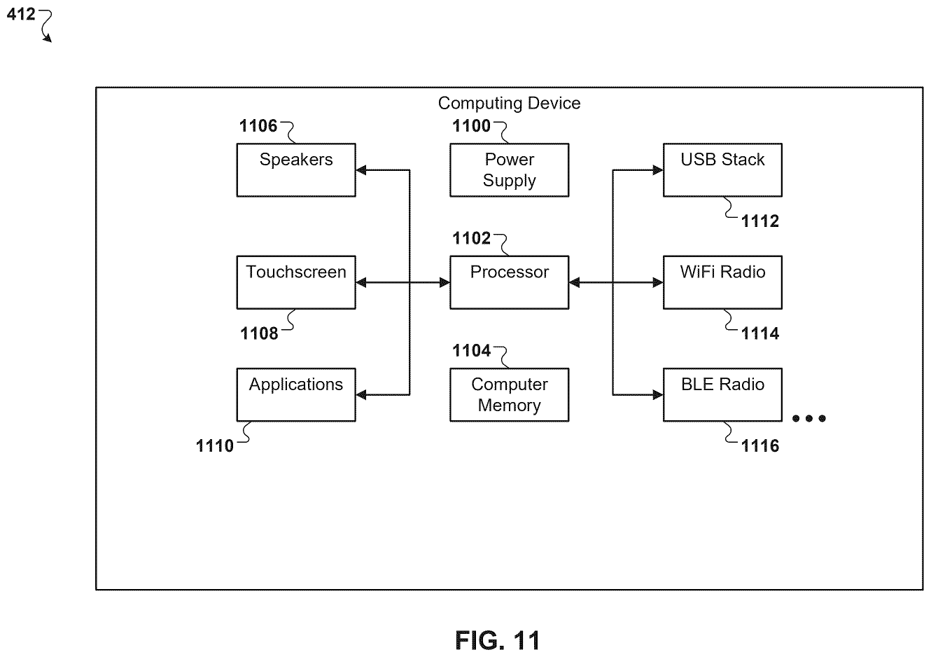

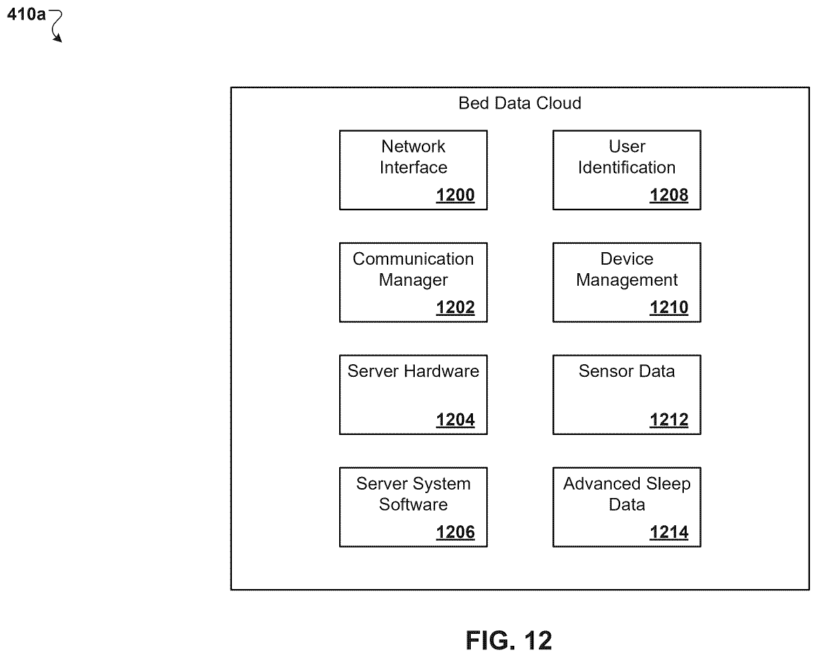

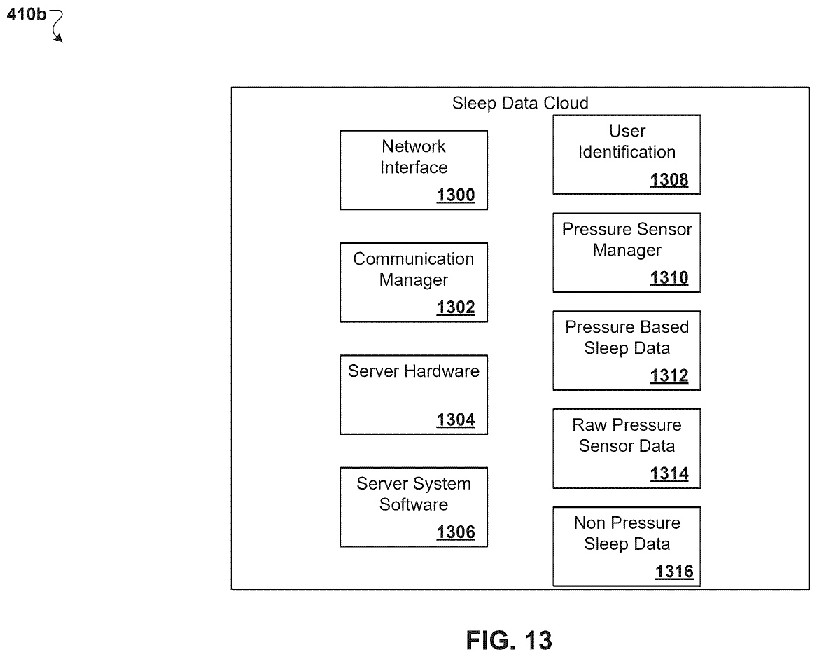

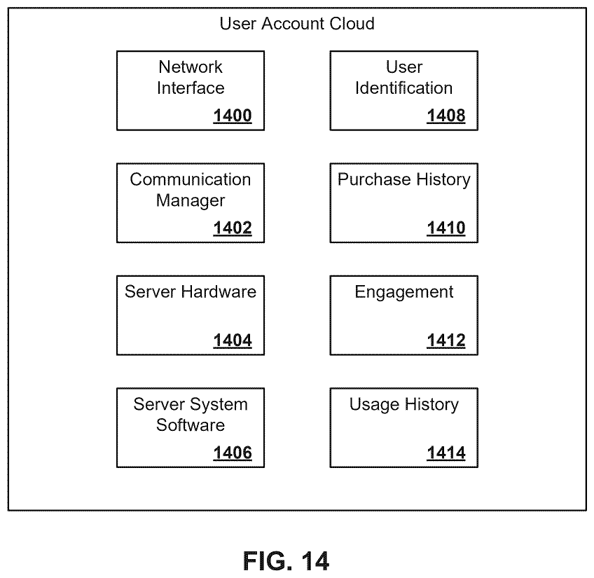

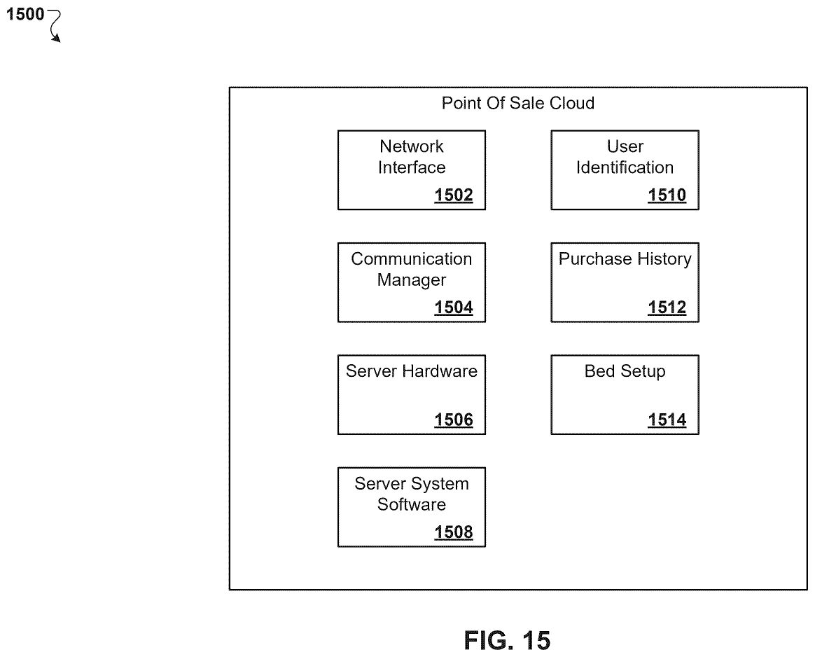

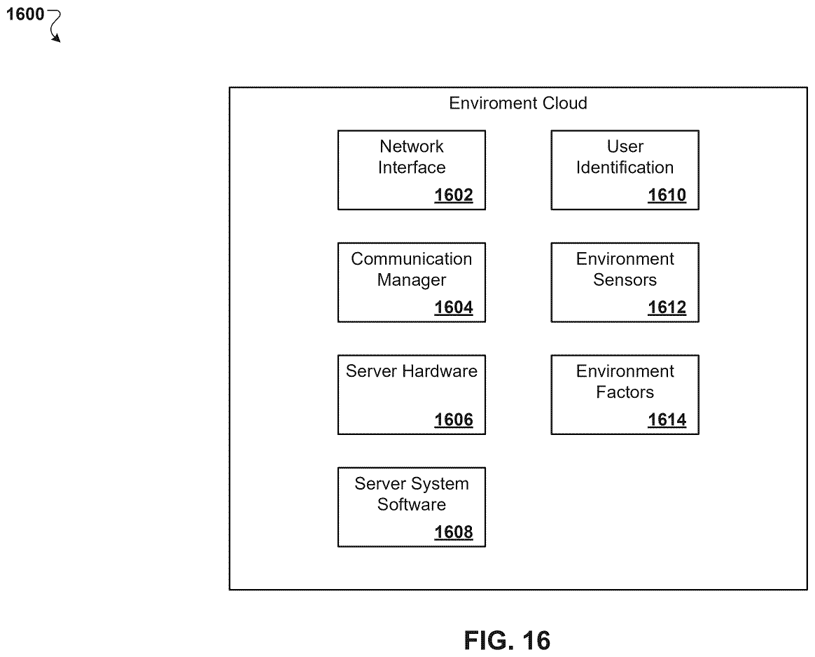

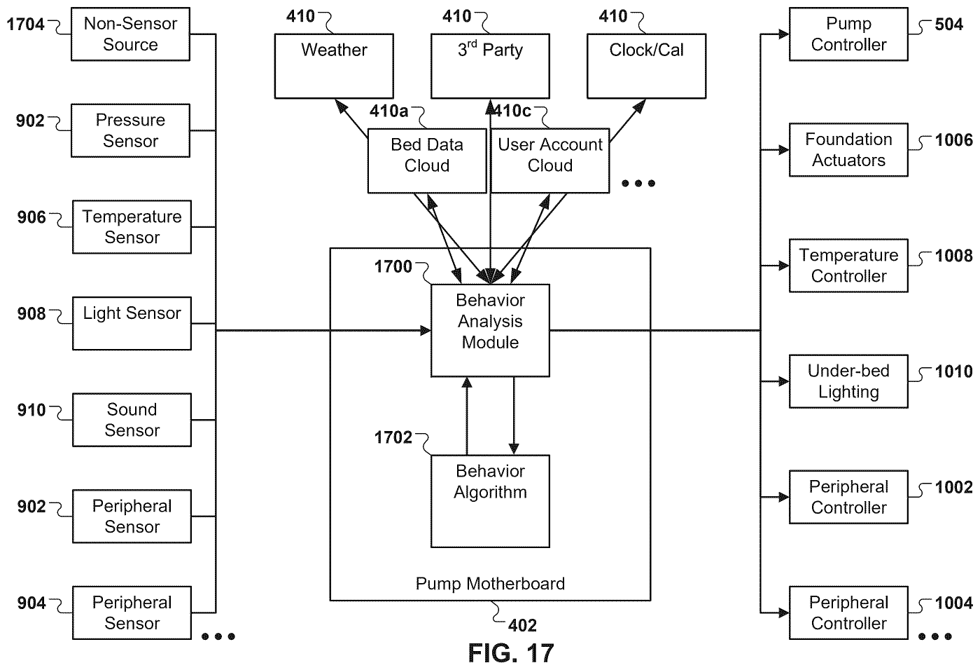

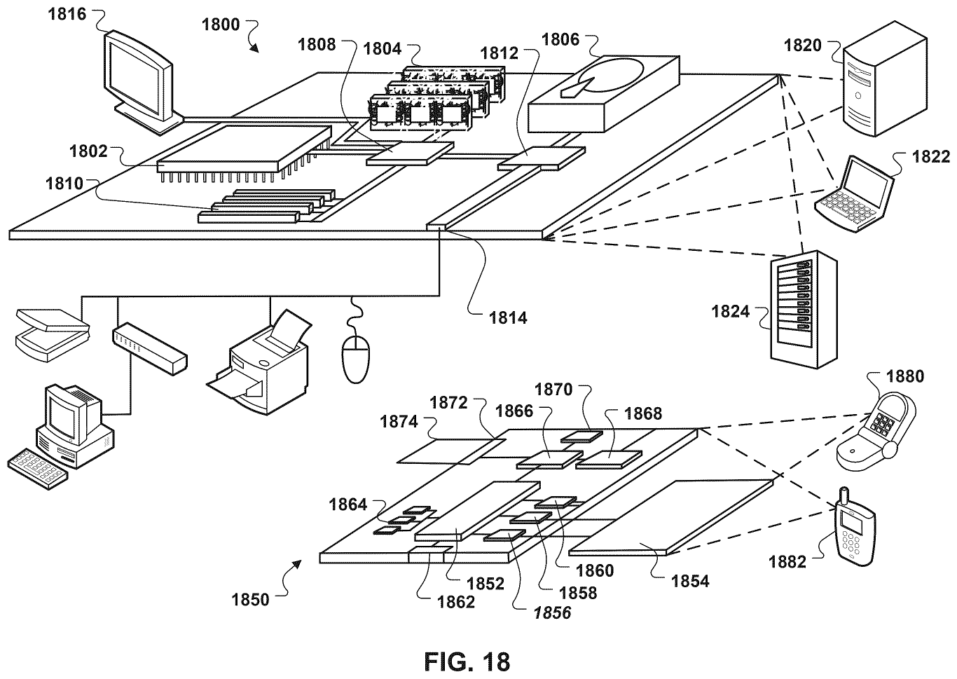

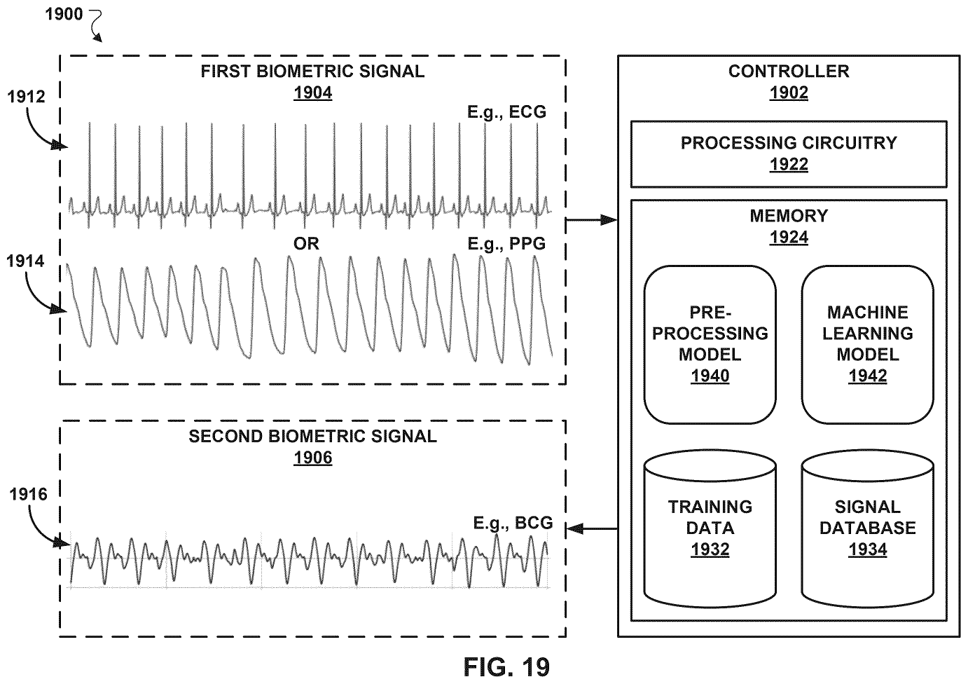

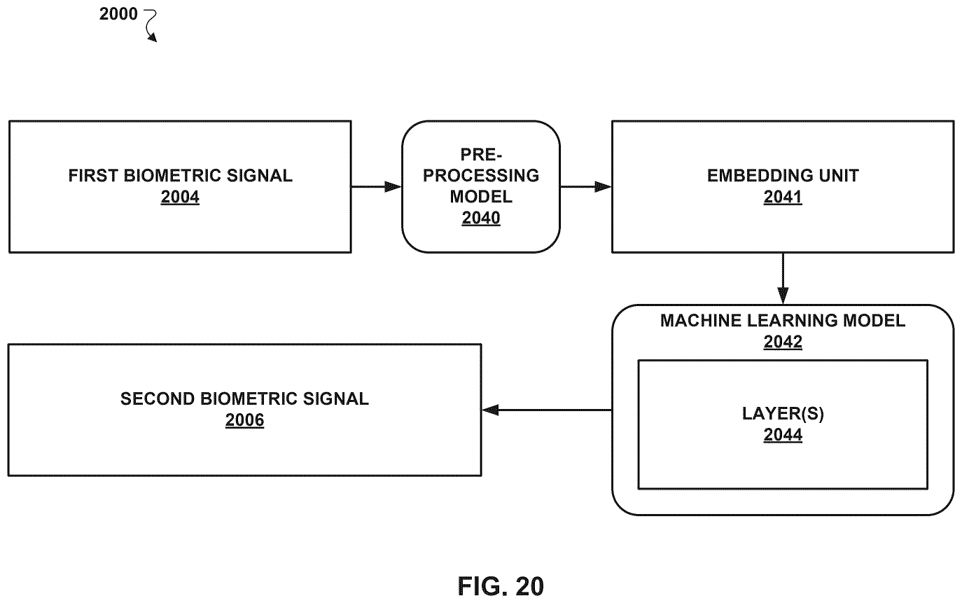

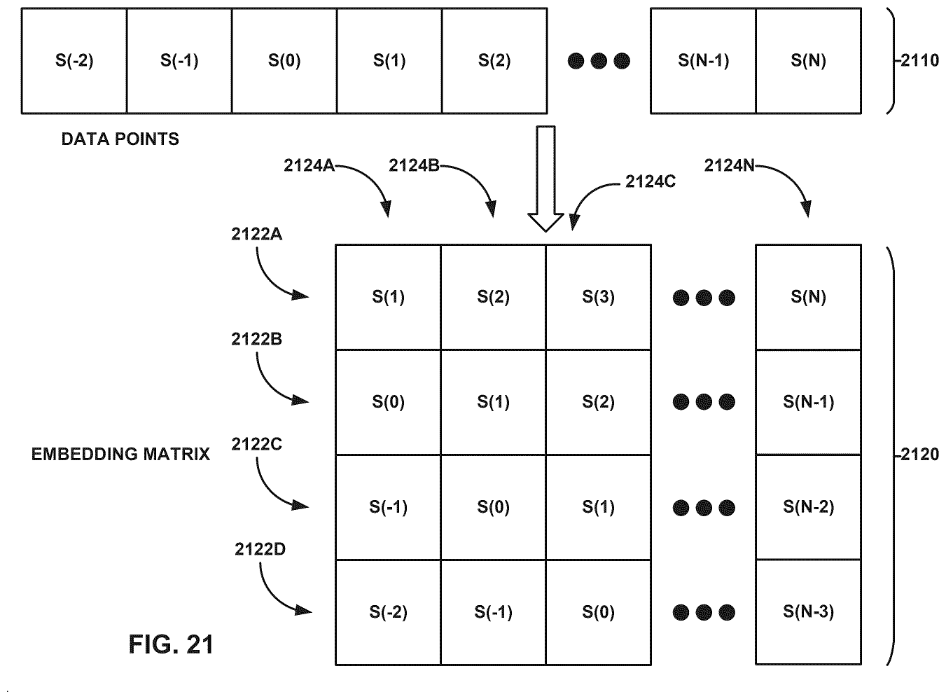

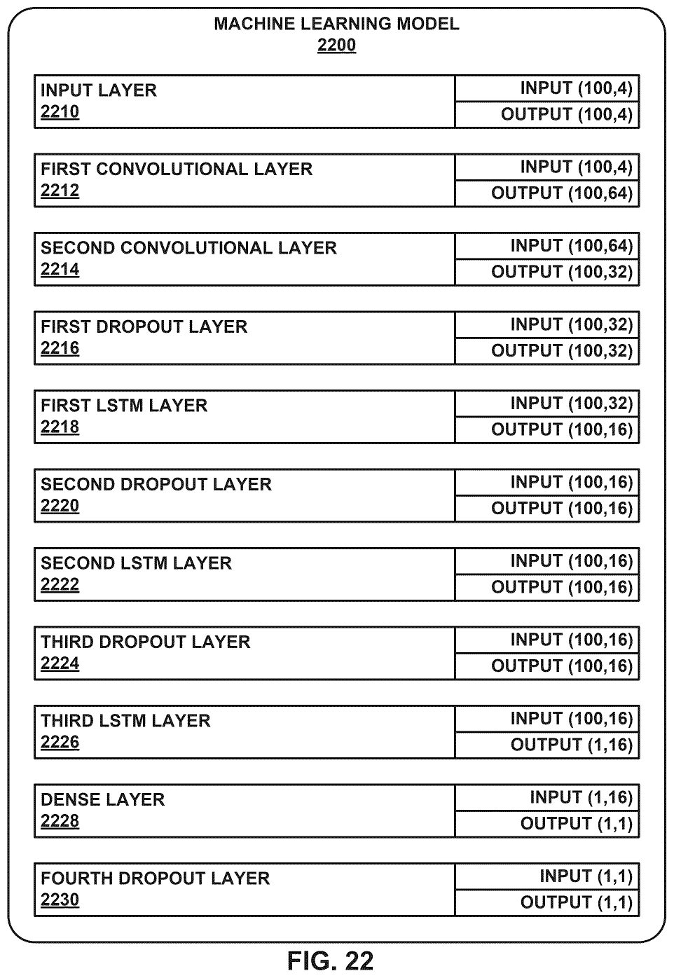

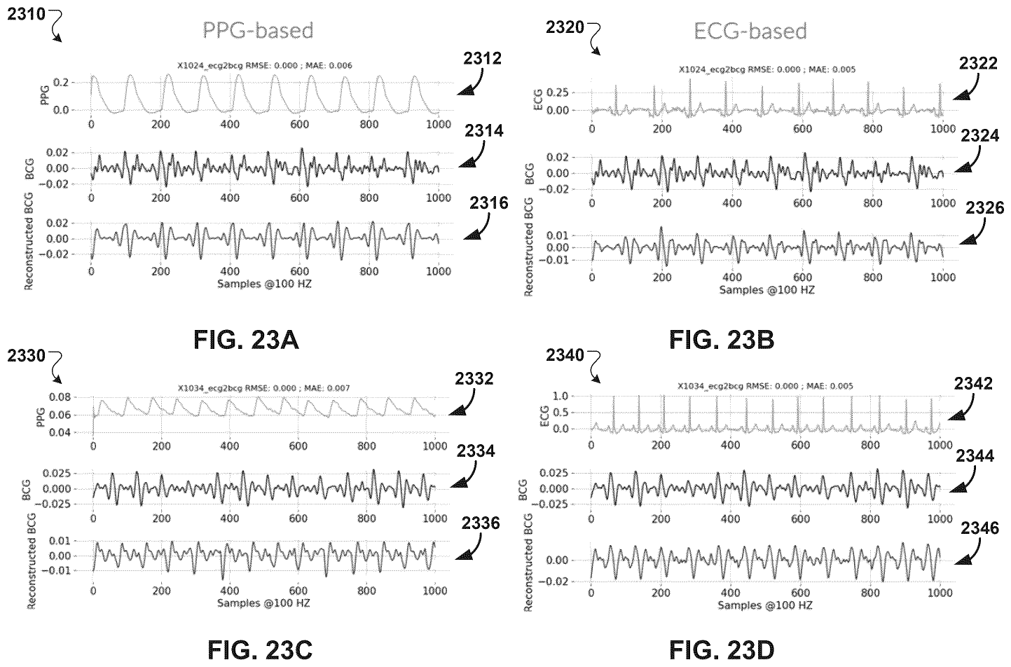

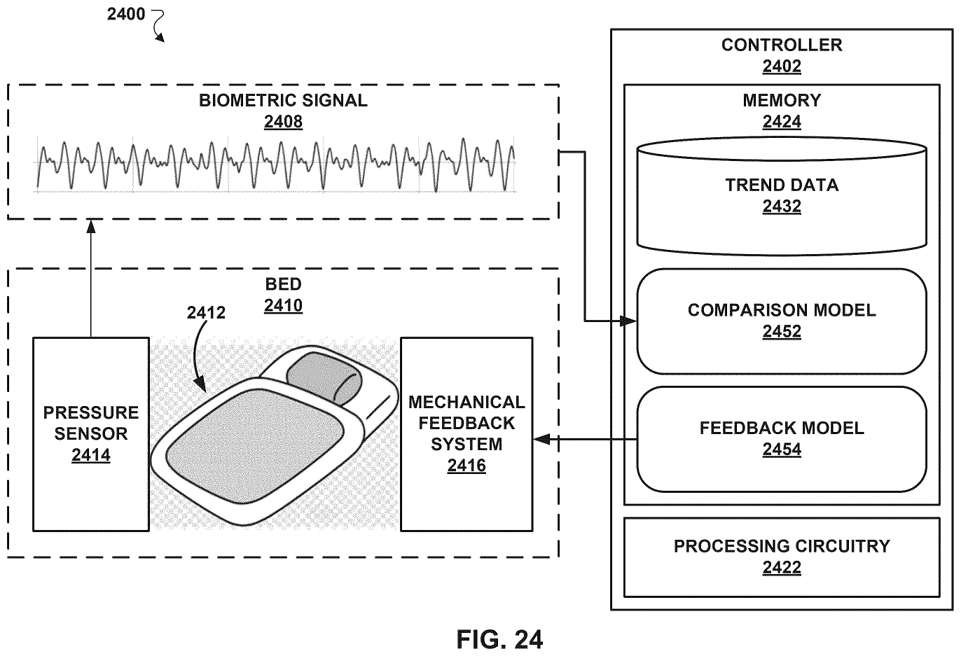

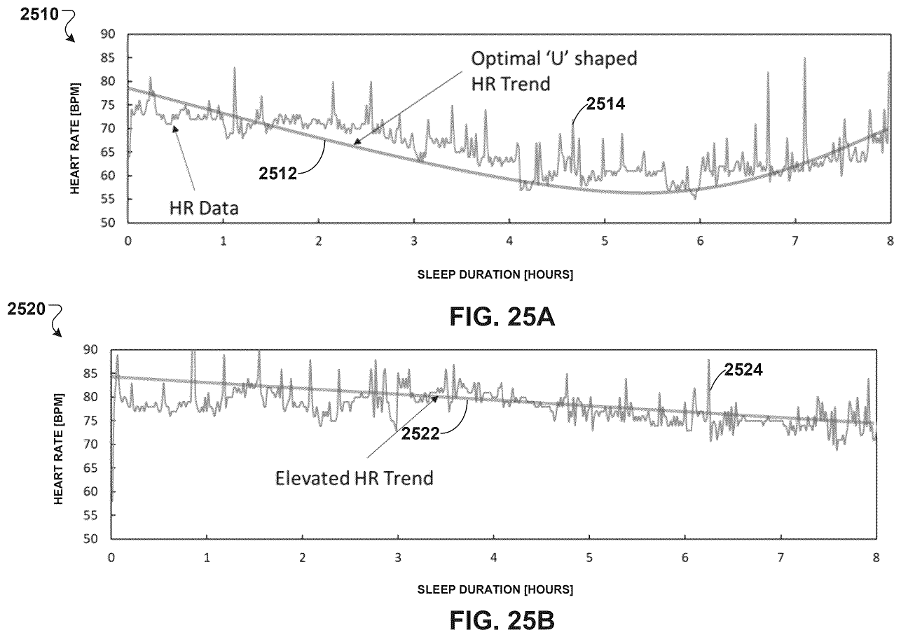

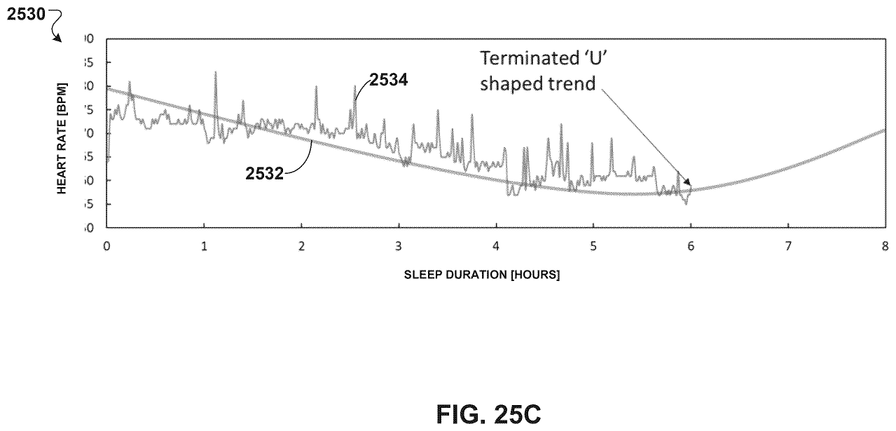

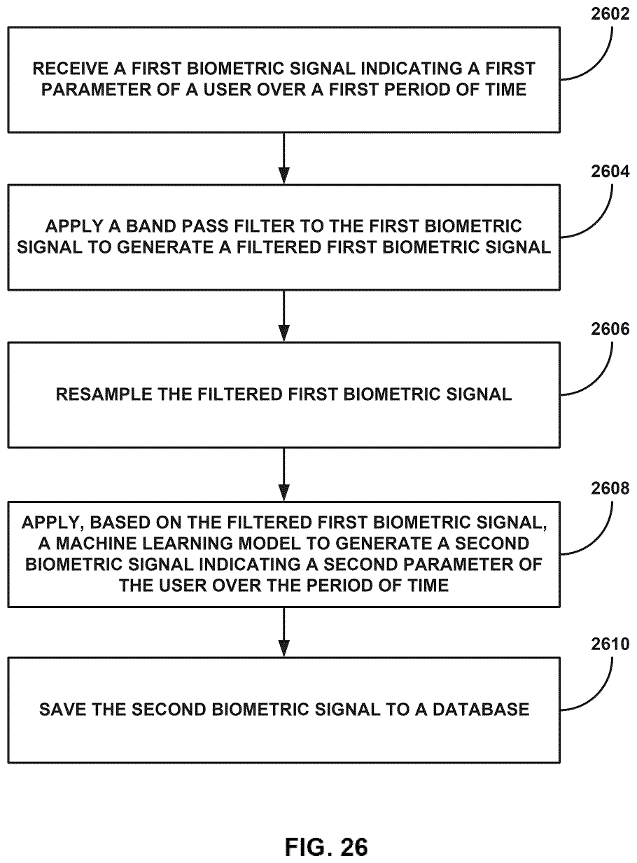

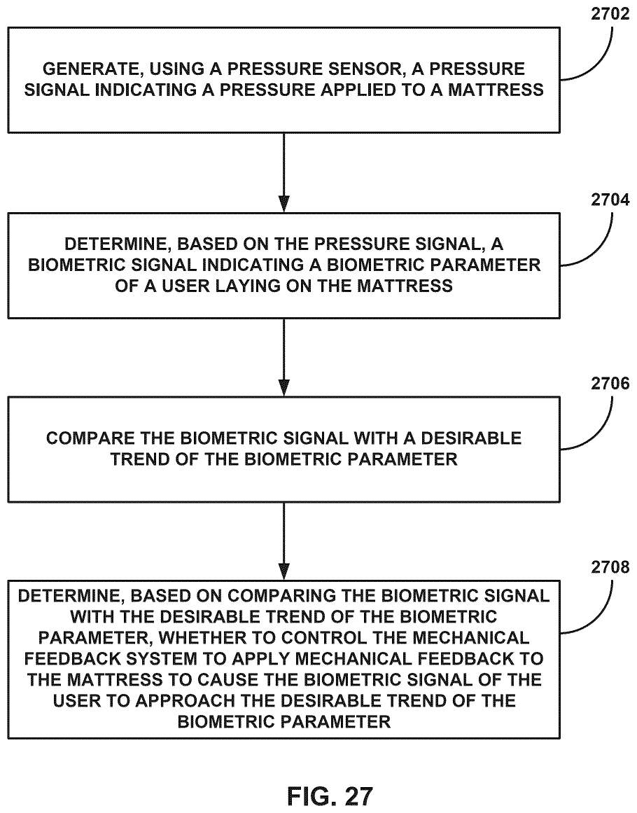

FIG. 3 shows an example environment 300 including a bed 302 in communication with devices located in and around a home. In the example shown, the bed 302 includes pump 304 for controlling air pressure within two air chambers 306a and 306b (as described above with respect to the air chambers 114A-114B). The pump 304 additionally includes circuitry for controlling inflation and deflation functionality performed by the pump 304. The circuitry is further programmed to detect fluctuations in air pressure of the air chambers 306a-b and used the detected fluctuations in air pressure to identify bed presence of a user 308, sleep state of the user 308, movement of the user 308, and biometric signals of the user 308 such as heart rate and respiration rate. In the example shown, the pump 304 is located within a support structure of the bed 302 and the control circuitry 334 for controlling the pump 304 is integrated with the pump 304. In some implementations, the control circuitry 334 is physically separate from the pump 304 and is in wireless or wired communication with the pump 304. In some implementations, the pump 304 and/or control circuitry 334 are located outside of the bed 302. In some implementations, various control functions can be performed by systems located in different physical locations. For example, circuitry for controlling actions of the pump 304 can be located within a pump casing of the pump 304 while control circuitry 334 for performing other functions associated with the bed 302 can be located in another portion of the bed 302, or external to the bed 302. As another example, control circuitry 334 located within the pump 304 can communicate with control circuitry 334 at a remote location through a LAN or WAN (e.g., the internet). As yet another example, the control circuitry 334 can be included in the control box 124 of FIGS. 1 and 2.

In some implementations, one or more devices other than, or in addition to, the pump 304 and control circuitry 334 can be utilized to identify user bed presence, sleep state, movement, and biometric signals. For example, the bed 302 can include a second pump in addition to the pump 304, with each of the two pumps connected to a respective one of the air chambers 306a-b. For example, the pump 304 can be in fluid communication with the air chamber 306b to control inflation and deflation of the air chamber 306b as well as detect user signals for a user located over the air chamber 306b such as bed presence, sleep state, movement, and biometric signals while the second pump is in fluid communication with the air chamber 306a to control inflation and deflation of the air chamber 306a as well as detect user signals for a user located over the air chamber 306a.

As another example, the bed 302 can include one or more pressure sensitive pads or surface portions that are operable to detect movement, including user presence, user motion, respiration, and heart rate. For example, a first pressure sensitive pad can be incorporated into a surface of the bed 302 over a left portion of the bed 302, where a first user would normally be located during sleep, and a second pressure sensitive pad can be incorporated into the surface of the bed 302 over a right portion of the bed 302, where a second user would normally be located during sleep. The movement detected by the one or more pressure sensitive pads or surface portions can be used by control circuitry 334 to identify user sleep state, bed presence, or biometric signals.

In some implementations, information detected by the bed (e.g., motion information) is processed by control circuitry 334 (e.g., control circuitry 334 integrated with the pump 304) and provided to one or more user devices such as a user device 310 for presentation to the user 308 or to other users. In the example depicted in FIG. 3, the user device 310 is a tablet device; however, in some implementations, the user device 310 can be a personal computer, a smart phone, a smart television (e.g., a television 312), or other user device capable of wired or wireless communication with the control circuitry 334. The user device 310 can be in communication with control circuitry 334 of the bed 302 through a network or through direct point-to-point communication. For example, the control circuitry 334 can be connected to a LAN (e.g., through a Wi-Fi router) and communicate with the user device 310 through the LAN. As another example, the control circuitry 334 and the user device 310 can both connect to the Internet and communicate through the Internet. For example, the control circuitry 334 can connect to the Internet through a WiFi router and the user device 310 can connect to the Internet through communication with a cellular communication system. As another example, the control circuitry 334 can communicate directly with the user device 310 through a wireless communication protocol such as Bluetooth. As yet another example, the control circuitry 334 can communicate with the user device 310 through a wireless communication protocol such as ZigBee, Z-Wave, infrared, or another wireless communication protocol suitable for the application. As another example, the control circuitry 334 can communicate with the user device 310 through a wired connection such as, for example, a USB connector, serial/RS232, or another wired connection suitable for the application.

The user device 310 can display a variety of information and statistics related to sleep, or user 308′s interaction with the bed 302. For example, a user interface displayed by the user device 310 can present information including amount of sleep for the user 308 over a period of time (e.g., a single evening, a week, a month, etc.) amount of deep sleep, ratio of deep sleep to restless sleep, time lapse between the user 308 getting into bed and the user 308 falling asleep, total amount of time spent in the bed 302 for a given period of time, heart rate for the user 308 over a period of time, respiration rate for the user 308 over a period of time, or other information related to user interaction with the bed 302 by the user 308 or one or more other users of the bed 302. In some implementations, information for multiple users can be presented on the user device 310, for example information for a first user positioned over the air chamber 306a can be presented along with information for a second user positioned over the air chamber 306b. In some implementations, the information presented on the user device 310 can vary according to the age of the user 308. For example, the information presented on the user device 310 can evolve with the age of the user 308 such that different information is presented on the user device 310 as the user 308 ages as a child or an adult.

The user device 310 can also be used as an interface for the control circuitry 334 of the bed 302 to allow the user 308 to enter information. The information entered by the user 308 can be used by the control circuitry 334 to provide better information to the user or to various control signals for controlling functions of the bed 302 or other devices. For example, the user can enter information such as weight, height, and age and the control circuitry 334 can use this information to provide the user 308 with a comparison of the user's tracked sleep information to sleep information of other people having similar weights, heights, and/or ages as the user 308. As another example, the user 308 can use the user device 310 as an interface for controlling air pressure of the air chambers 306a and 306b, for controlling various recline or incline positions of the bed 302, for controlling temperature of one or more surface temperature control devices of the bed 302, or for allowing the control circuitry 334 to generate control signals for other devices (as described in greater detail below).

In some implementations, control circuitry 334 of the bed 302 (e.g., control circuitry 334 integrated into the pump 304) can communicate with other first, second, or third party devices or systems in addition to or instead of the user device 310. For example, the control circuitry 334 can communicate with the television 312, a lighting system 314, a thermostat 316, a security system 318, or other household devices such as an oven 322, a coffee maker 324, a lamp 326, and a nightlight 328. Other examples of devices and/or systems that the control circuitry 334 can communicate with include a system for controlling window blinds 330, one or more devices for detecting or controlling the states of one or more doors 332 (such as detecting if a door is open, detecting if a door is locked, or automatically locking a door), and a system for controlling a garage door 320 (e.g., control circuitry 334 integrated with a garage door opener for identifying an open or closed state of the garage door 320 and for causing the garage door opener to open or close the garage door 320). Communications between the control circuitry 334 of the bed 302 and other devices can occur through a network (e.g., a LAN or the Internet) or as point-to-point communication (e.g., using Bluetooth, radio communication, or a wired connection). In some implementations, control circuitry 334 of different beds 302 can communicate with different sets of devices. For example, a kid bed may not communicate with and/or control the same devices as an adult bed. In some embodiments, the bed 302 can evolve with the age of the user such that the control circuitry 334 of the bed 302 communicates with different devices as a function of age of the user.

The control circuitry 334 can receive information and inputs from other devices/systems and use the received information and inputs to control actions of the bed 302 or other devices. For example, the control circuitry 334 can receive information from the thermostat 316 indicating a current environmental temperature for a house or room in which the bed 302 is located. The control circuitry 334 can use the received information (along with other information) to determine if a temperature of all or a portion of the surface of the bed 302 should be raised or lowered. The control circuitry 334 can then cause a heating or cooling mechanism of the bed 302 to raise or lower the temperature of the surface of the bed 302. For example, the user 308 can indicate a desired sleeping temperature of 74 degrees while a second user of the bed 302 indicates a desired sleeping temperature of 72 degrees. The thermostat 316 can indicate to the control circuitry 334 that the current temperature of the bedroom is 72 degrees. The control circuitry 334 can identify that the user 308 has indicated a desired sleeping temperature of 74 degrees and send control signals to a heating pad located on the user 308's side of the bed to raise the temperature of the portion of the surface of the bed 302 where the user 308 is located to raise the temperature of the user 308's sleeping surface to the desired temperature.

The control circuitry 334 can also generate control signals controlling other devices and propagate the control signals to the other devices. In some implementations, the control signals are generated based on information collected by the control circuitry 334, including information related to user interaction with the bed 302 by the user 308 and/or one or more other users. In some implementations, information collected from one or more other devices other than the bed 302 are used when generating the control signals. For example, information relating to environmental occurrences (e.g., environmental temperature, environmental noise level, and environmental light level), time of day, time of year, day of the week, or other information can be used when generating control signals for various devices in communication with the control circuitry 334 of the bed 302. For example, information on the time of day can be combined with information relating to movement and bed presence of the user 308 to generate control signals for the lighting system 314. In some implementations, rather than or in addition to providing control signals for one or more other devices, the control circuitry 334 can provide collected information (e.g., information related to user movement, bed presence, sleep state, or biometric signals for the user 308) to one or more other devices to allow the one or more other devices to utilize the collected information when generating control signals. For example, control circuitry 334 of the bed 302 can provide information relating to user interactions with the bed 302 by the user 308 to a central controller (not shown) that can use the provided information to generate control signals for various devices, including the bed 302.

Still referring to FIG. 3, the control circuitry 334 of the bed 302 can generate control signals for controlling actions of other devices and transmit the control signals to the other devices in response to information collected by the control circuitry 334, including bed presence of the user 308, sleep state of the user 308, and other factors. For example, control circuitry 334 integrated with the pump 304 can detect a feature of a mattress of the bed 302, such as an increase in pressure in the air chamber 306b and use this detected increase in air pressure to determine that the user 308 is present on the bed 302. In some implementations, the control circuitry 334 can identify a heart rate or respiratory rate for the user 308 to identify that the increase in pressure is due to a person sitting, laying, or otherwise resting on the bed 302 rather than an inanimate object (such as a suitcase) having been placed on the bed 302. In some implementations, the information indicating user bed presence is combined with other information to identify a current or future likely state for the user 308. For example, a detected user bed presence at 11:00 am can indicate that the user is sitting on the bed (e.g., to tie her shoes, or to read a book) and does not intend to go to sleep, while a detected user bed presence at 10:00 pm can indicate that the user 308 is in bed for the evening and is intending to fall asleep soon. As another example, if the control circuitry 334 detects that the user 308 has left the bed 302 at 6:30 am (e.g., indicating that the user 308 has woken up for the day), and then later detects user bed presence of the user 308 at 7:30 am, the control circuitry 334 can use this information that the newly detected user bed presence is likely temporary (e.g., while the user 308 ties her shoes before heading to work) rather than an indication that the user 308 is intending to stay on the bed 302 for an extended period.

In some implementations, the control circuitry 334 is able to use collected information (including information related to user interaction with the bed 302 by the user 308, as well as environmental information, time information, and input received from the user) to identify use patterns for the user 308. For example, the control circuitry 334 can use information indicating bed presence and sleep states for the user 308 collected over a period of time to identify a sleep pattern for the user. For example, the control circuitry 334 can identify that the user 308 generally goes to bed between 9:30 pm and 10:00 pm, generally falls asleep between 10:00 pm and 11:00 pm, and generally wakes up between 6:30 am and 6:45 am based on information indicating user presence and biometrics for the user 308 collected over a week. The control circuitry 334 can use identified patterns for a user to better process and identify user interactions with the bed 302 by the user 308.

For example, given the above example user bed presence, sleep, and wake patterns for the user 308, if the user 308 is detected as being on the bed at 3:00 pm, the control circuitry 334 can determine that the user's presence on the bed is only temporary, and use this determination to generate different control signals than would be generated if the control circuitry 334 determined that the user 308 was in bed for the evening. As another example, if the control circuitry 334 detects that the user 308 has gotten out of bed at 3:00 am, the control circuitry 334 can use identified patterns for the user 308 to determine that the user has only gotten up temporarily (for example, to use the rest room, or get a glass of water) and is not up for the day. By contrast, if the control circuitry 334 identifies that the user 308 has gotten out of the bed 302 at 6:40 am, the control circuitry 334 can determine that the user is up for the day and generate a different set of control signals than those that would be generated if it were determined that the user 308 were only getting out of bed temporarily (as would be the case when the user 308 gets out of the bed 302 at 3:00 am). For other users 308, getting out of the bed 302 at 3:00 am can be the normal wake-up time, which the control circuitry 334 can learn and respond to accordingly.

As described above, the control circuitry 334 for the bed 302 can generate control signals for control functions of various other devices. The control signals can be generated, at least in part, based on detected interactions by the user 308 with the bed 302, as well as other information including time, date, temperature, etc. For example, the control circuitry 334 can communicate with the television 312, receive information from the television 312, and generate control signals for controlling functions of the television 312. For example, the control circuitry 334 can receive an indication from the television 312 that the television 312 is currently on. If the television 312 is located in a different room from the bed 302, the control circuitry 334 can generate a control signal to turn the television 312 off upon making a determination that the user 308 has gone to bed for the evening. For example, if bed presence of the user 308 on the bed 302 is detected during a particular time range (e.g., between 8:00 pm and 7:00 am) and persists for longer than a threshold period of time (e.g., 10 minutes) the control circuitry 334 can use this information to determine that the user 308 is in bed for the evening. If the television 312 is on (as indicated by communications received by the control circuitry 334 of the bed 302 from the television 312) the control circuitry 334 can generate a control signal to turn the television 312 off. The control signals can then be transmitted to the television (e.g., through a directed communication link between the television 312 and the control circuitry 334 or through a network). As another example, rather than turning off the television 312 in response to detection of user bed presence, the control circuitry 334 can generate a control signal that causes the volume of the television 312 to be lowered by a pre-specified amount.

As another example, upon detecting that the user 308 has left the bed 302 during a specified time range (e.g., between 6:00 am and 8:00 am) the control circuitry 334 can generate control signals to cause the television 312 to turn on and tune to a pre-specified channel (e.g., the user 308 has indicated a preference for watching the morning news upon getting out of bed in the morning). The control circuitry 334 can generate the control signal and transmit the signal to the television 312 to cause the television 312 to turn on and tune to the desired station (which could be stored at the control circuitry 334, the television 312, or another location). As another example, upon detecting that the user 308 has gotten up for the day, the control circuitry 334 can generate and transmit control signals to cause the television 312 to turn on and begin playing a previously recorded program from a digital video recorder (DVR) in communication with the television 312.

As another example, if the television 312 is in the same room as the bed 302, the control circuitry 334 does not cause the television 312 to turn off in response to detection of user bed presence. Rather, the control circuitry 334 can generate and transmit control signals to cause the television 312 to turn off in response to determining that the user 308 is asleep. For example, the control circuitry 334 can monitor biometric signals of the user 308 (e.g., motion, heart rate, respiration rate) to determine that the user 308 has fallen asleep. Upon detecting that the user 308 is sleeping, the control circuitry 334 generates and transmits a control signal to turn the television 312 off. As another example, the control circuitry 334 can generate the control signal to turn off the television 312 after a threshold period of time after the user 308 has fallen asleep (e.g., 10 minutes after the user has fallen asleep). As another example, the control circuitry 334 generates control signals to lower the volume of the television 312 after determining that the user 308 is asleep. As yet another example, the control circuitry 334 generates and transmits a control signal to cause the television to gradually lower in volume over a period of time and then turn off in response to determining that the user 308 is asleep.

In some implementations, the control circuitry 334 can similarly interact with other media devices, such as computers, tablets, smart phones, stereo systems, etc. For example, upon detecting that the user 308 is asleep, the control circuitry 334 can generate and transmit a control signal to the user device 310 to cause the user device 310 to turn off or turn down the volume on a video or audio file being played by the user device 310.

The control circuitry 334 can additionally communicate with the lighting system 314, receive information from the lighting system 314, and generate control signals for controlling functions of the lighting system 314. For example, upon detecting user bed presence on the bed 302 during a certain time frame (e.g., between 8:00 pm and 7:00 am) that lasts for longer than a threshold period of time (e.g., 10 minutes) the control circuitry 334 of the bed 302 can determine that the user 308 is in bed for the evening. In response to this determination, the control circuitry 334 can generate control signals to cause lights in one or more rooms other than the room in which the bed 302 is located to switch off. The control signals can then be transmitted to the lighting system 314 and executed by the lighting system 314 to cause the lights in the indicated rooms to shut off. For example, the control circuitry 334 can generate and transmit control signals to turn off lights in all common rooms, but not in other bedrooms. As another example, the control signals generated by the control circuitry 334 can indicate that lights in all rooms other than the room in which the bed 302 is located are to be turned off, while one or more lights located outside of the house containing the bed 302 are to be turned on, in response to determining that the user 308 is in bed for the evening. Additionally, the control circuitry 334 can generate and transmit control signals to cause the nightlight 328 to turn on in response to determining user 308 bed presence or whether the user 308 is asleep. As another example, the control circuitry 334 can generate first control signals for turning off a first set of lights (e.g., lights in common rooms) in response to detecting user bed presence, and second control signals for turning off a second set of lights (e.g., lights in the room in which the bed 302 is located) in response to detecting that the user 308 is asleep.

In some implementations, in response to determining that the user 308 is in bed for the evening, the control circuitry 334 of the bed 302 can generate control signals to cause the lighting system 314 to implement a sunset lighting scheme in the room in which the bed 302 is located. A sunset lighting scheme can include, for example, dimming the lights (either gradually over time, or all at once) in combination with changing the color of the light in the bedroom environment, such as adding an amber hue to the lighting in the bedroom. The sunset lighting scheme can help to put the user 308 to sleep when the control circuitry 334 has determined that the user 308 is in bed for the evening.

The control circuitry 334 can also be configured to implement a sunrise lighting scheme when the user 308 wakes up in the morning. The control circuitry 334 can determine that the user 308 is awake for the day, for example, by detecting that the user 308 has gotten off of the bed 302 (i.e., is no longer present on the bed 302) during a specified time frame (e.g., between 6:00 am and 8:00 am). As another example, the control circuitry 334 can monitor movement, heart rate, respiratory rate, or other biometric signals of the user 308 to determine that the user 308 is awake even though the user 308 has not gotten out of bed. If the control circuitry 334 detects that the user is awake during a specified time frame, the control circuitry 334 can determine that the user 308 is awake for the day. The specified time frame can be, for example, based on previously recorded user bed presence information collected over a period of time (e.g., two weeks) that indicates that the user 308 usually wakes up for the day between 6:30 am and 7:30 am. In response to the control circuitry 334 determining that the user 308 is awake, the control circuitry 334 can generate control signals to cause the lighting system 314 to implement the sunrise lighting scheme in the bedroom in which the bed 302 is located. The sunrise lighting scheme can include, for example, turning on lights (e.g., the lamp 326, or other lights in the bedroom). The sunrise lighting scheme can further include gradually increasing the level of light in the room where the bed 302 is located (or in one or more other rooms). The sunrise lighting scheme can also include only turning on lights of specified colors. For example, the sunrise lighting scheme can include lighting the bedroom with blue light to gently assist the user 308 in waking up and becoming active.

In some implementations, the control circuitry 334 can generate different control signals for controlling actions of one or more components, such as the lighting system 314, depending on a time of day that user interactions with the bed 302 are detected. For example, the control circuitry 334 can use historical user interaction information for interactions between the user 308 and the bed 302 to determine that the user 308 usually falls asleep between 10:00 pm and 11:00 pm and usually wakes up between 6:30 am and 7:30 am on weekdays. The control circuitry 334 can use this information to generate a first set of control signals for controlling the lighting system 314 if the user 308 is detected as getting out of bed at 3:00 am and to generate a second set of control signals for controlling the lighting system 314 if the user 308 is detected as getting out of bed after 6:30 am. For example, if the user 308 gets out of bed prior to 6:30 am, the control circuitry 334 can turn on lights that guide the user 308's route to a restroom. As another example, if the user 308 gets out of bed prior to 6:30 am, the control circuitry 334 can turn on lights that guide the user 308's route to the kitchen (which can include, for example, turning on the nightlight 328, turning on under bed lighting, or turning on the lamp 326).

As another example, if the user 308 gets out of bed after 6:30 am, the control circuitry 334 can generate control signals to cause the lighting system 314 to initiate a sunrise lighting scheme, or to turn on one or more lights in the bedroom and/or other rooms. In some implementations, if the user 308 is detected as getting out of bed prior to a specified morning rise time for the user 308, the control circuitry 334 causes the lighting system 314 to turn on lights that are dimmer than lights that are turned on by the lighting system 314 if the user 308 is detected as getting out of bed after the specified morning rise time. Causing the lighting system 314 to only turn on dim lights when the user 308 gets out of bed during the night (i.e., prior to normal rise time for the user 308) can prevent other occupants of the house from being woken by the lights while still allowing the user 308 to see in order to reach the restroom, kitchen, or another destination within the house.

The historical user interaction information for interactions between the user 308 and the bed 302 can be used to identify user sleep and awake time frames. For example, user bed presence times and sleep times can be determined for a set period of time (e.g., two weeks, a month, etc.). The control circuitry 334 can then identify a typical time range or time frame in which the user 308 goes to bed, a typical time frame for when the user 308 falls asleep, and a typical time frame for when the user 308 wakes up (and in some cases, different time frames for when the user 308 wakes up and when the user 308 actually gets out of bed). In some implementations, buffer time can be added to these time frames. For example, if the user is identified as typically going to bed between 10:00 pm and 10:30 pm, a buffer of a half hour in each direction can be added to the time frame such that any detection of the user getting onto the bed between 9:30 pm and 11:00 pm is interpreted as the user 308 going to bed for the evening. As another example, detection of bed presence of the user 308 starting from a half hour before the earliest typical time that the user 308 goes to bed extending until the typical wake up time (e.g., 6:30 am) for the user can be interpreted as the user going to bed for the evening. For example, if the user typically goes to bed between 10:00 pm and 10:30 pm, if the user's bed presence is sensed at 12:30 am one night, that can be interpreted as the user getting into bed for the evening even though this is outside of the user's typical time frame for going to bed because it has occurred prior to the user's normal wake up time. In some implementations, different time frames are identified for different times of the year (e.g., earlier bedtime during winter vs. summer) or at different times of the week (e.g., user wakes up earlier on weekdays than on weekends).

The control circuitry 334 can distinguish between the user 308 going to bed for an extended period (such as for the night) as opposed to being present on the bed 302 for a shorter period (such as for a nap) by sensing duration of presence of the user 308. In some examples, the control circuitry 334 can distinguish between the user 308 going to bed for an extended period (such as for the night) as opposed to going to bed for a shorter period (such as for a nap) by sensing duration of sleep of the user 308. For example, the control circuitry 334 can set a time threshold whereby if the user 308 is sensed on the bed 302 for longer than the threshold, the user 308 is considered to have gone to bed for the night. In some examples, the threshold can be about 2 hours, whereby if the user 308 is sensed on the bed 302 for greater than 2 hours, the control circuitry 334 registers that as an extended sleep event. In other examples, the threshold can be greater than or less than two hours.

The control circuitry 334 can detect repeated extended sleep events to determine a typical bedtime range of the user 308 automatically, without requiring the user 308 to enter a bed time range. This can allow the control circuitry 334 to accurately estimate when the user 308 is likely to go to bed for an extended sleep event, regardless of whether the user 308 typically goes to bed using a traditional sleep schedule or a non-traditional sleep schedule. The control circuitry 334 can then use knowledge of the bedtime range of the user 308 to control one or more components (including components of the bed 302 and/or non-bed peripherals) differently based on sensing bed presence during the bed time range or outside of the bed time range.

In some examples, the control circuitry 334 can automatically determine the bedtime range of the user 308 without requiring user inputs. In some examples, the control circuitry 334 can determine the bedtime range of the user 308 automatically and in combination with user inputs. In some examples, the control circuitry 334 can set the bedtime range directly according to user inputs. In some examples, the control circuity 334 can associate different bedtimes with different days of the week. In each of these examples, the control circuitry 334 can control one or more components (such as the lighting system 314, the thermostat 316, the security system 318, the oven 322, the coffee maker 324, the lamp 326, and the nightlight 328), as a function of sensed bed presence and the bedtime range.

The control circuitry 334 can additionally communicate with the thermostat 316, receive information from the thermostat 316, and generate control signals for controlling functions of the thermostat 316. For example, the user 308 can indicate user preferences for different temperatures at different times, depending on the sleep state or bed presence of the user 308. For example, the user 308 may prefer an environmental temperature of 72 degrees when out of bed, 70 degrees when in bed but awake, and 68 degrees when sleeping. The control circuitry 334 of the bed 302 can detect bed presence of the user 308 in the evening and determine that the user 308 is in bed for the night. In response to this determination, the control circuitry 334 can generate control signals to cause the thermostat to change the temperature to 70 degrees. The control circuitry 334 can then transmit the control signals to the thermostat 316. Upon detecting that the user 308 is in bed during the bedtime range or asleep, the control circuitry 334 can generate and transmit control signals to cause the thermostat 316 to change the temperature to 68. The next morning, upon determining that the user is awake for the day (e.g., the user 308 gets out of bed after 6:30 am) the control circuitry 334 can generate and transmit control circuitry 334 to cause the thermostat to change the temperature to 72 degrees.

In some implementations, the control circuitry 334 can similarly generate control signals to cause one or more heating or cooling elements on the surface of the bed 302 to change temperature at various times, either in response to user interaction with the bed 302 or at various pre-programmed times. For example, the control circuitry 334 can activate a heating element to raise the temperature of one side of the surface of the bed 302 to 73 degrees when it is detected that the user 308 has fallen asleep. As another example, upon determining that the user 308 is up for the day, the control circuitry 334 can turn off a heating or cooling element. As yet another example, the user 308 can pre-program various times at which the temperature at the surface of the bed should be raised or lowered. For example, the user can program the bed 302 to raise the surface temperature to 76 degrees at 10:00 pm and lower the surface temperature to 68 degrees at 11:30 pm.

In some implementations, in response to detecting user bed presence of the user 308 and/or that the user 308 is asleep, the control circuitry 334 can cause the thermostat 316 to change the temperature in different rooms to different values. For example, in response to determining that the user 308 is in bed for the evening, the control circuitry 334 can generate and transmit control signals to cause the thermostat 316 to set the temperature in one or more bedrooms of the house to 72 degrees and set the temperature in other rooms to 67 degrees.

The control circuitry 334 can also receive temperature information from the thermostat 316 and use this temperature information to control functions of the bed 302 or other devices. For example, as discussed above, the control circuitry 334 can adjust temperatures of heating elements included in the bed 302 in response to temperature information received from the thermostat 316.

In some implementations, the control circuitry 334 can generate and transmit control signals for controlling other temperature control systems. For example, in response to determining that the user 308 is awake for the day, the control circuitry 334 can generate and transmit control signals for causing floor heating elements to activate. For example, the control circuitry 334 can cause a floor heating system for a master bedroom to turn on in response to determining that the user 308 is awake for the day.

The control circuitry 334 can additionally communicate with the security system 318, receive information from the security system 318, and generate control signals for controlling functions of the security system 318. For example, in response to detecting that the user 308 in is bed for the evening, the control circuitry 334 can generate control signals to cause the security system to engage or disengage security functions. The control circuitry 334 can then transmit the control signals to the security system 318 to cause the security system 318 to engage. As another example, the control circuitry 334 can generate and transmit control signals to cause the security system 318 to disable in response to determining that the user 308 is awake for the day (e.g., user 308 is no longer present on the bed 302 after 6:00 am). In some implementations, the control circuitry 334 can generate and transmit a first set of control signals to cause the security system 318 to engage a first set of security features in response to detecting user bed presence of the user 308, and can generate and transmit a second set of control signals to cause the security system 318 to engage a second set of security features in response to detecting that the user 308 has fallen asleep.

In some implementations, the control circuitry 334 can receive alerts from the security system 318 (and/or a cloud service associated with the security system 318) and indicate the alert to the user 308. For example, the control circuitry 334 can detect that the user 308 is in bed for the evening and in response, generate and transmit control signals to cause the security system 318 to engage or disengage. The security system can then detect a security breach (e.g., someone has opened the door 332 without entering the security code, or someone has opened a window when the security system 318 is engaged). The security system 318 can communicate the security breach to the control circuitry 334 of the bed 302. In response to receiving the communication from the security system 318, the control circuitry 334 can generate control signals to alert the user 308 to the security breach. For example, the control circuitry 334 can cause the bed 302 to vibrate. As another example, the control circuitry 334 can cause portions of the bed 302 to articulate (e.g., cause the head section to raise or lower) in order to wake the user 308 and alert the user to the security breach. As another example, the control circuitry 334 can generate and transmit control signals to cause the lamp 326 to flash on and off at regular intervals to alert the user 308 to the security breach. As another example, the control circuitry 334 can alert the user 308 of one bed 302 regarding a security breach in a bedroom of another bed, such as an open window in a kid's bedroom. As another example, the control circuitry 334 can send an alert to a garage door controller (e.g., to close and lock the door). As another example, the control circuitry 334 can send an alert for the security to be disengaged.

The control circuitry 334 can additionally generate and transmit control signals for controlling the garage door 320 and receive information indicating a state of the garage door 320 (i.e., open or closed). For example, in response to determining that the user 308 is in bed for the evening, the control circuitry 334 can generate and transmit a request to a garage door opener or another device capable of sensing if the garage door 320 is open. The control circuitry 334 can request information on the current state of the garage door 320. If the control circuitry 334 receives a response (e.g., from the garage door opener) indicating that the garage door 320 is open, the control circuitry 334 can either notify the user 308 that the garage door is open or generate a control signal to cause the garage door opener to close the garage door 320. For example, the control circuitry 334 can send a message to the user device 310 indicating that the garage door is open. As another example, the control circuitry 334 can cause the bed 302 to vibrate. As yet another example, the control circuitry 334 can generate and transmit a control signal to cause the lighting system 314 to cause one or more lights in the bedroom to flash to alert the user 308 to check the user device 310 for an alert (in this example, an alert regarding the garage door 320 being open). Alternatively, or additionally, the control circuitry 334 can generate and transmit control signals to cause the garage door opener to close the garage door 320 in response to identifying that the user 308 is in bed for the evening and that the garage door 320 is open. In some implementations, control signals can vary depend on the age of the user 308.

The control circuitry 334 can similarly send and receive communications for controlling or receiving state information associated with the door 332 or the oven 322. For example, upon detecting that the user 308 is in bed for the evening, the control circuitry 334 can generate and transmit a request to a device or system for detecting a state of the door 332. Information returned in response to the request can indicate various states for the door 332 such as open, closed but unlocked, or closed and locked. If the door 332 is open or closed but unlocked, the control circuitry 334 can alert the user 308 to the state of the door, such as in a manner described above with reference to the garage door 320. Alternatively, or in addition to alerting the user 308, the control circuitry 334 can generate and transmit control signals to cause the door 332 to lock, or to close and lock. If the door 332 is closed and locked, the control circuitry 334 can determine that no further action is needed.

Similarly, upon detecting that the user 308 is in bed for the evening, the control circuitry 334 can generate and transmit a request to the oven 322 to request a state of the oven 322 (e.g., on or off). If the oven 322 is on, the control circuitry 334 can alert the user 308 and/or generate and transmit control signals to cause the oven 322 to turn off. If the oven is already off, the control circuitry 334 can determine that no further action is necessary. In some implementations, different alerts can be generated for different events. For example, the control circuitry 334 can cause the lamp 326 (or one or more other lights, via the lighting system 314) to flash in a first pattern if the security system 318 has detected a breach, flash in a second pattern if garage door 320 is on, flash in a third pattern if the door 332 is open, flash in a fourth pattern if the oven 322 is on, and flash in a fifth pattern if another bed has detected that a user of that bed has gotten up (e.g., that a child of the user 308 has gotten out of bed in the middle of the night as sensed by a sensor in the bed 302 of the child). Other examples of alerts that can be processed by the control circuitry 334 of the bed 302 and communicated to the user include a smoke detector detecting smoke (and communicating this detection of smoke to the control circuitry 334), a carbon monoxide tester detecting carbon monoxide, a heater malfunctioning, or an alert from any other device capable of communicating with the control circuitry 334 and detecting an occurrence that should be brought to the user 308′s attention.

The control circuitry 334 can also communicate with a system or device for controlling a state of the window blinds 330. For example, in response to determining that the user 308 is in bed for the evening, the control circuitry 334 can generate and transmit control signals to cause the window blinds 330 to close. As another example, in response to determining that the user 308 is up for the day (e.g., user has gotten out of bed after 6:30 am) the control circuitry 334 can generate and transmit control signals to cause the window blinds 330 to open. By contrast, if the user 308 gets out of bed prior to a normal rise time for the user 308, the control circuitry 334 can determine that the user 308 is not awake for the day and does not generate control signals for causing the window blinds 330 to open. As yet another example, the control circuitry 334 can generate and transmit control signals that cause a first set of blinds to close in response to detecting user bed presence of the user 308 and a second set of blinds to close in response to detecting that the user 308 is asleep.

The control circuitry 334 can generate and transmit control signals for controlling functions of other household devices in response to detecting user interactions with the bed 302. For example, in response to determining that the user 308 is awake for the day, the control circuitry 334 can generate and transmit control signals to the coffee maker 324 to cause the coffee maker 324 to begin brewing coffee. As another example, the control circuitry 334 can generate and transmit control signals to the oven 322 to cause the oven to begin preheating (for users that like fresh baked bread in the morning). As another example, the control circuitry 334 can use information indicating that the user 308 is awake for the day along with information indicating that the time of year is currently winter and/or that the outside temperature is below a threshold value to generate and transmit control signals to cause a car engine block heater to turn on.

As another example, the control circuitry 334 can generate and transmit control signals to cause one or more devices to enter a sleep mode in response to detecting user bed presence of the user 308, or in response to detecting that the user 308 is asleep. For example, the control circuitry 334 can generate control signals to cause a mobile phone of the user 308 to switch into sleep mode. The control circuitry 334 can then transmit the control signals to the mobile phone. Later, upon determining that the user 308 is up for the day, the control circuitry 334 can generate and transmit control signals to cause the mobile phone to switch out of sleep mode.

In some implementations, the control circuitry 334 can communicate with one or more noise control devices. For example, upon determining that the user 308 is in bed for the evening, or that the user 308 is asleep, the control circuitry 334 can generate and transmit control signals to cause one or more noise cancelation devices to activate. The noise cancelation devices can, for example, be included as part of the bed 302 or located in the bedroom with the bed 302. As another example, upon determining that the user 308 is in bed for the evening or that the user 308 is asleep, the control circuitry 334 can generate and transmit control signals to turn the volume on, off, up, or down, for one or more sound generating devices, such as a stereo system radio, computer, tablet, etc.

Additionally, functions of the bed 302 are controlled by the control circuitry 334 in response to user interactions with the bed 302. For example, the bed 302 can include an adjustable foundation and an articulation controller configured to adjust the position of one or more portions of the bed 302 by adjusting the adjustable foundation that supports the bed. For example, the articulation controller can adjust the bed 302 from a flat position to a position in which a head portion of a mattress of the bed 302 is inclined upward (e.g., to facilitate a user sitting up in bed and/or watching television). In some implementations, the bed 302 includes multiple separately articulable sections. For example, portions of the bed corresponding to the locations of the air chambers 306a and 306b can be articulated independently from each other, to allow one person positioned on the bed 302 surface to rest in a first position (e.g., a flat position) while a second person rests in a second position (e.g., a reclining position with the head raised at an angle from the waist). In some implementations, separate positions can be set for two different beds (e.g., two twin beds placed next to each other). The foundation of the bed 302 can include more than one zone that can be independently adjusted. The articulation controller can also be configured to provide different levels of massage to one or more users on the bed 302 or to cause the bed to vibrate to communicate alerts to the user 308 as described above.

The control circuitry 334 can adjust positions (e.g., incline and decline positions for the user 308 and/or an additional user of the bed 302) in response to user interactions with the bed 302. For example, the control circuitry 334 can cause the articulation controller to adjust the bed 302 to a first recline position for the user 308 in response to sensing user bed presence for the user 308. The control circuitry 334 can cause the articulation controller to adjust the bed 302 to a second recline position (e.g., a less reclined, or flat position) in response to determining that the user 308 is asleep. As another example, the control circuitry 334 can receive a communication from the television 312 indicating that the user 308 has turned off the television 312, and in response the control circuitry 334 can cause the articulation controller to adjust the position of the bed 302 to a preferred user sleeping position (e.g., due to the user turning off the television 312 while the user 308 is in bed indicating that the user 308 wishes to go to sleep).

In some implementations, the control circuitry 334 can control the articulation controller so as to wake up one user of the bed 302 without waking another user of the bed 302. For example, the user 308 and a second user of the bed 302 can each set distinct wakeup times (e.g., 6:30 am and 7:15 am respectively). When the wakeup time for the user 308 is reached, the control circuitry 334 can cause the articulation controller to vibrate or change the position of only a side of the bed on which the user 308 is located to wake the user 308 without disturbing the second user. When the wakeup time for the second user is reached, the control circuitry 334 can cause the articulation controller to vibrate or change the position of only the side of the bed on which the second user is located. Alternatively, when the second wakeup time occurs, the control circuitry 334 can utilize other methods (such as audio alarms or turning on the lights) to wake the second user since the user 308 is already awake and therefore will not be disturbed when the control circuitry 334 attempts to wake the second user.

Still referring to FIG. 3, the control circuitry 334 for the bed 302 can utilize information for interactions with the bed 302 by multiple users to generate control signals for controlling functions of various other devices. For example, the control circuitry 334 can wait to generate control signals for, for example, engaging the security system 318, or instructing the lighting system 314 to turn off lights in various rooms until both the user 308 and a second user are detected as being present on the bed 302. As another example, the control circuitry 334 can generate a first set of control signals to cause the lighting system 314 to turn off a first set of lights upon detecting bed presence of the user 308 and generate a second set of control signals for turning off a second set of lights in response to detecting bed presence of a second user. As another example, the control circuitry 334 can wait until it has been determined that both the user 308 and a second user are awake for the day before generating control signals to open the window blinds 330. As yet another example, in response to determining that the user 308 has left the bed and is awake for the day, but that a second user is still sleeping, the control circuitry 334 can generate and transmit a first set of control signals to cause the coffee maker 324 to begin brewing coffee, to cause the security system 318 to deactivate, to turn on the lamp 326, to turn off the nightlight 328, to cause the thermostat 316 to raise the temperature in one or more rooms to 72 degrees, and to open blinds (e.g., the window blinds 330) in rooms other than the bedroom in which the bed 302 is located. Later, in response to detecting that the second user is no longer present on the bed (or that the second user is awake) the control circuitry 334 can generate and transmit a second set of control signals to, for example, cause the lighting system 314 to turn on one or more lights in the bedroom, to cause window blinds in the bedroom to open, and to turn on the television 312 to a pre-specified channel.

### Examples of Data Processing Systems Associated with a Bed

Described here are examples of systems and components that can be used for data processing tasks that are, for example, associated with a bed. In some cases, multiple examples of a particular component or group of components are presented. Some of these examples are redundant and/or mutually exclusive alternatives. Connections between components are shown as examples to illustrate possible network configurations for allowing communication between components. Different formats of connections can be used as technically needed or desired. The connections generally indicate a logical connection that can be created with any technologically feasible format. For example, a network on a motherboard can be created with a printed circuit board, wireless data connections, and/or other types of network connections. Some logical connections are not shown for clarity. For example, connections with power supplies and/or computer readable memory may not be shown for clarities sake, as many or all elements of a particular component may need to be connected to the power supplies and/or computer readable memory.

FIG. 4A is a block diagram of an example of a data processing system 400 that can be associated with a bed system, including those described above with respect to FIGS. 1-3. This system 400 includes a pump motherboard 402 and a pump daughterboard 404. The system 400 includes a sensor array 406 that can include one or more sensors configured to sense physical phenomenon of the environment and/or bed, and to report such sensing back to the pump motherboard 402 for, for example, analysis. The system 400 also includes a controller array 408 that can include one or more controllers configured to control logic-controlled devices of the bed and/or environment. The pump motherboard 400 can be in communication with one or more computing devices 414 and one or more cloud services 410 over local networks, the Internet 412, or otherwise as is technically appropriate. Each of these components will be described in more detail, some with multiple example configurations, below.

In this example, a pump motherboard 402 and a pump daughterboard 404 are communicably coupled. They can be conceptually described as a center or hub of the system 400, with the other components conceptually described as spokes of the system 400. In some configurations, this can mean that each of the spoke components communicates primarily or exclusively with the pump motherboard 402. For example, a sensor of the sensor array may not be configured to, or may not be able to, communicate directly with a corresponding controller. Instead, each spoke component can communicate with the motherboard 402. The sensor of the sensor array 406 can report a sensor reading to the motherboard 402, and the motherboard 402 can determine that, in response, a controller of the controller array 408 should adjust some parameters of a logic-controlled device or otherwise modify a state of one or more peripheral devices. In one case, if the temperature of the bed is determined to be too hot, the pump motherboard 402 can determine that a temperature controller should cool the bed.

One advantage of a hub-and-spoke network configuration, sometimes also referred to as a star-shaped network, is a reduction in network traffic compared to, for example, a mesh network with dynamic routing. If a particular sensor generates a large, continuous stream of traffic, that traffic may only be transmitted over one spoke of the network to the motherboard 402. The motherboard 402 can, for example, marshal that data and condense it to a smaller data format for retransmission for storage in a cloud service 410. Additionally, or alternatively, the motherboard 402 can generate a single, small, command message to be sent down a different spoke of the network in response to the large stream. For example, if the large stream of data is a pressure reading that is transmitted from the sensor array 406 a few times a second, the motherboard 402 can respond with a single command message to the controller array to increase the pressure in an air chamber. In this case, the single command message can be orders of magnitude smaller than the stream of pressure readings.

As another advantage, a hub-and-spoke network configuration can allow for an extensible network that can accommodate components being added, removed, failing, etc. This can allow, for example, more, fewer, or different sensors in the sensor array 406, controllers in the controller array 408, computing devices 414, and/or cloud services 410. For example, if a particular sensor fails or is deprecated by a newer version of the sensor, the system 400 can be configured such that only the motherboard 402 needs to be updated about the replacement sensor. This can allow, for example, product differentiation where the same motherboard 402 can support an entry level product with fewer sensors and controllers, a higher value product with more sensors and controllers, and customer personalization where a customer can add their own selected components to the system 400.

Additionally, a line of air bed products can use the system 400 with different components. In an application in which every air bed in the product line includes both a central logic unit and a pump, the motherboard 402 (and optionally the daughterboard 404) can be designed to fit within a single, universal housing. Then, for each upgrade of the product in the product line, additional sensors, controllers, cloud services, etc., can be added. Design, manufacturing, and testing time can be reduced by designing all products in a product line from this base, compared to a product line in which each product has a bespoke logic control system.

Each of the components discussed above can be realized in a wide variety of technologies and configurations. Below, some examples of each component will be further discussed. In some alternatives, two or more of the components of the system 400 can be realized in a single alternative component; some components can be realized in multiple, separate components; and/or some functionality can be provided by different components.

FIG. 4B is a block diagram showing some communication paths of the data processing system 400. As previously described, the motherboard 402 and the pump daughterboard 404 may act as a hub for peripheral devices and cloud services of the system 400. In cases in which the pump daughterboard 404 communicates with cloud services or other components, communications from the pump daughterboard 404 may be routed through the pump motherboard 402. This may allow, for example, the bed to have only a single connection with the internet 412. The computing device 414 may also have a connection to the internet 412, possibly through the same gateway used by the bed and/or possibly through a different gateway (e.g., a cell service provider).

Previously, a number of cloud services 410 were described. As shown in FIG. 4B, some cloud services, such as cloud services 410d and 410e, may be configured such that the pump motherboard 402 can communicate with the cloud service directly—that is the motherboard 402 may communicate with a cloud service 410 without having to use another cloud service 410 as an intermediary. Additionally, or alternatively, some cloud services 410, for example cloud service 410f, may only be reachable by the pump motherboard 402 through an intermediary cloud service, for example cloud service 410c. While not shown here, some cloud services 410 may be reachable either directly or indirectly by the pump motherboard 402.

Additionally, some or all of the cloud services 410 may be configured to communicate with other cloud services. This communication may include the transfer of data and/or remote function calls according to any technologically appropriate format. For example, one cloud service 410 may request a copy for another cloud service's 410 data, for example, for purposes of backup, coordination, migration, or for performance of calculations or data mining. In another example, many cloud services 410 may contain data that is indexed according to specific users tracked by the user account cloud 410c and/or the bed data cloud 410a. These cloud services 410 may communicate with the user account cloud 410c and/or the bed data cloud 410a when accessing data specific to a particular user or bed.

FIG. 5 is a block diagram of an example of a motherboard 402 that can be used in a data processing system that can be associated with a bed system, including those described above with respect to FIGS. 1-3. In this example, compared to other examples described below, this motherboard 402 consists of relatively fewer parts and can be limited to provide a relatively limited feature set.

The motherboard includes a power supply 500, a processor 502, and computer memory 512. In general, the power supply includes hardware used to receive electrical power from an outside source and supply it to components of the motherboard 402. The power supply can include, for example, a battery pack and/or wall outlet adapter, an AC to DC converter, a DC to AC converter, a power conditioner, a capacitor bank, and/or one or more interfaces for providing power in the current type, voltage, etc., needed by other components of the motherboard 402.

The processor 502 is generally a device for receiving input, performing logical determinations, and providing output. The processor 502 can be a central processing unit, a microprocessor, general purpose logic circuity, application-specific integrated circuity, a combination of these, and/or other hardware for performing the functionality needed.

The memory 512 is generally one or more devices for storing data. The memory 512 can include long term stable data storage (e.g., on a hard disk), short term unstable (e.g., on Random Access Memory) or any other technologically appropriate configuration.

The motherboard 402 includes a pump controller 504 and a pump motor 506. The pump controller 504 can receive commands from the processor 502 and, in response, control the function of the pump motor 506. For example, the pump controller 504 can receive, from the processor 502, a command to increase the pressure of an air chamber by 0.3 pounds per square inch (PSI). The pump controller 504, in response, engages a valve so that the pump motor 506 is configured to pump air into the selected air chamber, and can engage the pump motor 506 for a length of time that corresponds to 0.3 PSI or until a sensor indicates that pressure has been increased by 0.3 PSI. In an alternative configuration, the message can specify that the chamber should be inflated to a target PSI, and the pump controller 504 can engage the pump motor 506 until the target PSI is reached.

A valve solenoid 508 can control which air chamber a pump is connected to. In some cases, the solenoid 508 can be controlled by the processor 502 directly. In some cases, the solenoid 508 can be controlled by the pump controller 504.

A remote interface 510 of the motherboard 402 can allow the motherboard 402 to communicate with other components of a data processing system. For example, the motherboard 402 can be able to communicate with one or more daughterboards, with peripheral sensors, and/or with peripheral controllers through the remote interface 510. The remote interface 510 can provide any technologically appropriate communication interface, including but not limited to multiple communication interfaces such as WiFi, Bluetooth, and copper wired networks.

FIG. 6 is a block diagram of an example of a motherboard 402 that can be used in a data processing system that can be associated with a bed system, including those described above with respect to FIGS. 1-3. Compared to the motherboard 402 described with reference to FIG. 5, the motherboard in FIG. 6 can contain more components and provide more functionality in some applications.

In addition to the power supply 500, processor 502, pump controller 504, pump motor 506, and valve solenoid 508, this motherboard 402 is shown with a valve controller 600, a pressure sensor 602, a universal serial bus (USB) stack 604, a WiFi radio 606, a Bluetooth Low Energy (BLE) radio 608, a ZigBee radio 610, a Bluetooth radio 612 and a computer memory 512.

Similar to the way that the pump controller 504 converts commands from the processor 502 into control signals for the pump motor 506, the valve controller 600 can convert commands from the processor 502 into control signals for the valve solenoid 508. In one example, the processor 502 can issue a command to the valve controller 600 to connect the pump to a particular air chamber out of the group of air chambers in an air bed. The valve controller 600 can control the position of the valve solenoid 508 so that the pump is connected to the indicated air chamber.

The pressure sensor 602 can read pressure readings from one or more air chambers of the air bed. The pressure sensor 602 can also preform digital sensor conditioning.

The motherboard 402 can include a suite of network interfaces, including but not limited to those shown here. These network interfaces can allow the motherboard to communicate over a wired or wireless network with any number of devices, including but not limited to peripheral sensors, peripheral controllers, computing devices, and devices and services connected to the Internet 412.

FIG. 7 is a block diagram of an example of a daughterboard 404 that can be used in a data processing system that can be associated with a bed system, including those described above with respect to FIGS. 1-3. In some configurations, one or more daughterboards 404 can be connected to the motherboard 402. Some daughterboards 404 can be designed to offload particular and/or compartmentalized tasks from the motherboard 402. This can be advantageous, for example, if the particular tasks are computationally intensive, proprietary, or subject to future revisions. For example, the daughterboard 404 can be used to calculate a particular sleep data metric. This metric can be computationally intensive and calculating the sleep metric on the daughterboard 404 can free up the resources of the motherboard 402 while the metric is being calculated. Additionally, and/or alternatively, the sleep metric can be subject to future revisions. To update the system 400 with the new sleep metric, it is possible that only the daughterboard 404 that calculates that metric need be replaced. In this case, the same motherboard 402 and other components can be used, saving the need to perform unit testing of additional components instead of just the daughterboard 404.

The daughterboard 404 is shown with a power supply 700, a processor 702, computer readable memory 704, a pressure sensor 706, and a WiFi radio 708. The processor can use the pressure sensor 706 to gather information about the pressure of the air chamber or chambers of an air bed. From this data, the processor 702 can perform an algorithm to calculate a sleep metric. In some examples, the sleep metric can be calculated from only the pressure of air chambers. In other examples, the sleep metric can be calculated from one or more other sensors. In an example in which different data is needed, the processor 702 can receive that data from an appropriate sensor or sensors. These sensors can be internal to the daughterboard 404, accessible via the WiFi radio 708, or otherwise in communication with the processor 702. Once the sleep metric is calculated, the processor 702 can report that sleep metric to, for example, the motherboard 402.

FIG. 8 is a block diagram of an example of a motherboard 800 with no daughterboard that can be used in a data processing system that can be associated with a bed system, including those described above with respect to FIGS. 1-3. In this example, the motherboard 800 can perform most, all, or more of the features described with reference to the motherboard 402 in FIG. 6 and the daughterboard 404 in FIG. 7.

FIG. 9 is a block diagram of an example of a sensory array 406 that can be used in a data processing system that can be associated with a bed system, including those described above with respect to FIGS. 1-3. In general, the sensor array 406 is a conceptual grouping of some or all the peripheral sensors that communicate with the motherboard 402 but are not native to the motherboard 402.

The peripheral sensors of the sensor array 406 can communicate with the motherboard 402 through one or more of the network interfaces of the motherboard, including but not limited to the USB stack 604, a WiFi radio 606, a Bluetooth Low Energy (BLE) radio 608, a ZigBee radio 610, and a Bluetooth radio 612, as is appropriate for the configuration of the particular sensor. For example, a sensor that outputs a reading over a USB cable can communicate through the USB stack 604.

Some of the peripheral sensors 900 of the sensor array 406 can be bed mounted 900. These sensors can be, for example, embedded into the structure of a bed and sold with the bed, or later affixed to the structure of the bed. Other peripheral sensors 902 and 904 can be in communication with the motherboard 402, but optionally not mounted to the bed. In some cases, some or all of the bed mounted sensors 900 and/or peripheral sensors 902 and 904 can share networking hardware, including a conduit that contains wires from each sensor, a multi-wire cable or plug that, when affixed to the motherboard 402, connect all of the associated sensors with the motherboard 402. In some embodiments, one, some, or all of sensors 902, 904, 906, 908, and 910 can sense one or more features of a mattress, such as pressure, temperature, light, sound, and/or one or more other features of the mattress. In some embodiments, one, some, or all of sensors 902, 904, 906, 908, and 910 can sense one or more features external to the mattress, such as one or more biometric signals of a person on the mattress.

In some embodiments, pressure sensor 902 can sense pressure of the mattress while some or all of sensors 902, 904, 906, 908, and 910 can sense one or more features of the mattress and/or external to the mattress. Light sensor 908 can sense an intensity of light in an area of the mattress. Sound sensor 910 can sense one or more acoustic signals in the area of the mattress.

FIG. 10 is a block diagram of an example of a controller array 408 that can be used in a data processing system that can be associated with a bed system, including those described above with respect to FIGS. 1-3. In general, the controller array 408 is a conceptual grouping of some or all peripheral controllers that communicate with the motherboard 402 but are not native to the motherboard 402.

The peripheral controllers of the controller array 408 can communicate with the motherboard 402 through one or more of the network interfaces of the motherboard, including but not limited to the USB stack 604, a WiFi radio 606, a Bluetooth Low Energy (BLE) radio 608, a ZigBee radio 610, and a Bluetooth radio 612, as is appropriate for the configuration of the particular sensor. For example, a controller that receives a command over a USB cable can communicate through the USB stack 604.

Some of the controllers of the controller array 408 can be bed mounted 1000. These controllers can be, for example, embedded into the structure of a bed and sold with the bed, or later affixed to the structure of the bed. Other peripheral controllers 1002 and 1004 can be in communication with the motherboard 402, but optionally not mounted to the bed. In some cases, some or all of the bed mounted controllers 1000 and/or peripheral controllers 1002 and 1004 can share networking hardware, including a conduit that contains wires for each controller, a multi-wire cable or plug that, when affixed to the motherboard 402, connects all of the associated controllers with the motherboard 402.

FIG. 11 is a block diagram of an example of a computing device 412 that can be used in a data processing system that can be associated with a bed system, including those described above with respect to FIGS. 1-3. The computing device 412 can include, for example, computing devices used by a user of a bed. Example computing devices 412 include, but are not limited to, mobile computing devices (e.g., mobile phones, tablet computers, laptops) and desktop computers.

The computing device 412 includes a power supply 1100, a processor 1102, and computer readable memory 1104. User input and output can be transmitted by, for example, speakers 1106, a touchscreen 1108, or other not shown components such as a pointing device or keyboard. The computing device 412 can run one or more applications 1110. These applications can include, for example, application to allow the user to interact with the system 400. These applications can allow a user to view information about the bed (e.g., sensor readings, sleep metrics), or configure the behavior of the system 400 (e.g., set a desired firmness to the bed, set desired behavior for peripheral devices). In some cases, the computing device 412 can be used in addition to, or to replace, the remote control 122 described previously.

FIG. 12 is a block diagram of an example bed data cloud service 410a that can be used in a data processing system that can be associated with a bed system, including those described above with respect to FIGS. 1-3. In this example, the bed data cloud service 410a is configured to collect sensor data and sleep data from a particular bed, and to match the sensor and sleep data with one or more users that use the bed when the sensor and sleep data was generated.

The bed data cloud service 410a is shown with a network interface 1200, a communication manager 1202, server hardware 1204, and server system software 1206. In addition, the bed data cloud service 410a is shown with a user identification module 1208, a device management 1210 module, a sensor data module 1210, and an advanced sleep data module 1214.

The network interface 1200 generally includes hardware and low-level software used to allow one or more hardware devices to communicate over networks. For example, the network interface 1200 can include network cards, routers, modems, and other hardware needed to allow the components of the bed data cloud service 410a to communicate with each other and other destinations over, for example, the Internet 412. The communication manger 1202 generally comprises hardware and software that operate above the network interface 1200. This includes software to initiate, maintain, and tear down network communications used by the bed data cloud service 410a. This includes, for example, TCP/IP, SSL or TLS, Torrent, and other communication sessions over local or wide area networks. The communication manger 1202 can also provide load balancing and other services to other elements of the bed data cloud service 410a.

The server hardware 1204 generally includes the physical processing devices used to instantiate and maintain bed data cloud service 410a. This hardware includes, but is not limited to processors (e.g., central processing units, ASICs, graphical processers), and computer readable memory (e.g., random access memory, stable hard disks, tape backup). One or more servers can be configured into clusters, multi-computer, or datacenters that can be geographically separate or connected.

The server system software 1206 generally includes software that runs on the server hardware 1204 to provide operating environments to applications and services. The server system software 1206 can include operating systems running on real servers, virtual machines instantiated on real servers to create many virtual servers, server level operations such as data migration, redundancy, and backup.

The user identification 1208 can include, or reference, data related to users of beds with associated data processing systems. For example, the users can include customers, owners, or other users registered with the bed data cloud service 410a or another service. Each user can have, for example, a unique identifier, user credentials, contact information, billing information, demographic information, or any other technologically appropriate information.

The device manager 1210 can include, or reference, data related to beds or other products associated with data processing systems. For example, the beds can include products sold or registered with a system associated with the bed data cloud service 410a. Each bed can have, for example, a unique identifier, model and/or serial number, sales information, geographic information, delivery information, a listing of associated sensors and control peripherals, etc. Additionally, an index or indexes stored by the bed data cloud service 410a can identify users that are associated with beds. For example, this index can record sales of a bed to a user, users that sleep in a bed, etc.

The sensor data 1212 can record raw or condensed sensor data recorded by beds with associated data processing systems. For example, a bed's data processing system can have a temperature sensor, pressure sensor, and light sensor. Readings from these sensors, either in raw form or in a format generated from the raw data (e.g., sleep metrics) of the sensors, can be communicated by the bed's data processing system to the bed data cloud service 410a for storage in the sensor data 1212. Additionally, an index or indexes stored by the bed data cloud service 410a can identify users and/or beds that are associated with the sensor data 1212.

The bed data cloud service 410a can use any of its available data to generate advanced sleep data 1214. In general, the advanced sleep data 1214 includes sleep metrics and other data generated from sensor readings. Some of these calculations can be performed in the bed data cloud service 410a instead of locally on the bed's data processing system, for example, because the calculations are computationally complex or require a large amount of memory space or processor power that is not available on the bed's data processing system. This can help allow a bed system to operate with a relatively simple controller and still be part of a system that performs relatively complex tasks and computations.

FIG. 13 is a block diagram of an example sleep data cloud service 410b that can be used in a data processing system that can be associated with a bed system, including those described above with respect to FIGS. 1-3. In this example, the sleep data cloud service 410b is configured to record data related to users' sleep experience.

The sleep data cloud service 410b is shown with a network interface 1300, a communication manager 1302, server hardware 1304, and server system software 1306. In addition, the sleep data cloud service 410b is shown with a user identification module 1308, a pressure sensor manager 1310, a pressure-based sleep data module 1312, a raw pressure sensor data module 1314, and a non-pressure sleep data module 1316.

The pressure sensor manager 1310 can include, or reference, data related to the configuration and operation of pressure sensors in beds. For example, this data can include an identifier of the types of sensors in a particular bed, their settings and calibration data, etc.

The pressure-based sleep data 1312 can use raw pressure sensor data 1314 to calculate sleep metrics specifically tied to pressure sensor data. For example, user presence, movements, weight change, heart rate, and breathing rate can all be determined from raw pressure sensor data 1314. For example, raw pressure sensor data 1314 can indicate a BCG signal of a user laying on a mattress of a bed system. This BCG signal can indicate heart rate and other parameters. Additionally, an index or indexes stored by the sleep data cloud service 410b can identify users that are associated with pressure sensors, raw pressure sensor data, and/or pressure-based sleep data.

The non-pressure sleep data 1316 can use other sources of data to calculate sleep metrics. For example, user entered preferences, light sensor readings, and sound sensor readings can all be used to track sleep data. Additionally, an index or indexes stored by the sleep data cloud service 410b can identify users that are associated with other sensors and/or non-pressure sleep data 1316.

FIG. 14 is a block diagram of an example user account cloud service 410c that can be used in a data processing system that can be associated with a bed system, including those described above with respect to FIGS. 1-3. In this example, the user account cloud service 410c is configured to record a list of users and to identify other data related to those users.

The user account cloud service 410c is shown with a network interface 1400, a communication manager 1402, server hardware 1404, and server system software 1406. In addition, the user account cloud service 410c is shown with a user identification module 1408, a purchase history module 1410, an engagement module 1412, and an application usage history module 1414.

The user identification module 1408 can include, or reference, data related to users of beds with associated data processing systems. For example, the users can include customers, owners, or other users registered with the user account cloud service 410a or another service. Each user can have, for example, a unique identifier, and user credentials, demographic information, or any other technologically appropriate information.

The purchase history module 1410 can include, or reference, data related to purchases by users. For example, the purchase data can include a sale's contact information, billing information, and salesperson information. Additionally, an index or indexes stored by the user account cloud service 410c can identify users that are associated with a purchase.

The engagement 1412 can track user interactions with the manufacturer, vendor, and/or manager of the bed and or cloud services. This engagement data can include communications (e.g., emails, service calls), data from sales (e.g., sales receipts, configuration logs), and social network interactions.

The usage history module 1414 can contain data about user interactions with one or more applications and/or remote controls of a bed. For example, a monitoring and configuration application can be distributed to run on, for example, computing devices 412. This application can log and report user interactions for storage in the application usage history module 1414. Additionally, an index or indexes stored by the user account cloud service 410c can identify users that are associated with each log entry.

FIG. 15 is a block diagram of an example point of sale cloud service 1500 that can be used in a data processing system that can be associated with a bed system, including those described above with respect to FIGS. 1-3. In this example, the point-of-sale cloud service 1500 is configured to record data related to users' purchases.

The point-of-sale cloud service 1500 is shown with a network interface 1502, a communication manager 1504, server hardware 1506, and server system software 1508. In addition, the point-of-sale cloud service 1500 is shown with a user identification module 1510, a purchase history module 1512, and a setup module 1514.

The purchase history module 1512 can include, or reference, data related to purchases made by users identified in the user identification module 1510. The purchase information can include, for example, data of a sale, price, and location of sale, delivery address, and configuration options selected by the users at the time of sale.

These configuration options can include selections made by the user about how they wish their newly purchased beds to be setup and can include, for example, expected sleep schedule, a listing of peripheral sensors and controllers that they have or will install, etc.

The bed setup module 1514 can include, or reference, data related to installations of beds that users' purchase. The bed setup data can include, for example, the date and address to which a bed is delivered, the person that accepts delivery, the configuration that is applied to the bed upon delivery, the name or names of the person or people who will sleep on the bed, which side of the bed each person will use, etc.

Data recorded in the point-of-sale cloud service 1500 can be referenced by a user's bed system at later dates to control functionality of the bed system and/or to send control signals to peripheral components according to data recorded in the point of sale cloud service 1500. This can allow a salesperson to collect information from the user at the point of sale that later facilitates automation of the bed system. In some examples, some or all aspects of the bed system can be automated with little or no user-entered data required after the point of sale. In other examples, data recorded in the point-of-sale cloud service 1500 can be used in connection with a variety of additional data gathered from user-entered data.

FIG. 16 is a block diagram of an example environment cloud service 1600 that can be used in a data processing system that can be associated with a bed system, including those described above with respect to FIGS. 1-3. In this example, the environment cloud service 1600 is configured to record data related to users' home environment.

The environment cloud service 1600 is shown with a network interface 1602, a communication manager 1604, server hardware 1606, and server system software 1608. In addition, the environment cloud service 1600 is shown with a user identification module 1610, an environmental sensor module 1612, and an environmental factors module 1614.

The environmental sensors module 1612 can include a listing of sensors that users in the user identification module 1610 have installed in their bed. These sensors include any sensors that can detect environmental variables-light sensors, noise sensors, vibration sensors, thermostats, etc. Additionally, the environmental sensors module 1612 can store historical readings or reports from those sensors.

The environmental factors module 1614 can include reports generated based on data in the environmental sensors module 1612. For example, for a user with a light sensor with data in the environment sensors module 1612, the environmental factors module 1614 can hold a report indicating the frequency and duration of instances of increased lighting when the user is asleep.

In the examples discussed here, each cloud service 410 is shown with some of the same components. In various configurations, these same components can be partially or wholly shared between services, or they can be separate. In some configurations, each service can have separate copies of some or all of the components that are the same or different in some ways. Additionally, these components are only supplied as illustrative examples. In other examples each cloud service can have different number, types, and styles of components that are technically possible.

FIG. 17 is a block diagram of an example of using a data processing system that can be associated with a bed (such as a bed of the bed systems described herein) to automate peripherals around the bed. Shown here is a behavior analysis module 1700 that runs on the pump motherboard 402. For example, the behavior analysis module 1700 can be one or more software components stored on the computer memory 512 and executed by the processor 502. In general, the behavior analysis module 1700 can collect data from a wide variety of sources (e.g., sensors, non-sensor local sources, cloud data services) and use a behavioral algorithm 1702 to generate one or more actions to be taken (e.g., commands to send to peripheral controllers, data to send to cloud services). This can be useful, for example, in tracking user behavior and automating devices in communication with the user's bed.

The behavior analysis module 1700 can collect data from any technologically appropriate source, for example, to gather data about features of a bed, the bed's environment, and/or the bed's users. Some such sources include any of the sensors of the sensor array 406. For example, this data can provide the behavior analysis module 1700 with information about the current state of the environment around the bed. For example, the behavior analysis module 1700 can access readings from the pressure sensor 902 to determine the pressure of an air chamber in the bed. From this reading, and potentially other data, user presence in the bed can be determined. In another example, the behavior analysis module can access a light sensor 908 to detect the amount of light in the bed's environment.

In some embodiments, pressure sensor 902 is configured to generate one or more biometric signals corresponding to a user laying in the bed. One example biometric signal that pressure sensor 902 can generate is a BCG signal. BCG signals indicate physical movements of the human body that are caused by cardiac activity (e.g., movements of the heart and blood flow). This means that BCG signals can indicate cardiac cycles, heart beats, and parameters associated with cardiac activity (e.g., heart rate and heart rate variability. In some cases, user movements caused by cardiac activity affect the pressure within the air chamber in the bed. This means that these movements are readable by pressure sensor 902 and pressure sensor 902 can generate a BCG signal corresponding to a user laying in the bed.

Similarly, the behavior analysis module 1700 can access data from cloud services. For example, the behavior analysis module 1700 can access the bed cloud service 410a to access historical sensor data 1212 and/or advanced sleep data 1214. Other cloud services 410, including those not previously described can be accessed by the behavior analysis module 1700. For example, the behavior analysis module 1700 can access a weather reporting service, a 3^{rd} party data provider (e.g., traffic and news data, emergency broadcast data, user travel data), and/or a clock and calendar service.

Similarly, the behavior analysis module 1700 can access data from non-sensor sources 1704. For example, the behavior analysis module 1700 can access a local clock and calendar service (e.g., a component of the motherboard 402 or of the processor 502).

The behavior analysis module 1700 can aggregate and prepare this data for use by one or more behavioral algorithms 1702. The behavioral algorithms 1702 can be used to learn a user's behavior and/or to perform some action based on the state of the accessed data and/or the predicted user behavior. For example, the behavior algorithm 1702 can use available data (e.g., pressure sensor, non-sensor data, clock and calendar data) to create a model of when a user goes to bed every night. Later, the same or a different behavioral algorithm 1702 can be used to determine if an increase in air chamber pressure is likely to indicate a user going to bed and, if so, send some data to a third-party cloud service 410 and/or engage a peripheral controller 1002.

In the example shown, the behavioral analysis module 1700 and the behavioral algorithm 1702 are shown as components of the motherboard 402. However, other configurations are possible. For example, the same or a similar behavioral analysis module and/or behavior algorithm can be run in one or more cloud services, and the resulting output can be sent to the motherboard 402, a controller in the controller array 408, or to any other technologically appropriate recipient.

FIG. 18 shows an example of a computing device 1800 and an example of a mobile computing device that can be used to implement the techniques described here. The computing device 1800 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1800 includes a processor 1802, a memory 1804, a storage device 1806, a high-speed interface 1808 connecting to the memory 1804 and multiple high-speed expansion ports 1810, and a low-speed interface 1812 connecting to a low-speed expansion port 1814 and the storage device 1806. Each of the processor 1802, the memory 1804, the storage device 1806, the high-speed interface 1808, the high-speed expansion ports 1810, and the low-speed interface 1812, are interconnected using various busses, and can be mounted on a common motherboard or in other manners as appropriate. The processor 1802 can process instructions for execution within the computing device 1800, including instructions stored in the memory 1804 or on the storage device 1806 to display graphical information for a GUI on an external input/output device, such as a display 1816 coupled to the high-speed interface 1808. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 1804 stores information within the computing device 1800. In some implementations, the memory 1804 is a volatile memory unit or units. In some implementations, the memory 1804 is a non-volatile memory unit or units. The memory 1804 can also be another form of computer-readable medium, such as a magnetic or optical disk.

The storage device 1806 is capable of providing mass storage for the computing device 1800. In some implementations, the storage device 1806 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer-or machine-readable medium, such as the memory 1804, the storage device 1806, or memory on the processor 1802.

The high-speed interface 1808 manages bandwidth-intensive operations for the computing device 1800, while the low-speed interface 1812 manages lower bandwidth-intensive operations. Such allocation of functions is exemplary only. In some implementations, the high-speed interface 1808 is coupled to the memory 1804, the display 1816 (e.g., through a graphics processor or accelerator), and to the high-speed expansion ports 1810, which can accept various expansion cards (not shown). In the implementation, the low-speed interface 1812 is coupled to the storage device 1806 and the low-speed expansion port 1814. The low-speed expansion port 1814, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 1800 can be implemented in a number of different forms, as shown in the figure. For example, it can be implemented as a standard server 1820, or multiple times in a group of such servers. In addition, it can be implemented in a personal computer such as a laptop computer 1822. It can also be implemented as part of a rack server system 1824. Alternatively, components from the computing device 1800 can be combined with other components in a mobile device (not shown), such as a mobile computing device 1850. Each of such devices can contain one or more of the computing device 1800 and the mobile computing device 1850, and an entire system can be made up of multiple computing devices communicating with each other.

The mobile computing device 1850 includes a processor 1852, a memory 1864, an input/output device such as a display 1854, a communication interface 1866, and a transceiver 1868, among other components. The mobile computing device 1850 can also be provided with a storage device, such as a micro-drive or other device, to provide additional storage. Each of the processor 1852, the memory 1864, the display 1854, the communication interface 1866, and the transceiver 1868, are interconnected using various buses, and several of the components can be mounted on a common motherboard or in other manners as appropriate.

The processor 1852 can execute instructions within the mobile computing device 1850, including instructions stored in the memory 1864. The processor 1852 can be implemented as a chipset of chips that include separate and multiple analog and digital processors. The processor 1852 can provide, for example, for coordination of the other components of the mobile computing device 1850, such as control of user interfaces, applications run by the mobile computing device 1850, and wireless communication by the mobile computing device 1850.

The processor 1852 can communicate with a user through a control interface 1858 and a display interface 1856 coupled to the display 1854. The display 1854 can be, for example, a TFT (Thin-Film-Transistor Liquid Crystal Display) display or an OLED (Organic Light Emitting Diode) display, or other appropriate display technology. The display interface 1856 can comprise appropriate circuitry for driving the display 1854 to present graphical and other information to a user. The control interface 1858 can receive commands from a user and convert them for submission to the processor 1852. In addition, an external interface 1862 can provide communication with the processor 1852, so as to enable near area communication of the mobile computing device 1850 with other devices. The external interface 1862 can provide, for example, for wired communication in some implementations, or for wireless communication in other implementations, and multiple interfaces can also be used.

The memory 1864 stores information within the mobile computing device 1850. The memory 1864 can be implemented as one or more of a computer-readable medium or media, a volatile memory unit or units, or a non-volatile memory unit or units. An expansion memory 1874 can also be provided and connected to the mobile computing device 1850 through an expansion interface 1872, which can include, for example, a SIMM (Single In Line Memory Module) card interface. The expansion memory 1874 can provide extra storage space for the mobile computing device 1850, or can also store applications or other information for the mobile computing device 1850. Specifically, the expansion memory 1874 can include instructions to carry out or supplement the processes described above, and can include secure information also. Thus, for example, the expansion memory 1874 can be provide as a security module for the mobile computing device 1850, and can be programmed with instructions that permit secure use of the mobile computing device 1850. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1864, the expansion memory 1874, or memory on the processor 1852. In some implementations, the computer program product can be received in a propagated signal, for example, over the transceiver 1868 or the external interface 1862.

The mobile computing device 1850 can communicate wirelessly through the communication interface 1866, which can include digital signal processing circuitry where necessary. The communication interface 1866 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1868 using a radio-frequency. In addition, short-range communication can occur, such as using a Bluetooth, WiFi, or other such transceiver (not shown). In addition, a GPS (Global Positioning System) receiver module 1870 can provide additional navigation-and location-related wireless data to the mobile computing device 1850, which can be used as appropriate by applications running on the mobile computing device 1850.

The mobile computing device 1850 can also communicate audibly using an audio codec 1860, which can receive spoken information from a user and convert it to usable digital information. The audio codec 1860 can likewise generate audible sound for a user, such as through a speaker, e.g., in a handset of the mobile computing device 1850. Such sound can include sound from voice telephone calls, can include recorded sound (e.g., voice messages, music files, etc.) and can also include sound generated by applications operating on the mobile computing device 1850.

The mobile computing device 1850 can be implemented in a number of different forms, as shown in the figure. For example, it can be implemented as a cellular telephone 1880. It can also be implemented as part of a smart-phone 1882, personal digital assistant, or other similar mobile device.

FIG. 19 is a block diagram illustrating a bed system 1900 including an example controller 1902 for using a first biometric signal 1904 to reconstruct a second biometric signal 1906. This can be useful to reconstruct biometric signal samples that are similar to those collected by bed system 1900. With the reconstructed biometric signal samples, controller 1902 can train bed system 1900 to respond to actual samples of the biometric signal collected from user. As seen in FIG. 19, first biometric signal 1904 can include an electrocardiogram (ECG) signal 1912 or a photoplethysmogram (PPG) signal 1914 and second biometric signal 1906 can include a BCG signal 1916. Controller 1902 is configured to accept one of the ECG signal 1912 or the PPG signal 1914 as an input and generate the BCG signal 1916 as an output. In some examples, controller 1902 can be part of data processing system 400 of FIGS. 4A and 4B, but this is not required. Controller 1902 can be separate from data processing system 400. In some examples, first biometric signal 1904 or another first biometric signal may be referred to herein as a “primary biometric signal.” In some examples, second biometric signal 1906 or another second biometric signal may be referred to herein as a “secondary biometric signal.”

A bed system (e.g., air bed system 100 of FIG. 1) can process a biometric signal collected from a user laying on a mattress to determine whether to perform one or more actions. One kind of biometric signal that air bed system 100 can collect from a user is a BCG signal. A BCG signal is a recording of the body's mechanical activity resulting from cardiac activity. Unlike an ECG, which indicates the electrical activity of the heart, a BCG captures the physical body movements caused by heart contractions and resulting blood flow throughout the body. For example, cardiac activity causes subtle vibrations that can be detected and recorded in the form of a BCG signal. Sensors located on a piece of furniture such as a bed or a chair can measure BCG signals based on small physical body movements caused by cardiac activity. Pressure transistor 146 of air bed system 100 is one such sensor.

As described above, pressure transistor 146 is configured monitor a pressure of air chambers 114 of a mattress. Air bed system 100 can use this pressure reading to determine biometric parameters such as a heart rate and/or a respiration rate of a user lying on the mattress. In some cases, pressure transistor 146 can generate a biometric signal such as a BCG signal based on the fluctuations in the pressure of air chambers 114 as measured by pressure transistor 146. Air bed system 100 can process the biometric signal to determine one or more biometric parameters. Based on these biometric parameters, air bed system 100 can determine whether to perform one or more actions to control a sleep environment.

BCG signals can provide information concerning several aspects of cardiac activity including cardiac output, heart rate, heart rate variability, and aspects of vascular function. For example, a BCG signal can be a time series of data points that indicate a strength and efficiency of heart contraction thus indicating cardiac output. The timing and pattern of the BCG signal indicates parameters such as heart rhythm and heart rate. Irregularities or abnormalities in a BCG signal can indicate cardiac conditions such as arrhythmias. This means that a BCG signal can be tool for determining information relating to cardiac activity. BCG signals are particularly useful in situations where direct measurement of heart activity using electrodes is impractical or difficult to perform.

For example, it may be more practical for air bed system 100 to collect a BCG signal as compared with the practicality of collecting other biometric signals such as ECG signals and PPG signals. This is because ECG signals and PPG signals are generally collected using sensors in direct contact with the skin of the subject, whereas pressure transistor 146 can generate a BCG signal indirectly based on the pressure within air chambers 114 without being in contact with the skin of the user laying on the mattress. Even if there were electrodes and optical sensors located on the mattress, these sensors could prove ineffective in collecting ECG signals and PPG signals because the user can move during sleep, thus breaking skin contact with the sensors.

Biometric signals such as BCG signals, ECG signals, and PPG signals can indicate one or more patient conditions (e.g., atrial fibrillation (AF) and other arrhythmias). In embodiments where air bed system 100 processes a biometric signal collected from a user laying on a mattress to make determinations, it may be beneficial for air bed system 100 to account for patient conditions that may affect the biometric signal. When air bed system 100 uses a model, for example, to process a biometric signal collected from a user laying on a mattress, it may be beneficial to encode or train the model to account for patient conditions that may appear in the biometric signal or otherwise affect the biometric signal. Said another way, some subjects exhibit atypical physiological processes, and this technology can advantageously account for the atypicality in order to more accurately measure features of the subject.

In some embodiments, to account for patient conditions that affect a biometric signal collected by air bed system 100 such as a BCG signal of a user laying on a mattress, it may be beneficial to determine an extent to which the presence of the patient conditions affect an ability of the system to derive information from the biometric signal. For example, an accuracy at which the system determines heart rate and breathing rate based on a collected BCG signal can decrease when the user has one or more conditions such as arrythmias, cardiac failure, obstructive pulmonary disorders, or asthma. This decrease in accuracy of determining parameters such as heart rate and breathing rate can lead to an increased rate of air bed system 100 making improper decisions. For example, air bed system 100 may improperly increase or decrease a firmness of the mattress based on an incorrect breathing rate measurement.

To train air bed system 100 to use sensor data collected from a multi-sensor system, air bed system 100 may use samples of data collected from many users. This data is beneficial for understanding a manner in which a presence of patient conditions (e.g., cardiorespiratory conditions) affects data collected from users via pressure sensors, load-cell sensors, and temperature sensors. It may be difficult to run a study where patients lie on mattresses to produce data samples to improve air bed system 100. It may be beneficial to generate reconstructed data samples that resemble data collected from the sensors of air bed system 100. For example, a machine learning model can use publicly available ECG signals and/or PPG signals to generate BCG signals that resemble those collected by air bed system 100 during use. In some embodiments, it may be possible to generate a machine learning model or another kind of algorithm to detect one or more patient conditions based on a signal collected from a bed. This can involve reconstructing biometric signals such as BCG signals from other kinds of biometric signals such as ECG signals and PPG signals so that reconstructed BCG signals provide training samples associated with certain conditions that the model is trained to detect. For example, ECG signals and/or PPG signals can be associated with certain patient conditions and BCG signals reconstructed form these ECG signals and/or PPG signals are also associated with these patient conditions. This means that a model can be trained to detect patient conditions using BCG signals reconstructed from ECG signals and/or PPG signals associated with those conditions.

Air bed system 100 can therefore benefit from having access to BCG signal samples that are collected from subjects that are known to exhibit certain patient conditions. With this information, air bed system 100 can improve a manner in which it makes determinations based on biometric signals collected from users that exhibit these patient conditions. Controller 1902 is configured to reconstruct BCG signal samples from ECG signals and/or PPG signals. This means that when an ECG signal or a PPG signal is known to be collected from a subject having a patient condition, controller 1902 can use this ECG signal or PPG signal to generate a BCG signal exhibiting effects of that patient condition. Air bed system 100 can use these reconstructed BCG signals to improve a way air bed system 100 processes BCG signals collected from users who have certain patient conditions.

An ECG signal indicates electrical activity of the heart over time. ECG signals can be recorded, for example, using electrodes placed on the surface of the skin. One way that electrodes can measure the electrical activity of the heart by detecting the electric potential difference between two points, the heart being located between the two points. The electrical activity of the heart changes throughout the cardiac cycle as the myocardium contracts the heart to pump blood. For example, when a heart chamber contracts, this can cause an increase in electric potential as reflected by an ECG signal. ECG signals include several distinct features that mark significant milestones in the cardiac cycle. These features include P-waves, R-waves, and T-waves.

A P-wave in an ECG signal indicates an atrial depolarization. Electrical activity of the myocardium surrounding the atria increases as the atria contract, pumping blood into the ventricles. This increase in electrical activity appears in an ECG signal as a P-wave. An R-wave in an ECG signal indicates a ventricular depolarization. Electrical activity of the myocardium surrounding the ventricles increases as the ventricles contract, and this increase in electrical activity appears in an ECG signal as an R-wave. Ventricular depolarizations are commonly referred to as “heart beats.” A T-wave reflects ventricular repolarization, where the ventricles reset their electrical state after contraction, preparing for the next heartbeat. Since features of an ECG signal indicate important events in the cardiac cycle, ECG signals can indicate cardiac parameters relating to the cardiac cycle. For example, an ECG signal may indicate heart rate as the rate per minute of R-wave occurrences.

PPG signals, like ECG signals, indicate information relating to the cardiac cycle. PPG signals indicate changes in blood volume as opposed to indicating electrical activity of the heart. A PPG signal generally includes a sequence of waveform oscillations corresponding to rhythmic changes in blood volume associated with each heartbeat. Components of a PPG signal include a pulse wave, a pulsatile component, and a baseline component. The pulse wave represents an oscillatory waveform in the PPG signal indicating the cyclic expansion and contraction of arteries as blood is ejected from and returns to the heart. The pulsatile component of the PPG signal indicates changes in blood volume due to cardiac activity, and the baseline component of the PPG signal indicates overall blood volume in the tissue.

Sensors can measure PPG signals from various peripheral sites on the body, such as the fingertip, earlobe, or wrist. Systems can use optical sensors to collect PPG signals. For example, an optical sensor can emit light into the tissue of a patient and detect an amount of light that is absorbed by the tissue or reflected back to the sensor. The sensor can generate a PPG signal based on the emitted and detected light, the PPG signal indicating a volume of blood in the tissue over time.

Controller 1902 is configured to use a first biometric signal 1904 including one of an ECG signal 1912 or a PPG signal 1914 to reconstruct a second biometric signal 1906 including a BCG signal 1916. Controller 1902 includes processing circuitry 1922 and memory 1924. Memory 1924 is configured to store training data 1932, user data 1934, pre-processing model 1940, and machine learning model 1942. Since ECG signals, PPG signals, and BCG signals each indicate aspects of the cardiac cycle, controller 1902 can reconstruct one biometric signal using another biometric signal based on patterns and correlations between the signals. For example, an ECG signal indicates electrical activity associated with a ventricular depolarization, a PPG signal indicates blood flow and volume caused by a ventricular depolarization, and a BCG indicates mechanical movements caused by a ventricular depolarization. This means that based on correlations between events in a first kind of signal with events in a second kind of signal, controller 1902 can regenerate the second kind of signal based on the first kind of signal.

Processing circuitry 1922 may include fixed function circuitry and/or programmable processing circuitry. Processing circuitry 1922 may include any one or more of a microprocessor, a controller, a digital signal processor (DSP), an application specific integrated circuit (ASIC), a field-programmable gate array (FPGA), or equivalent discrete or analog logic circuitry. In some examples, processing circuitry 1922 may include multiple components, such as any combination of one or more microprocessors, one or more controllers, one or more DSPs, one or more ASICs, or one or more FPGAS, as well as other discrete or integrated logic circuitry. The functions attributed to processing circuitry 1922 herein may be embodied as software, firmware, hardware or any combination thereof.

Memory 1924 may be configured to store information within controller 1902 during operation. Memory 1924 may include a computer-readable storage medium or computer-readable storage device. In some examples, memory 1924 includes one or more of a short-term memory or a long-term memory. Memory 1924 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, memory 1924 is used to store data indicative of instructions for execution by processing circuitry 1922.

In some embodiments, controller 1902 pre-processes first biometric signal 1904 using pre-processing model 1940. In some cases, pre-processing model 1940 applies a band-pass filter to first biometric signal. A band-pass filter is a type of electronic circuit or digital signal processing algorithm that allows a certain range of frequencies to pass through the band-bass filter while attenuating frequencies outside of the range of frequencies. A band-pass filter includes cutoff frequencies that define the range of frequencies that pass through the band-pass filter. The range of frequencies that pass through the band-pass filter is sometimes referred to as the “passband,” which extends from a lower-bound cutoff frequency to an upper-bound cutoff frequency. Band-pass filters can isolate specific frequency components in a signal while rejecting unwanted frequencies. For example, it may be beneficial to see R-waves in an ECG signal while attenuating high-frequency noise.

In some examples, the lower-bound frequency of the band-pass filter of pre-processing model 1940 is within a range from 0.0001 Hertz (Hz) to 0.2 Hz. In some examples, the upper-bound frequency of the band-pass filter of pre-processing model 1940 is within a range from 30 Hz to 100 Hz. In some examples, the passband of the pass filter of pre-processing model 1940 extends from 0.001 Hz to 50 Hz. In this example, ultra-low frequency noise and high-frequency noise is eliminated from the first biometric signal 1904 while events indicating cardiac activity (e.g., P-waves, R-waves, and T-waves of ECG signal 1912 and/or blood flow oscillations of PPG signal 1914) remain in the first biometric signal 1904.

Pre-processing model 1940, in some embodiments, is configured to resample first biometric signal 1904 at a predetermined frequency. Resampling involves processing an input signal having a raw frequency and creating an output signal having the predetermined frequency. For example, if an input signal has a frequency of 256 Hz, it may be possible to resample the input signal to generate an output signal having a frequency of 100 Hz. Pre-processing model 1940 may, in some examples, resample first biometric signal 1904 to a predetermined frequency of 100 Hz. In some examples, resampling is beneficial when a model accepts input signals of the predetermined frequency. That is, any input signal can be converted into the sampling frequency accepted by the model.

Resampling first biometric signal 1904 to a predetermined frequency such as 100 Hz can involve using pre-processing model 1940 to adjust a sampling rate of first biometric signal 1904 to match the predetermined frequency. For example, pre-processing model 1940 can determine a current sampling rate of first biometric signal 1904 and compare the current sampling rate of first biometric signal 1904 with the predetermined frequency. Pre-processing model 1940 can determine a ratio between the predetermined frequency and the current sampling rate. Based on this ratio, pre-processing model 1940 can use an appropriate resampling technique to adjust the sampling rate of pre-processing model 1940. In some examples, pre-processing model uses interpolation to upsample first biometric signal 1904 when the current sampling rate is lower than the predetermined frequency and uses decimation to downsample first biometric signal 1904 when the current sampling rate is greater than the predetermined frequency.

Controller 1902 can apply machine learning model 1942 to the pre-processed first biometric signal 1904 to generate second biometric signal 1906. In some embodiments, first biometric signal 1904 can include one or both of ECG signal 1912 and PPG signal 1914 and second biometric signal 1906 can include BCG signal 1916. This means that machine learning model 1942 is configured to use a first kind of biometric signal indicating a first parameter reconstruct a second kind of biometric signal indicating a second parameter. This can be beneficial when samples of the second kind of biometric signal serve as inputs to a system (e.g., air bed system 100) and many samples are used to test the system.

In some embodiments, the ECG signal 1912 or the PPG signal 1914 of first biometric signal 1904 represent genuine data collected from a human patient. The second biometric signal 1906 generated by machine learning model 1942 can represent an estimation of what a BCG signal collected from the same human patient over the same window of time that the first biometric signal 1904 was collected from the patient without second biometric signal 1906 actually being collected from the patient. Since ECG signals, PPG signals, and BCG signals all indicate some of the same aspects of cardiac activity in different ways, it may be possible for machine learning model 1942 to learn correlations between ECG signals and BCG signals and correlations between PPG signals and BCG signals. Using these correlations, machine learning model 1942 can generate second biometric signal 1906 based on first biometric signal 1904.

Machine learning model 1942 can, in some embodiments, include a generative neural network. A generative neural network can use a type of machine learning model referred to as a generative adversarial network (GAN). GANs may combine two different kinds of neural networks, generators and discriminators. A generator of machine learning model 1942, for example, can accept first biometric signal 1904 that represents a first kind of biometric data as an input and generate second biometric signal 1906 that represents a second kind of biometric data. The generator of machine learning model 1942 can produce increasingly realistic samples of the second kind of biometric data as it trains. A discriminator of machine learning model 1942 can differentiate between genuine samples of the second kind of biometric data and reconstructed samples of the second kind of biometric data.

Processing circuitry 1922 can train a generator and a discriminator of machine learning model 1942 simultaneously. The generator can attempt to fool the discriminator by generating increasingly realistic samples of the second kind of biometric data, while the discriminator improves at distinguishing genuine samples from reconstructed samples. As training progresses, the generator of machine learning model 1942 improves at generating realistic samples of the second kind of biometric data as it receives feedback (e.g., classifications of genuine vs. regenerated) from the discriminator. The discriminator, in turn, gets better at distinguishing genuine samples from reconstructed samples. This process allows machine learning model 1942 to learn to map the first kind of biometric data to the second kind of biometric data, effectively reconstructing the second kind of biometric data from the first kind of biometric data.

In some embodiments, machine learning model 1942 is trained to map ECG signals to BCG signals. In some embodiments, machine learning model 1942 is trained to map PPG signals to BCG signals. Machine learning model 1942 can use autoregression to map ECG signals and/or PPG signals to BCG signals. Autoregression is a statistical technique that can use past values of a timeseries to predict future values of the timeseries. Autoregression is useful for predicting future values of cyclical data such as ECG signals and PPG signals that indicate aspects of the cardiac cycle and the respiratory cycle, because each cardiac cycle and respiratory cycle has certain characteristics that tend to repeat for each cycle. This means that machine learning model 1942 can analyze past cycles to predict future cycles.

In some embodiments, machine learning model 1942 is trained to map (e.g., using autoregression) an ECG signal to a BCG signal and is trained to map a PPG signal to a BCG signal. In some embodiments, machine learning model 1942 is trained to generate a BCG signal based on input data comprising both of an ECG signal and a PPG signal. Machine learning model 1942 is not limited to using one or both of an ECG signal and a PPG signal to generate a BCG signal. In some embodiments, machine learning model 1942 can use one or more other kinds of signals to generate a BCG signal. In some embodiments, machine learning model 1942 can reconstruct a biometric signal other than a BCG signal using a different kind of biometric data.

Machine learning model 1942 may, in some examples, include a set of layers for processing input data such as the pre-processed first biometric signal 1904. In some embodiments, machine learning model 1942 can include one or more convolutional layers, one or more long short-term memory (LSTM) layers, and one or more dense layers. Convolutional layers are useful for processing input data that has spatial relationships. ECG and PPG signals include such spatial relationships. For example, a P-wave of a cardiac cycle occurs before an R-wave, and the R-wave of the cardiac cycle occurs before the T-wave. Convolutional layers can recognize these spatial features and patterns. For example, convolutional layers of machine learning model 1942 can learn to extract relevant features from first biometric signal 1904. Machine learning model 1942 can use these extracted features to reconstruct second biometric signal 1906.

In some embodiments, LSTM layers of machine learning model 1942 are configured to process sequential data, such as time-series data or sequences of data points with temporal dependencies. For example, the LSTM layers of machine learning model 1942 can use autoregression to predict future values of a reconstructed BCG signal based on past values of an ECG signal and/or a PPG signal. ECG signal 1912, PPG signal 1914, and BCG signal 1916 each represent sequences of data points with temporal dependencies. For example, ECG 1912 indicates R-waves which represent heart beats, PPG signal 1914 indicates blood flow through the course of the cardiac cycle, and BCG signal 1916 indicates periodic characteristics corresponding to the cardiac cycle. This means that each of ECG signal 1912, PPG signal 1914, and BCG signal 1916 can indicate a user's heart rate, which is a time-dependent parameter. The LSTM layers of machine learning model 1942 can use temporal relationships between any combination of ECG signal 1912, PPG signal 1914, and BCG signal 1916 to reconstruct second biometric signal 1906 using first biometric signal 1904.

Machine learning model 1942 can include one or more dense layers, also that combine features learned by earlier layers and map these features to a desired output dimensionality. For example, one or more dense layers of machine learning model 1942 can integrate features extracted by the one or more convolutional layers of machine learning model 1942 and features extracted from the one or more LSTM layers to produce the final reconstructed output of second biometric signal 1906. That is, the one or more dense layers of machine learning model 1942 can transform high-level representations of the first biometric signal 1904 into a format used to reconstruct second biometric signal 1906.

Memory 1924 can store training data 1932. In some embodiments, processing circuitry 1922 is configured to train machine learning model 1942 using training data 1932. Training data 1932 can, in some examples, include a plurality of training datasets. Each training dataset may include one or more training biometric signals collected from the same subject over a window of time. For example, when machine learning model 1942 is trained to use first biometric training signal 1904 to reconstruct second biometric signal 1906, each training dataset can include a first set training biometric signal that represents the same kind of biometric signal as first biometric signal 1904 and a second training biometric signal that represents the same kind of biometric signal as second biometric signal 1906. In some embodiments, processing circuitry 1922 trains machine learning model 1942 using unsupervised learning. Unsupervised learning involves training data that is not labeled. In some embodiments, processing circuitry 1922 trains machine learning model 1942 using supervised learning. Supervised learning involves training data that is labeled. In some embodiments, processing circuitry 1922 trains machine learning model 1942 using semi-supervised learning. Semi-supervised learning involves training data that is labeled and training data that is not labeled.

For example, to train machine learning model 1942 to reconstruct BCG signal 1916 using ECG signal 1912, processing circuitry 1922 can train machine learning model 1942 using a plurality of sets of training data that each include an ECG training biometric signal and a BCG training biometric signal collected from the same subject. In some cases, the ECG training biometric signal and the BCG training biometric signal collected from the same subject are also collected over the same window of time. Additionally, or alternatively, to train machine learning model 1942 to reconstruct BCG signal 1916 using PPG signal 1914, processing circuitry 1922 can train machine learning model 1942 using a plurality of sets of training data that each include a PPG training biometric signal and a BCG training biometric signal collected from the same subject. In some cases, the PPG training biometric signal and the BCG training biometric signal collected from the same subject are also collected over the same window of time.

Signal database 1934 is configured to store a plurality of biometric signal samples that machine learning model 1942 regenerates using other biometric signals. For example, second biometric signal 1906 that machine learning model 1942 regenerates based on first biometric signal 1904 represents one biometric signal sample stored to signal database 1934. In some examples, signal database 1934 is additionally or alternatively configured to store one or more biometric signal samples collected from users (e.g., users laying on a mattress of air bed system 100). In some examples, each biometric signal sample of the plurality of biometric signal samples represents a kind of signal that a pressure sensor of an air bed system can collect from a user laying on a bed. For example, each biometric signal sample of the plurality of biometric signal samples can be a BCG signal collected from a user or a BCG signal that is reconstructed using other biometric signals such as ECG signals and PPG signals.

Processing circuitry 1922 can apply the plurality of biometric signal samples stored by signal database 1934 to train a bed system to perform one or more actions using the kinds of biometric data stored by signal database 1934. For example, behavior analysis module 1700 and behavior algorithm 1702 of FIG. 17 are configured to control pump controller 504, foundation actuators 1006, temperature controller 1008, under-bed lighting 1010, and peripheral controllers 1002, 1004 based on many kinds of data, including data collected by a pressure sensor 902. Since this pressure sensor 902 can collect biometric signals such as BCG signals that indicate aspects of cardiac activity of a user lying on a bed, it may be beneficial to train behavior analysis module 1700 and/or behavior algorithm 1702 to perform actions based on BCG signals collected from users.

Since BCG data is not as commonly available in large amounts as compared with the availability of ECG data and PPG data, it may be beneficial for controller 1902 to regenerate BCG data based on ECG data and PPG data to increase an amount of data available to train bed systems to react to BCG data. This is especially true when it comes to BCG data collected from users that have conditions such as atrial fibrillation or other arrhythmias. These arrhythmias can cause irregularities in BCG data. Unless the bed system is trained to account for these irregularities, the system may misinterpret BCG data collected from users who have these conditions. Using machine learning model 1942 to regenerate BCG data using ECG data and PPG data collected from subjects known to have conditions such as atrial fibrillation can increase an amount of data available for training a bed system to account for these conditions.

FIG. 20 is a block diagram including a system 2000 for using a first biometric signal 2010 to reconstruct a second biometric signal 2020 that includes a pre-processing model 2040, an embedding unit 2041, and a machine learning model 2042. In some embodiments, first biometric signal 2004 is an example of first biometric signal 1904 of FIG. 19. In some embodiments, second biometric signal 2006 is an example of second biometric signal 1906 of FIG. 19. In some embodiments, pre-processing model 2040 is an example of pre-processing model 1940 of FIG. 19. In some embodiments, machine learning model 2042 is an example of machine learning model 1942 of FIG. 19.

First biometric signal 2004 can include a first sequence of data points. Each data point of the first sequence of data points can indicate a data value. In examples where first biometric signal 2004 comprises an ECG signal, each data point of the first sequence of data points indicates an ECG value. In examples where first biometric signal 2004 comprises a PPG signal, each data point of the first sequence of data points indicates a PPG value. The first sequence of data points may occur at a sampling rate (e.g., 50 Hz, 100 Hz, 200 Hz, or any other frequency). Sensor circuitry may generate the first sequence of data points as discrete data based on a biometric signal collected from a subject by one or more sensors over a period of time. For example, electrodes can sense an ECG signal of a subject and sensing circuitry can generate a sequence of data points indicating the ECG at a certain frequency. Additionally, or alternatively, an optical sensor can sense a PPG signal of a subject and sensing circuitry can generate a sequence of data points indicating the PPG at a certain frequency.

Second biometric signal 2004 can include a second sequence of data points. Each data point of the second sequence of data points can indicate a data value. Second biometric signal 2004, in some embodiments, represents an estimation of an expected biometric signal that is reconstructed based on first biometric signal 2004. In some embodiments, second biometric signal 2006 represents an estimation of a BCG signal that is reconstructed based on an ECG signal and/or a PPG signal of first biometric signal 2004.

Pre-processing model 2040 can be configured to process first biometric signal 2004 for input to embedding unit 2041. For example, pre-processing model 2040 can apply a band-pass filter and-or one or more other kinds of filters to remove undesirable frequency bands from first biometric signal 2004. In some embodiments, pre-processing model 2040 uses one or more processing algorithms such as outlier detection algorithms, probabilistic algorithms that identify noise events, and other algorithms for processing first biometric signal 2004 for input to embedding unit 2041. For example, an ECG signal of first biometric signal 2004 may include high-frequency noise that is unrelated to cardiac activity. This high-frequency noise can obstruct valuable portions of the ECG signal, such as P-waves. A PPG signal of first biometric signal 2004 may include noise related to motion, ambient light, or other factors. By applying a band-pass filter to first biometric signal 2004, pre-processing model 2040 can remove frequency bands from first biometric signal 2004 that are undesirable or not helpful for determining one or more parameters based on pre-processing model 2040.

In some embodiments, pre-processing model 2040 can resample first biometric signal 2004 from an initial sampling rate to a desired sampling rate. For example, if the first sequence of data points have an initial sampling rate that is different than a desired sampling rate, pre-processing model 2040 can resample the initial sampling rate to the desired sampling rate. When the initial sampling rate is lower than the desired sampling rate, pre-processing model 2040 can upsample the first biometric signal 2004. When the initial sampling rate is greater than the desired sampling rate, pre-processing model 2040 can downsample the first biometric signal 2004. In some cases, the desired sampling rate is 100 Hz, but this is not required. The desired sampling rate can be any frequency accepted as an input by embedding unit 2041 and/or machine learning model 2042.

The desired sampling rate at which pre-processing model 2040 resamples biometric signal 2004, in some embodiments, is the same sampling rate as the second biometric signal 2006 that is output from machine learning model 2042, but this is not required. In some embodiments, the sampling rate of the second biometric signal 2006 that is output from machine learning model 2042 is different from the sampling rate of the desired sampling rate at which pre-processing model 2040 resamples biometric signal 2004 for input to the embedding unit 2041. For example, machine learning model 2042 can generate second biometric signal 2006 to have a sampling rate that is different from the sampling rate of the input data.

Embedding unit 2014 can generate a sequence of embeddings for input to machine learning model 2042. In some embodiments, embedding unit 2014 can generate an embedding of a sequence of embeddings for each data point of a sequence of data points of the first biometric signal 2004 that is pre-processed by pre-processing model 2040. For example, when pre-processing model 2040 generates a pre-processed biometric signal that has a sampling rate of 100 Hz, this pre-processed biometric signal includes 100 data points for every second. This means that embedding unit 2014 can generate 100 embeddings every second so that there is an embedding for each data point. Embedding unit 2014 is not limited to generating an embedding for each data point of the pre-processed biometric signal generated by pre-processing model 2040. Embedding unit 2014 can generate embeddings at a different rate than the sampling rate of the pre-processed biometric signal.

In some embodiments, to generate an embedding corresponding to a data point of a sequence of data points of the pre-processed biometric signal generated by pre-processing model 2040, embedding unit 2041 can generate the embedding to include one or more data points preceding the data point. Since machine learning model 2042 is configured to reconstruct values of second biometric signal 2006 based on values of first biometric signal 2004, it may be beneficial for machine learning model 2042 to use data from previous points in time to predict future data points. For example, a P-wave in an ECG signal indicates that an R-wave is likely to occur in the near future. The P-wave also indicates that one or more features of a BCG signal collected over the same period of time corresponding to a ventricular depolarization are likely to occur in the near future. When embedding unit 2041 generates an embedding corresponding to a data point that includes data over a window of time preceding the data point, this can allow machine learning model 2042 to generate a reconstructed data point for the second biometric signal 2006 based on events present in the first biometric signal 2004 over the window of time.

Each embedding of the sequence of embeddings that embedding unit 2041 generates may include data corresponding to a period of time. In some examples, this period of time is approximately one second, but this is not required. The period of time can extend for greater than one second or less than one second. In some embodiments where the pre-processed biometric signal generated by pre-processing model 2040 has a sampling rate of 100 Hz, each embedding that embedding unit 2014 can include approximately 100 data points corresponding to approximately one second worth of data. Based on data points within each embedding machine learning model 2042 can generate one or more data points of second biometric signal 2006. In some embodiments, each embedding that embedding unit 2041 corresponds to one data point of second biometric signal 2006.

It can be beneficial for embedding unit 2041 to generate embeddings based on approximately one second worth of data, because a duration of a cardiac cycle of a sleeping subject is often approximately one second. For example, a sleeping subject's heart rate is often between 40 and 70 beats per minute. In this range of heart rates, the cardiac cycle is within a range from 0.86 seconds to 1.50 seconds. When embeddings reflect data over approximately one second intervals, this means that data over at least a large portion of a cardiac cycle is within the embedding. This allows machine learning model 2042 to recognize temporal and spatial relationships throughout the cardiac cycle.

Embedding unit 2041 can use a sliding window to select data points from the pre-processed biometric signal to generate each embedding of a sequence of embeddings. In some embodiments, to generate an embedding corresponding to data point N of the pre-processed biometric signal generated by pre-processing model 2040, embedding unit 2041 can use data points N-102 through data point N of the pre-processed biometric signal to generate the embedding. To generate an embedding corresponding to data point N+1 of the pre-processed biometric signal generated by pre-processing model 2040, embedding unit 2041 can use data points N-101 through data point N+1 of the pre-processed biometric signal to generate the embedding. In these embodiments, the sliding window includes the current data point and the 102 data points immediately preceding the current data point. The sliding window therefore includes 103 consecutive data points in some embodiments.

Embedding unit 2041 is not limited to generating an embedding based on a sliding window that includes 103 consecutive data points ending with the data point corresponding to the embedding. In some cases, embedding unit 2041 uses a sliding window that includes greater than 103 consecutive data points or less than 103 data points. In some embodiments, the sliding window includes data points both preceding the data point N corresponding to the embodiment and data points following data point N (e.g., N-100 through N+2, N-52 through N+50). In some embodiments, the sliding window includes data points preceding the data point N without including data point N (e.g., N-112 through N-10). In some embodiments, the sliding window includes data points following the data point N without including data point N (e.g., N+2 through N+104).

To generate each embedding of the sequence of embeddings, embedding unit 2041 can generate a matrix for input to machine learning model 2042 based on the data points that embedding unit 2041 selects for the embedding. This matrix can include a set of columns and a set of rows. In some examples, embedding unit 2041 can place a data point that embedding unit 2041 selects for an embedding in more than one location in the matrix. In some embodiments, the matrix corresponding to each embedding of the sequence of embeddings comprises four rows and 100 columns (e.g., 4×100) and thus includes 400 cells. Embedding unit 2041 is not limited to generating matrices comprising four rows and 100 columns. In some embodiments, embedding unit 2041 can include more than four rows or less than four rows. In some embodiments, embedding unit 2041 can include more than 100 columns or less than 100 columns.

Embedding unit 2041 can place, in each row of a matrix corresponding to an embedding, at least a portion of the data points selected for the embedding. For example, when embedding unit 2041 selects data points N-102 through data point N to include in an embedding corresponding to data point N, embedding unit 2041 can place data points N-99 through N in a first row of a matrix, embedding unit 2041 can place data points N-100 through N-1 in a second row of the matrix, embedding unit 2041 can place data points N-101 through N-2 in a third row of the matrix, and embedding unit 2041 can place data points N-102 through N-3 in a third row of the matrix. This means that the data points are offset by one in each row of the matrix. Embedding unit 2041 is not limited to generating matrices having rows that are offset by one data point. In some examples, the rows are offset by more than one data point. In embodiments where pre-processing model 2040 resamples first biometric signal 2004 at 100 Hz, one data sample corresponds to 10 milliseconds (ms). This means that in some cases, a second row of the matrix is shifted by 10 ms with respect to the first row, the third row is shifted 10 ms with respect to the second row, and the fourth row is shifted 10 ms with respect to the third row.

By generating embeddings to include matrices having offset rows of data points, embedding unit 2041 can generate matrices that reflect spatial and temporal relationships between data points selected for the embedding. By generating embeddings input to machine learning model 2042 to include matrices with offset rows of data, embedding unit 2041 can assist machine learning model 2042 improve a performance of machine learning model 2042 in reconstructing second biometric signal 2006. This is because first biometric signal 2004 and second biometric signal 2006 represent timeseries data where spatial relationships and temporal relationships are relevant. The embeddings can assist in indicating these spatial and temporal relationships by showing how the input data changes over time.

In some embodiments, embedding unit 2041 can generate embedding matrices based on two different kinds of input data. For example, embedding unit 2041 can generate an embedding matrix based on a set of ECG data and a set of PPG data. For example, first biometric signal 2004 can include two biometric signals, an EEG signal and a PPG signal. The pre-processing model 2040 can process both of the EEG signal and the PPG signal for input to embedding unit 2041. Embedding unit 2041 can generate an embedding matrix based on both of the EEG signal and the PPG signal processed by pre-processing model 2040. In some cases, the embedding matrix generated by the embedding unit 2041 can have twice as many rows as embeddings generated by embedding unit 2041 based on only one kind of input data. For example, the embeddings generated by the embedding unit 2041 based on two kinds of input data can include eight rows and 100 columns (e.g., 8×100), with the first four rows based on one kind of input data (e.g., ECG data) and the second four rows based on another kind of input data (e.g., PPG data). The machine learning model 2042 can process embedding matrices generated by embedding unit 2041 based on two kinds of biometric data (e.g., ECG data and PPG data) to generate a second biometric signal 2006 that represents a reconstructed sample of a second kind of biometric data (e.g., BCG data). In this way, the machine learning model 2042 can use spatial and temporal relationships present in both ECG data and PPG data to reconstruct BCG data.

Biometric signals (e.g., ECG signals, PPG signals, and BCG signals) can exhibit temporal dependencies where a current value is influenced by previous values. By generating embeddings to include a matrix having offsetting rows of data, embedding unit 2041 captures temporal dependencies of first biometric signal 2004 that are relevant for reconstructing second biometric signal 2006. For example, each row of the matrix can represent a time step, and the offset rows allow machine learning model 2042 account for the sequential nature of first biometric signal 2004 The offset rows of matrices generated by embedding unit 2041 can also provide contextual information about first biometric signal 2004. This context can improve an accuracy at which machine learning model 2042 makes predictions and decisions considering previous data points of first biometric signal 2004.

By generating embeddings to include matrices having rows offset by one data point, embedding unit 2041 can engineer features that encode temporal relationships between consecutive data points. This can simplify a learning process for machine learning model 2042 by giving some temporal relationships as input rather than relying on machine learning model 2042 to discover these temporal relationships itself. In general, embedding unit 2041 can generate matrices having rows offset by one data point to enhance an ability of machine learning model 2042 to capture temporal dependencies and contextual information. This can lead to improved performance in tasks involving sequential or time-series data, such as regenerating second biometric signal 2006 based on first biometric signal 2004.

Machine learning model 2042, in some examples, includes layer(s) 2044. Layer(s) 2044 can include one or more convolutional layers, one or more LSTM layers, and one or more dense layers. In some embodiments, layer(s) 2044 can include two convolutional layers, three LSTM layers, and one dense layer, but the system 2000 is not limited to these numbers of layers. In some embodiments, the number of layer(s) 2044 can depend on a size of the matrix input to the machine learning model 2042. For example, machine learning model 2042 may include a greater number of layers to process a larger embedding matrix and may include a smaller number of layers to process a smaller embedding matrix. In some embodiments, there can be a linear relationship between a number of rows of the embedding matrix input to machine learning model and a number of layer(s) 2044 of machine learning model 2042.

Machine learning model 2042 can include any number of convolutional layers, any number of LSTM layers, and any number of dense layers, with the number of layers based on a size of the embedding matrices input to machine learning model 2042. Machine learning model 2042 can additionally or alternatively include kinds of layers other than convolutional layers, LSTM layers, and dense layers. For example, machine learning model 2042 can also include one or more input layers, one or more output layers, one or more dropout layers, or any combination thereof.

In some embodiments, the layers of machine learning model 2042 are arranged in a sequence of layers such that data is processed iteratively by each layer. Machine learning model 2042 can apply a sequence of layers to process embeddings generated by embedding unit 2041 using a series of mathematical operations sometimes referred to as forward propagation. For example, embedding unit 2041 can feed an embedding into an input layer of machine learning model 2042. The input layer can include one or more neurons that each represent a feature or attribute of the input data. The data is processed by each layer of the sequence of layers of machine learning model,

Each layer of layer(s) 2044 can include one or more neurons. Each connection between neurons in adjacent layers can be associated with a weight parameter. Neurons can have an associated bias parameter. These weights and biases can be adjusted during a process of training machine learning model 2042 to improve an ability of machine learning model 2042 to generate second biometric signal 2006 based on first biometric signal 2004. In some examples, input data is multiplied by a weight parameter and summed with a bias parameter at one or more neurons within layer(s) 2044. In some embodiments, machine learning model 2042 can apply an activation function to introduce non-linearity into machine learning model 2042. The output of each neuron in a layer can serve as an input to neurons in a subsequent layer of layer(s) 2044. This means that data propagates through neurons of each layer of layer(s) 2044 until a final layer is reached. Each layer can extract increasingly abstract and high-level features from the input data.

A final layer of layer(s) 2044 can produce an output. This output, in some examples, comprises data points of the second sequence of data points of second biometric signal 2006. In some embodiments, machine learning model 2042 generates a single data point of biometric signal 2006 for each embedding input to machine learning model 2042. In examples where each embedding input to machine learning model 2042 includes a 4×100 matrix, this means that machine learning model 2042 processes 400 data entries to generate a single output data point. These 400 data entries can indicate special and temporal relationships that machine learning model 2042 to determine what a “next: data point of second biometric signal 2006 will be.

FIG. 21 is a conceptual diagram illustrating an example set of data points 2110 for generating an embedding matrix 2120. In some embodiments, embedding unit 2041 can select data points 2110 from a sequence of data points and can generate embedding matrix 2120 based on the set of data points 2110. The set of data points 2110 can include consecutive data points from pre-processed biometric data that pre-processing model 2040 of FIG. 20 generates based on first biometric signal 2004.

In some embodiments, embedding unit 2041 selects the set of data points 2110 using a rolling window that extends for a predetermined number of data points. As seen in FIG. 21, the set of data points 2110 includes data points S(-2) through S(N). In some embodiments, N is equal to 100. This means that in these embodiments, the set of data points 2110 includes data points S(-2) through S(100), amounting to a total of 103 data points. Embedding unit 2041 can use a rolling window of 103 data points to select the set of data points 2110 for generating an embedding matrix 2120 corresponding to data point S(N).

In some embodiments, embedding unit 2041 can generate embedding matrices based on two sets of pre-processed biometric data, each set of pre-processed biometric data corresponding to a type of input biometric data. For example, a first set of pre-processed biometric data may correspond to ECG data and a second set of pre-processed biometric data may correspond to PPG data. In embodiments where embedding unit 2041 generates embedding matrices based on two kinds of biometric data, embedding unit 2041 can generate an embedding matrix to include twice as many rows as in examples where embedding unit 2041 generates an embedding matrix based on one kind of input biometric data. For example, embedding unit 2041 can use a rolling window to select a set of data points corresponding to each set of pre-processed data points. Embedding unit 2041 can use these selected sets of data points to generate an embedding matrix.

Embedding unit 2041 can use the rolling window to select a set of data points corresponding to each data point of a sequence of data points of the pre-processed biometric data generated by pre-processing model 2040. Each time that the sequence of data points advances by one data point, the rolling window also advances by one data point. For instance, embedding unit 2041 can use the rolling window to select data points S(-2) through S (N) for the set of data points 2110 corresponding to data point S (N) and embedding unit 2041 can use the rolling window to select data points S(-1) through S(N+1) for the set of data points 2110 corresponding to data point S(N+1). This means that in the example of FIG. 21, the rolling window can include the current data point and the 102 data points immediately preceding the current data point.

In some embodiments, embedding unit 2041 generates embedding matrix 2120 using the set of data points 2110. As seen in FIG. 21, embedding matrix 2120 can include a set of rows 2122A-2122D (collectively, “rows 2122”) and a set of columns 2124A-2124N (collectively, “columns 2124”). In embodiments where embedding unit 2041 generates an embedding matrix based on one kind of input biometric data (e.g., ECG data only or PPG data only) as illustrated in FIG. 21, embedding matrix 2120 can include four rows and 100 columns. In embodiments where embedding unit 2041 generates an embedding matrix based on two kinds of input biometric data (e.g., ECG data only or PPG data only), embedding matrix 2120 can include eight rows and 100 columns, with the first four rows corresponding to a first kind of biometric data (e.g., EEG data) and the second four rows corresponding to a second kind of biometric data (e.g., PPG data). An embedding matrix can include greater than four rows or less than four rows and/or greater than 100 columns or less than 100 columns. Rows 2122 can be populated with data points of the set of data points 2110.

Each row of rows 2122 includes consecutive data points of the set of data points 2110 that is offset by one data point across each consecutive row of rows 2122. For example, row 2122A includes data points S(1) through S(N), row 2122B includes data points S(0) through S(N-1), row 2122C includes data points S(-1) through S(N-2), and row 2122D includes data points S(-2) through S(N-3). Since each of rows 2122 is offset by one data point, this means that each column includes four consecutive data points of the set of data points 2110. For example, column 2124A include data points S(-2) through S(1), column 2124B include data points S(-1) through S(2), column 2124C include data points S(0) through S(3), and so on.

FIG. 22 is a conceptual diagram illustrating an example machine learning model 2200 including a set of layers. Machine learning model 2200 can be an example of machine learning model 1942 of FIG. 19 and/or machine learning model 2042 of FIG. 20. As seen in FIG. 22, machine learning model 2200 includes input layer 2210, first convolutional layer 2212, second convolutional layer 2214, first dropout layer 2216, first LSTM layer 2218, second dropout layer 2220, second LSTM layer 2222, third dropout layer 2224, third LSTM layer 2226, dense layer 2228, and fourth dropout layer 2230.

Input layer 2210 can accept embeddings generated by embedding unit 2041 as input. In some embodiments, each embedding generated by embedding unit 2041 comprises an n×m matrix or tensor. This matrix or tensor, in some cases, may include additional dummy dimensions for implementation purposes. These “dummy dimensions” may be part of a third dimension such that the embedding comprises an n×m×d matrix, with “d” representing the third dimension. In the example of FIG. 22, each embedding comprises a 4×100 matrix with four rows and 100 columns. In some examples, input layer 2210 is configured to encode embeddings generated by embedding unit 2041 for processing by the rest of machine learning model 2200. To encode the embeddings generated by embedding unit 2014, input layer 2212 can indicate characteristics of the portion of the first biometric signal 2004 used to generate the embedding. In some examples, input layer 2210 generates a matrix for output, the matrix having the same dimensions as the embedding received by input layer 2210. For example, the matrix generated by input layer may be a 4×100 matrix with four rows and 100 columns.

First convolutional layer 2212 is configured to process the matrix output from input layer 2210 to generate another matrix. In the example of FIG. 22, first convolutional layer 2212 to process a 4×100 matrix having four rows and 100 columns to generate a 64×100 matrix having 64 rows and 100 columns. First convolutional layer 2212 is not limited to generating an output that has 64 rows and 100 columns. In some embodiments, the output generated by first convolutional layer 2212 has other numbers of rows and columns.

A convolutional layer in a can extract features from input data. In some examples, a convolutional layer comprises one or more filters each including a set of weights. Each filter can, in some cases, be smaller than the input data (e.g., 2×4 or 4×8).

First convolutional layer 2212 can convolve these features with input data to generate feature maps. Convolution can involve sliding the filters across the input data and multiplying the filter values with the corresponding input values. At each position as the features are slid across the input data, products of filter values with input values can produce a single value in an output feature map. This is one reason why the output from a convolutional layer can have different numbers of rows and/or columns as the input to a convolutional layer.

Second convolutional layer 2214 may accept the output from first convolutional layer 2212 and generate another matrix for output to first dropout layer 2216. In some embodiments, second convolutional layer 2214 accepts a 64×100 matrix having 64 rows and 100 columns from first convolutional layer 2212 and generates a 32×100 matrix having 32 rows and 100 columns for output to first dropout layer 2216. In some embodiments, to shrink the output matrix relative to the input matrix, second convolutional layer 2214 may set a high stride for filters to cross the input matrix.

First dropout layer 2216 can receive the matrix output from second convolutional layer 2214. Neural networks such as machine learning model 2200 can use dropout layers as one way to prevent overfitting. Overfitting can occur in neural networks when a model is trained such that the model effectively processes training data but does not learn to perform wall on new or unfamiliar samples. In other words, overfitting can lead to a model performing poorly when the model encounters new data. First dropout layer 2216 can randomly drop some of the data output from second convolutional layer 2214 to introduce noise into the data. In some examples, first dropout layer 2216 receives a 32×100 matrix having 32 rows and 100 columns from second convolutional layer 2214 and generates a 32×100 matrix having 32 rows and 100 columns for output to first LSTM layer 2218. Some of the values in the 32×100 matrix output to first LSTM layer 2218 may be “dropped” to introduce noise and reduce a risk of overfitting.

First LSTM layer 2218 can receive the matrix output from first dropout layer 2216 and generate another matrix for output to second dropout layer 2220. In some embodiments, first LSTM layer 2218 receives a 32×100 matrix from first dropout layer 2216 and generate a 16×100 matrix for output to second dropout layer 2220. LSTM layers are a kind of recurrent neural network (RNN) architecture configured for processing sequential data and/or timeseries data. LSTM layers can effectively capture temporal dependencies and long-range dependencies in input data. For example, biometric signals such as first biometric signal 2004 and second biometric signal 2006 are often sequential in nature, with each data point dependent on previous data points. LSTM layers are configured to process sequential data by processing one data point at a time while maintaining an internal state representing a context of previous data points. LSTM layers can include memory cells for storing information over long periods of time.

Second dropout layer 2220 receives a matrix output from first LSTM layer 2218 and generates another matrix for output to second LSTM layer 2222. Second dropout layer 2220 can drop some of the data output by first LSTM layer 2218 to introduce noise and prevent overfitting. In some embodiments, second dropout layer 2220 receives a 16×100 matrix having 16 rows and 100 columns from first LSTM layer 2218 and generates a 16×100 matrix having 16 rows and 100 columns for output to second LSTM layer 2222. Second LSTM layer 2222 can receive the matrix output by second dropout layer 2220 and generate another matrix for output to third dropout layer 2224. In some embodiments, second LSTM layer 2222 outputs a 16×100 matrix having 16 rows and 100 columns to third LSTM layer 2226. Third LSTM layer 2226 generates a 16×1 output matrix 16×100 matrix having 16 rows and one column for output to dense layer 2228.

First LSTM layer 2218, second LSTM layer 2222, and third LSTM layer 2226 may be configured to capture temporal dependencies and long-range dependencies in the input data and use these dependencies to regenerate BCG data based on ECG data and/or PPG data. In some examples, traditional RNNs may suffer from vanishing or exploding gradients when processing long sequences of data LSTM layers 22118, 2222, 2226 help to avoid vanishing or exploding gradients. For example, LSTM layers can address the vanishing gradient problem in RNNs by incorporating memory cells and gating mechanisms that enable LSTM layers to learn and retain information over long sequences while preventing gradients from vanishing or exploding during backpropagation.

Dense layer 2228 can receive the matrix output from third LSTM layer 2226 and generate another matrix for output to fourth dropout layer 2230. In some embodiments, dense layer 2228 outputs a single data value (e.g., a 1×1 matrix) to fourth dropout layer 2230. Fourth dropout layer 2230 can receive the data value from dense layer 2228 and output another data value. In the example of FIG. 22, machine learning model 2200 can receive an embedding comprising a 4×100 matrix and condense this input data to a single value. Machine learning model 2200 can output these single values to regenerate second biometric signal 2006 based on first biometric signal 2004.

FIGS. 23A-23D include plot diagrams of recorded ECG signals, recorded PPG signals, recorded BCG signals, and reconstructed BCG signals generated based on the recorded ECG signals or recorded PPG signals. FIG. 23A illustrates a first recorded PPG signal 2312, a first recorded BCG signal 2314, and a first reconstructed BCG signal 2316. FIG. 23B illustrates a first recorded ECG signal 2322, a second recorded BCG signal 2324, and a second reconstructed BCG signal 2326. FIG. 23C illustrates a second recorded PPG signal 2332, a third recorded BCG signal 2334, and a third reconstructed BCG signal 2336. FIG. 23D illustrates a second recorded ECG signal 2342, a fourth recorded BCG signal 2344, and a fourth reconstructed BCG signal 2346. Although the reconstructed BCG signals illustrated in FIGS. 23A-23D are reconstructed based on either ECG signals alone or PPG signals alone, BCG signals can be reconstructed based on a combination of ECG signals and PPG signals.

In some examples, using ECG signals to reconstruct BCG signals may result in a reconstructed BCG signal that is closer to an actual BCG signal as compared with using PPG signals to reconstruct BCG signals. As seen in FIGS. 23A-23D, BCG signals that are reconstructed using ECG signals appear to be closer to corresponding recorded BCG signals as compared with a similarity of BCG signals that are reconstructed using PPG signals to recorded BCG signals. This is because ECG signals can include more information concerning cardiac activity as compared with PPG signals. In any case, both PPG signals and ECG signals or a combination of those can be used to reconstruct BCG signals that resemble actual BCG data.

FIG. 24 is a flow diagram illustrating an example operation for using a first kind of biometric data to regenerate a second kind of biometric data. For convenience, FIG. 24 is described with respect to bed system 1900 of FIG. 19. However, the techniques of FIG. 24 may be performed by different components of bed system 1900 of FIG. 19 or by additional or alternative devices.

Controller 1902 is configured to receive a first biometric signal 1904 indicating a first parameter of a user over a first period of time (2402). In some examples, the first biometric signal 1904 comprises an ECG signal 1912 indicating an ECG of the user over the period of time or a PPG signal 1914 indicating a PPG of the user over the period of time. The first biometric signal 1904, in some examples, is collected from the user and the user is known to have one or more conditions, such as atrial fibrillation or other arrhythmias.

Processing circuitry 1922 is configured to use pre-processing model 1940 to apply a band-pass filter to the first biometric signal to generate a filtered first biometric signal (2404). This band pass filter can attenuate unwanted frequencies such as high-frequency noise. Processing circuitry 1922 can use pre-processing model 1940 to resample the filtered first biometric signal (2406). In some examples, filtered first biometric signal is resampled at 100 Hz. Processing circuitry 1922 is configured to apply machine learning model 1942 to generate second biometric signal 1906 indicating a second parameter of the user over the period of time (2408). Processing circuitry 1922 is configured to save the second biometric signal to a database (2410).

FIG. 25A-25C include plot diagrams of recorded hear rate and sleep duration signals.

FIG. 26 is a flow diagram illustrating an example operation for generating biometric signals.

The processing circuitry can be configured to receive 2602 a primary biometric signal indicating a primary biometric parameter over a period of time.

The processing circuitry can be configured to apply 2604 a band pass filter to the primary biometric signal to generate a filtered primary biometric signal.

The processing circuitry can be configured to resample 2606 the primary biometric signal at a predetermined sampling frequency.

The processing circuitry can be configured to apply 2608, based on the primary biometric signal, the machine learning model to generate a secondary biometric signal, wherein the secondary biometric signal indicates a secondary biometric parameter over the period of time.

The processing circuitry can be configured to save 2610 each secondary biometric signal of the plurality of secondary biometric signals to the database.

FIG. 27 is a flow diagram illustrating an example operation for controlling a mechanical feedback system.

The processing circuitry can be configured to generate 2702 a pressure signal.

The processing circuitry can be configured to determine 2704 a biometric signal.

The processing circuitry can be configured to compare 2706 the biometric

signal with a trend.

The processing circuitry can be configured to determine 2708 whether to control mechanical feedback.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

The foregoing detailed description and some embodiments have been given for clarity of understanding only. No unnecessary limitations are to be understood therefrom. It will be apparent to those skilled in the art that many changes can be made in the embodiments described without departing from the scope of the invention. For example, a different order and type of operations may be used to generate classifiers. Additionally, a bed system may aggregate output from classifiers in different ways. Thus, the scope of the present invention should not be limited to the exact details and structures described herein, but rather by the structures described by the language of the claims, and the equivalents of those structures. Any feature or characteristic described with respect to any of the above embodiments can be incorporated individually or in combination with any other feature or characteristic and are presented in the above order and combinations for clarity only.

1. A bed system comprising:
a bed comprising:
one or more actuation devices; and
a pressure sensor configured to generate a pressure signal; and
control circuitry comprising:
one or more memories configured to store a machine learning model and a bed actuation control model; and
processing circuitry in communication with the one or more memories, wherein the processing circuitry is configured to:
receive a primary biometric signal indicating a primary biometric parameter over a period of time;
apply, based on the primary biometric signal, the machine learning model to generate a secondary biometric signal, wherein the secondary biometric signal indicates a secondary biometric parameter over the period of time, wherein the pressure signal indicates a user sample of the secondary biometric parameter corresponding to a user laying on the bed; and
train, using the secondary biometric signal, the bed actuation control model to control the one or more actuation devices based on the user sample of the secondary biometric parameter.

2. The bed system of claim 1, wherein the one or more memories are configured to store a database, wherein the database is configured to store a plurality of secondary biometric signals each representing a sample of the secondary biometric parameter, wherein the plurality of secondary biometric signals includes the secondary biometric signal, and wherein the processing circuitry is further configured to train the bed actuation control model using the plurality of secondary biometric signals.

3. The bed system of claim 2, wherein the processing circuitry is configured to:
apply the machine learning model to generate each secondary biometric signal of the plurality of secondary biometric signals based on a primary biometric signal of a plurality of primary biometric signals, wherein each primary biometric signal of the plurality of primary biometric signals represents a sample of the primary biometric parameter, and wherein the plurality of primary biometric signals comprises the primary biometric signal; and
save each secondary biometric signal of the plurality of secondary biometric signals to the database.

4. The bed system claim 1,
wherein prior to applying the machine learning model to generate the secondary biometric signal, the processing circuitry is configured to apply a band pass filter to the primary biometric signal to generate a filtered primary biometric signal, and
wherein the processing circuitry is configured to apply the machine learning model to the filtered primary biometric signal to generate the secondary biometric signal.

5. The bed system of claim 4, wherein to apply the band pass filter to the primary biometric signal, the processing circuitry is configured to cause the band pass filter to pass one or more frequency components of the primary biometric signal, wherein the one or more frequency components are within a range from a lower-bound frequency to an upper-bound frequency.

6. The bed system of claim 5, wherein the lower-bound frequency is within a first range from 0.0001 Hertz (Hz) to 0.2 Hz, and wherein the upper-bound frequency is within a second range from 30 Hz to 100 Hz.

7. The bed system of claim 6, wherein the lower-bound frequency is 0.001 Hz and the upper-bound frequency is 50 Hz.

8. The bed system claim 1, wherein prior to applying the machine learning model to generate the secondary biometric signal, the processing circuitry is configured to resample the primary biometric signal at a predetermined sampling frequency.

9. The bed system of claim 8, wherein the predetermined sampling frequency is 100 Hz.

10. The bed system claim 1, wherein the primary biometric signal comprises one of an electrocardiogram (ECG) signal or a photoplethysmogram (PPG) signal, and wherein the secondary biometric signal comprises a ballistocardiogram (BCG) signal.

11. The bed system of claim 10, wherein the primary biometric signal comprises the ECG signal.

12. The bed system of claim 10, wherein the primary biometric signal comprises the PPG signal.

13. The bed system claim 1, wherein the memory is further configured to store training data comprising a plurality of training data sets, each training data set of the plurality of training data sets comprising:
a first training biometric signal collected over a window of time, the first training biometric signal indicating the primary biometric parameter of a subject over the window of time; and
a second training biometric signal collected over the window of time, the second training biometric signal indicating the second parameter of the subject over the window of time; and
wherein the processing circuitry is further configured to train, using the plurality of training data sets, the machine learning model to regenerate the secondary biometric signal indicating the second parameter using the primary biometric signal indicating the primary biometric parameter.

14. The bed system of claim 13, wherein the processing circuitry is configured to train the machine learning model using unsupervised learning.

15. The bed system of claim 13, wherein the processing circuitry is configured to train the machine learning model using supervised learning.

16. The bed system of claim 13, wherein the processing circuitry is configured to train the machine learning model using semi-supervised learning.

17. The bed system claim 1, wherein the processing circuitry is further configured to:
generate, for each data sample of a first plurality of data samples corresponding to the primary biometric signal, an input embedding, and
wherein to apply the machine learning model to generate the secondary biometric signal, the processing circuitry is configured to apply the machine learning model generate, for the input embedding corresponding to each data sample of the first plurality of data samples, a data sample of a second plurality of data samples of the secondary biometric signal.

18. The bed system of claim 17, wherein the input embedding includes a set of rows and a set of columns, and wherein to generate the input embedding, the processing circuitry is configured to:
populate a first row of the input embedding with a sequence of data samples of the first plurality of data samples, the sequence of data samples the sequence of data samples ending with the data sample corresponding to the input embedding;
populate a second row of the input embedding with the sequence of data samples so that the sequence of data samples is delayed by one sample relative to the first row;
populate a third row of the input embedding with the sequence of data samples so that the sequence of data samples is delayed by two samples relative to the first row; and
populate a fourth row of the input embedding with the sequence of data samples so that the sequence of data samples is delayed by three samples relative to the first row.

19. The bed system claim 1, wherein the machine learning model comprises two convolutional layers, three long short-term memory (LSTM) layers, and one dense layer.

20. A method comprising:
generating, by a pressure sensor of a bed, a pressure signal;
receiving, by processing circuitry, a primary biometric signal indicating a primary biometric parameter over a period of time, wherein one or more memories are configured to store a machine learning model and a bed actuation control model; and
applying, by the processing circuitry based on the primary biometric signal, the machine learning model to generate a secondary biometric signal, wherein the v biometric signal indicates a secondary biometric parameter over the period of time, wherein the pressure signal indicates a user sample of the secondary biometric parameter corresponding to a user laying on the bed; and
training, by the processing circuitry using the secondary biometric signal, the bed actuation control model to control one or more actuation devices of the bed based on the user sample of the secondary biometric parameter.

21-40. (canceled)
